(19) United States
(12) Patent Application Publication
(10) Pub. No.: US 2003/0213937 A1
(43) Pub. Date: Nov. 20, 2003

(54) Precipitated aragonite and a process for producing it

(76) Inventor: Isaac Yaniv, Haifa (IL)

Correspondence Address: BROWDY AND NEIMARK, P.L.L.C., 624 NINTH STREET, NW, SUITE 300, WASHINGTON, DC, 20001-5303, US

(21) Appl. No.: 10/220,643

(22) PCT Filed: Feb. 22, 2001
(86) PCT No.: PCT/IL01/00166

(51) Int. Cl. C01F 11/18

(52) U.S. Cl. 252/500; 423/432; 423/266; 423/430; 106/464; 502/400

(57) ABSTRACT

Disclosed is a novel form of particulate precipitated aragonite, and a novel process for producing it.

### FIELD AND BACKGROUND OF THE INVENTION

The present invention relates to a novel form of particulate precipitated calcium carbonate; and particularly to a novel form of particulate precipitated aragonite, and to a novel process for producing it.

Various routes are known for the production of calcium carbonate, which finds use as a thickening material, as a filler, as an extender, and most of all as a pigment, in a variety of industries such as pharmaceuticals, agrochemicals, plastics, adhesives, printing, coating (paint), paper, rubber and in filtration. For such purposes, there may be used ground calcium carbonate (GCC) or precipitated calcium carbonate (PCC). PCC in general possesses advantages over GCC, in that it is economical to produce and its precise composition, or purity, can be more strictly controlled.

The most frequently used chemical process for producing PCC is based on the carbonation of aqueous suspensions of calcium hydroxide (also known as “milk of lime” or “slaked lime”) with carbon dioxide gas, or with a carbon dioxide containing gas. This process gives rise to relatively pure precipitated calcium carbonate and is a preferred process, because there are no serious problems of contamination of the product with undesired salts, and moreover it can be controlled in order to adjust the properties of the final product. Thus, the process is based essentially on four stages: firstly, calcination of raw limestone to produce calcium oxide or “quicklime” and carbon dioxide gas or a carbon dioxide containing gas; secondly, “slaking” of the quicklime with water to produce an aqueous suspension of calcium hydroxide; thirdly, carbonation of the calcium hydroxide with carbon dioxide gas or a carbon dioxide containing gas; and finally, downstream operations such as dewatering, drying, deagglomeration, grinding, surface treatment, surface coating, mixing with other minerals (e.g. titanium dioxide, talc, kaolin, GCC, PCC —including aragonite PCC) and dyeing, which allow optimization of the properties of the precipitated calcium carbonate particles in order to be adapted to their intended uses.

Calcium carbonate can be precipitated from aqueous calcium hydroxide slurries or solutions in three different crystallographic forms (polymorphs): the vaterite form which is thermodynamically unstable, the aragonite form which is metastable under normal ambient conditions of temperature and pressure, and the calcite form which is the most stable and the most abundant in nature. These forms of calcium carbonate can be prepared by carbonation of slaked lime by suitable variations of the process conditions.

The calcite form is easy to produce on industrial scales, as precipitated calcium carbonate particles. It exists in several different shapes, of which the most common are the rhombohedral shape and the scalenohedral shape.

Aragonite forms crystals having a length/width ratio (hereinafter—“aspect ratio”) in the range between >1:1, and 100:1 of which a typical aspect ratio is 10, in which case the aragonite forms long, thin needles. Therefore, aragonite having a high aspect ratio may be denoted hereinafter—“acicular aragonite” or “needle-shaped aragonite”. The production of aragonite is a slow process and is very difficult to control on an industrial scale.

PCC particles are used as thickening materials, fillers, extenders and, most of all, as inexpensive pigments. The latter use implies that a particularly desirable property of this material is its light scattering characteristics, in order to be able to impart opacity and brightness to the products containing it. Such characteristics are optimized, when the pigment particles are very effectively dispersed and are apart by an average distance in the range between 0.2 μm and 0.4 μm in their final products, and their size distribution is in the range between 0.2 μm and 0.4 μm, namely, in the range of half a wavelength of the visible light. That means that either the production of the PCC should be adjusted to produce small particles in order to avoid expensive downstream particle size reduction operations and to cope with the expensive problems of dewatering and drying the product, or, alternatively, the process should be adjusted to produce large particles, and subsequently effect the downstream dewatering and grinding operations. In both cases, the production costs of precipitated calcium carbonate of pigment grades may be doubled or tripled just because of these unavoidable downstream steps.

High light scattering pigments currently available to the above-mentioned industries include titanium dioxide particles, which are very effective to scatter the light due to their relatively high refractive index (2.76; for the rutile form) and their meticulously controlled particle size distribution of which median is in the range between 0.2 μtm and 0.4 μm. However, this product is of a high specific gravity (−4.0 g/cm3), of a high surface area due to its small particles, and most of all, is quite expensive. Fine kaolin particles are also being used as pigments, but this product, which has a much lower refractive index (1.56), is of limited whiteness and is still relatively expensive. Particulate calcium carbonate is the ideal least expensive pigment and could replace much more of the titanium dioxide and kaolin pigments in their respective present applications, if it could be prepared in a form having improved light scattering properties.

Calcium carbonate pigments are produced in part by grinding coarse natural rocks and in part by precipitation processes. Of the precipitated calcium carbonate particles, a particulate precipitated aragonite is considered to be the most effective light scattering calcium carbonate pigment, of which refractive indices are 1.530, 1.681 and 1.685, depending on its crystallographic surfaces, its specific gravity is above 2.5 g/cm3, and is the most suitable for same applications. However, its production rate is characteristically very slow and its production conditions are very difficult to control, industrially.

While the majority of references, cited hereinafter, relate to the technology for producing a particulate precipitated aragonite, some of the references are included in order to better present the state of the art for the production of PCC more generally, including the downstream operations, which may be common to all these processes and also to the present invention.

1. U.S. Pat. No. 2,081,112 (N. Statham et al.) describes a process for producing precipitated calcium carbonate by carbonating milk of lime with carbon dioxide. containing gas, where the temperature in the gas absorber is maintained at 50-60° C., preferably around 55° C. It is recognized that the more violent the agitation in the gas absorber, the finer will be the product; the aim being to create a fine mist of calcium hydroxide slurry.

2. U.S. Pat. No. 2,964,382 (G. E. Hall, Jr.) describes production of precipitated calcium carbonate by various chemical routes, in which calcium ions are contacted with carbonate ions in a precipitation zone, the process including also carbonation of milk of lime with carbon dioxide gas. A high shear stator/rotor agitator is used to provide turbulence by rotating at a peripheral speed of at least 1160 feet per minute (589 cm per second) in the precipitation zone. Also, this patent teaches that it is desirable to operate the process at pH values of at least 8.5 and that at temperatures above 60° C., needle-shaped precipitated aragonite particles are formed, which however produce an adverse flow property effect.

3. U.S. Pat. No. 3,320,026 (W. F. Waldeck) describes the production of various forms of precipitated calcium carbonate.

4. GB Patent No. 941,900 (assigned to Kaiser Aluminium & Chemical corporation) describes the production of precipitated aragonite particles, for use as a filter aid, by reacting continuously sodium carbonate solution and aqueous calcium hydroxide slurry at temperatures higher than 60° C. in a multistage system. The product and the solution are withdrawn at the third stage from the bottom of the reactor, the product is then separated from the solution and part of the crystals are recycled to the various stages of the process as seeds for further precipitation of the precipitated aragonite particles.

5. U.S. Pat. No. 3,669,620 (M. C. Bennett et al.) describes a continuous process for the production of a particulate precipitated aragonite by carbonating aqueous calcium hydroxide slurry in sucrose solutions. However, due to the cost of the sucrose, the solution had to be recycled and detrimental materials had to be removed by anion exchange resin. The preferred temperature range was between 60° C. and 90° C.; the pH values were in the range between 7 and 9; and the concentration of the calcium hydroxide was quite low—in the range between one-half and one-twentieth molar.

6. U.S. Pat. No. 4,018,877 (R. D. A. Woode) describes carbonation of calcium hydroxide slurry, wherein a complexing agent for Ca++ is added to the suspension in the gas absorber, after the calcium carbonate primary nucleation stage and before completion of the carbonation step, the complexing agent being e.g. citric acid, ethylenediamine tetraacetic acid (EDTA), aminotriacetic acid, aminodiacetic acid or a hydroxy polycarboxylic acid. Optionally, long-chain fatty acids or their salts can be added, preferably, after the final carbonation stage.

7. U.S. Pat. No. 4,157,379 (J. Arika et al.) describes the production of a chain-structured precipitated calcium carbonate by the carbonation of calcium hydroxide suspended in water in the presence of chelating agents, such as aliphatic carboxylic acids, and water-soluble metal salts.

8. U.S. Pat. No. 4,244,933 (H Shibazaki et al.) describes a multi-stage production process for producing a particulate precipitated aragonite, using aqueous calcium hydroxide slurry and carbon dioxide gas or a carbon dioxide containing gas, in the presence of phosphoric acids and water-soluble salts thereof.

9. U.S. Pat. No. 4,420,341 (T. H. Ferrigno) describes inorganic fillers (including calcium carbonate) surface modified with carboxylic acids, antioxidants and high-boiling non-reactive liquid agents.

10. JP Patent Publication No. 63260815 (H. Shibata et al.) describes the production of a particulate precipitated aragonite, by reacting carbon dioxide gas with an aqueous calcium hydroxide slurry in presence of phosphoric acid, a phosphoric acid compound, a barium compound and a strontium compound.

11. JP Patent No. 1261225 (H. Shibata et al.) describes reacting carbon dioxide gas with an aqueous calcium hydroxide slurry, in order to produce a particulate precipitated aragonite, which is stated to have improved properties compared with particulate precipitated calcite.

12. U.S. Pat. No. 4,824,654 (Y. Ota et al.) describes a process for producing precipitated needle-shaped (5-100 μm) particulate precipitated aragonite, in which a relatively dilute aqueous calcium hydroxide solution (0.04-0.17 wt. %) and carbon dioxide gas or a carbon dioxide-containing gas are reacted together at a temperature of not less than 60° C., in a continuous or semi-continuous (intermittent) manner.

13. U.S. Pat. No. 5,043,017 (J. D. Passaratti) describes a process for producing acid-stabilized precipitated calcium carbonate particles.

14. U.S. Pat. No. 5,164,172 (H. Katayama et al.) describes a process for producing a particulate precipitated aragonite, in which a mixture of aqueous calcium hydroxide slurry, aragonite calcium carbonate particles and a water-soluble phosphoric acid compound are premixed prior to the addition of carbon dioxide gas.

15. U.S. Pat. No. 5,342,600 (I. S. Bleakley et al.) describe a process of producing particulate precipitated calcium carbonate, in which aqueous calcium hydroxide slurries of varying concentrations are reacted with carbon dioxide-containing gas under a controlled mixing speed. It is recommended therein to prepare the aqueous calcium hydroxide suspension under high shear mixing and subsequently to lower the energy and shear agitation in the reaction mixture in which the precipitated calcium carbonate particles are formed.

16. U.S. Pat. No. 5,376,343 (P. M. Fouche) describes a process for producing various forms of particulate PCC. In the case of aragonite, a mixture of quite dilute aqueous calcium hydroxide solution and a water-soluble source of specific anions (e.g. ammonium nitrate) are premixed prior to addition of CO₂ gas.

17. U.S. Pat. No. 5,380,361 (R. A. Gill) describes inter alia calcium carbonate particles coated with C₁₂-C₂₂ fatty acid salts.

18. U.S. Pat. No. 5,593,489 (K-T. Wu) describes a process for producing acid-resistant calcium carbonate particles for making neutral to weakly acid paper.

19. U.S. Pat. No. 5,833,747 (I. S. Bleakley et al.) describes a process for producing a particulate, precipitated aragonite, in which an aqueous calcium hydroxide slurry (148 g Ca(OH)₂ per liter of suspension) is reacted with carbon dioxide gas at an exceptionally slow rate of 0.0026 moles per minute per mole of Ca(OH)₂ in a batch operation.

20. WO 9852870 (B. Jackson et al.) describes a multi-stage commercial process for producing a particulate precipitated aragonite, using coarse-grained precipitated aragonite particles as a seeding material. Though the process is claimed to be industrially applicable, it is quite slow and thus of very limited economical value.

21. U.S. Pat. No. 5,846,500 (J. W. Bunger et al.) describes a process for producing a particulate precipitated aragonite, in which an aqueous calcium hydroxide solution is reacted with CO₂ gas in a plug-flow reaction system.

22. U.S. Pat. No. 5,846,382 (A., von Raven) describes a process for producing inorganic fillers and pigments, including particulate calcium carbonate, of improved whiteness, brightness and chromaticity.

23. U.S. Pat. No. 5,861,209 (W. J. Haskins et al.) describes a process for producing a particulate precipitated aragonite, for printing, in which an aqueous calcium hydroxide slurry is first mixed with precipitated aragonite particles for seeding and then it is reacted quite slowly with carbon dioxide gas in a batch operation. After dewatering the product to a cake containing about 70% solids, it is mixed with a typical dispersant, e.g. sodium polyacrylate, and it is further dispersed. This patent discloses the use of mixtures of a particulate precipitated aragonite, with TiO₂ and other inorganic fillers, pigments and flame retardants.

24. U.S. Pat. No. 5,939,036 (A. L. Porter et al.) describes a process for producing a particulate precipitated aragonite, in which aqueous mixtures of organic compounds and acids (e.g. ethanolamine and HCl) are used to dissolve impure CaO and to form a calcium hydroxide mixture, which is then reacted with carbon dioxide gas to yield various forms of PCC, depending on the temperature. Controlling the temperature of the carbonation at about 95° C. leads to aragonite.

25. U.S. Pat. Nos. 6,022,517 and 6,071,336 (G. H. Fairchild et al.) describe a process for producing mixtures of precipitated acicular calcite and acicular aragonite particles in the ratio of 75:25 to 25:75, by reacting carbon dioxide gas or a carbon dioxide containing gas and aqueous calcium hydroxide in the presence of a water soluble aluminum compound, by controlling the specific conductivity in a range >4.0 and up to about 7.0, milliSiemens/cm, at a reaction temperature of from 25-600° C.

26. Pigment Handbook (Vol. I-III; Edited by T. C. Patton; John Wiley & Sons, New York (1973)) describes the properties, the production processes and various uses of aragonite calcium carbonate pigment (c.f. Vol. I; Pages 119-128), as well as those of other pigments that compete in the same market like titanium dioxide, kaolin, GCC, etc. The discussion concerning the influence of the film porosity on the hiding power or opacity of a coating film (c. f. Vol. III; Pages 203-217 and especially on Page 212) may help in understanding some aspects of the present invention.

The entire contents of the above-cited literature, including patents and publications, are incorporated herein by reference. It is apparent from the state of the art that known processes for the industrial production of substantially pure particulate precipitated aragonite (>90 parts aragonite: <10 parts calcite), by reacting aqueous calcium hydroxide slurries with carbon dioxide gas or a carbon dioxide containing gas, exhibit serious drawbacks that affect the quality and cost of the final product, as follows:

A. Some of the processes for producing particulate precipitated aragonite are conducted in aqueous solutions of extremely low concentrations of calcium hydroxide. In some cases it is specified that clear solutions, which contain less than 1 wt. % calcium hydroxide, should be used.

B. In those processes for producing particulate precipitated aragonite, which allow use of aqueous calcium hydroxide slurries, the production rates are very slow and difficult to control.

C. To increase somewhat the rates of production in processes of A and B, the prior art recommends seeding with previously produced aragonite particles. However, this complicates the production processes, especially those operated continuously, and which are otherwise of great commercial potential.

D. Dewatering of particulate precipitated calcium carbonate, and particularly particulate precipitated aragonite, obtained according to the known art gives rise to relatively wet filter cakes of which the water content is not below 30% and which may thus require a very expensive subsequent drying step.

E. Particulate precipitated calcium carbonate, and particularly particulate precipitated aragonite, of the prior art requires extensive grinding operations to optimize its particle size distribution (PSD) in order to meet the effective PSD in the range between 0.2 μm and 0.4 μm, mentioned above. Moreover, the grinding operation tends to contaminate the product, due to attrition of the grinding media, unless very expensive materials of construction are used for this purpose.

F. The known particulate precipitated calcium carbonate, and particularly particulate precipitated aragonite, is of limited whiteness, mainly due to the high residual impurities in the CaCO₃/CaO feedstock, which it is quite difficult to remove thoroughly, on the industrial scale. Also, the low whiteness of the product is a limiting factor in choosing the suitable sources of its raw materials (CaCO₃/CaO).

G. Particulate precipitated calcium carbonate, and particularly particulate precipitated aragonite, frequently requires one or more post-manufacturing treatment step(s), in order to ensure that the particle surface is hydrophobic, by coating with suitable long-chain carboxylic acids and esters and/or other materials such as silicon greases e.g. for efficient dispersal in hydrophobic media such as rubber or plastics, and/or to ensure resistance to acidic environments for use e.g. in the paper industry and in the coating industry.

H. Efforts in the prior art to increase the effective refractive index of particulate precipitated calcium carbonate, and particularly of particulate precipitated aragonite, has not so far succeeded in making this material a serious competitor to titanium dioxide.

Accordingly, it is an object of the present invention to overcome all or most of the problems encountered in the prior art, as mentioned in paragraphs A-H, above.

It is an object of the present invention to provide particulate precipitated calcium carbonate, and particularly particulate precipitated aragonite, as stated in the preceding paragraphs, by a process which is more efficient and less expensive, than those available in the prior art.

It is yet a further object of the present invention to effect such a more efficient and less expensive process as stated in the preceding paragraph, using sources of CaCO₃/CaO, which are presently not suitable raw materials for use as e.g. fillers, extenders and pigments, and for other applications, in all of which uses require pigments of high optical properties and high performance, whereby production costs are lowered.

Still another object of the present invention is to provide a particulate precipitated calcium carbonate, and particularly particulate precipitated aragonite, of a superior quality as stated above, in which the produced particles are treated in situ with a hydrophobic agent in order to avoid an extra downstream step and to fine-tune their properties to meet the requirements of consumer products like detergents and cleaning products, especially in the powder forms, toothpastes, sunscreen lotions, pharmaceuticals, agrochemicals, rubber, plastics, coatings (especially durable paints in acidic environments), inks and paper industries (especially paper production in weakly acidic media), an effect of said in situ treatment being lowering of production costs.

Still another object of the present invention is to carry out the above-stated more efficient and less expensive process, in a manner which gives rise to filter cakes which are relatively dry, e.g. with no more than about 20 wt. % water, right after the dewatering stage, and thus additionally lowering production costs.

Another object of the invention is to effect the above-stated more efficient and less expensive process, in such a manner that the particulate precipitated calcium carbonate, and particularly particulate precipitated aragonite, does not require, for most applications, any downstream grinding operations, except for the regular mixing systems which are in any event usually installed in the industries mentioned above, and thus additionally lowering production costs.

Most of all, it is a particular object of the present invention to provide a particulate precipitated calcium carbonate, and particularly a particulate precipitated aragonite, of a better quality than that obtained in the prior art, and especially having a higher whiteness, a lower specific gravity and a higher effective refractive index.

Other objects of the invention will appear from the description which follows.

### SUMMARY OF THE INVENTION

It has been surprisingly found, in accordance with the present invention, that a particulate precipitated calcium carbonate, and especially a particulate precipitated aragonite calcium carbonate, which is characterized by its high whiteness, high effective refractive index, low bulk density (apparent (loose) bulk density (L.B.D.) and tapped bulk density (T.B.D.)) and especially by its low specific gravity (below 2.5 g/cm³), can be produced, and that the above-mentioned objects of the present invention can be achieved, by a process which comprises reacting an aqueous calcium hydroxide slurry with a gas selected from carbon dioxide and a gas containing it, wherein the parameters of the process, including e.g. at least one preselected active agent, modes of operation, operating concentrations of raw materials, operating temperatures, operating pH range and high shear mixing speeds, are strictly controlled such that the desired product is obtained. In a particular embodiment, flotation of the product occurs during such process.

The present invention accordingly provides in a particular embodiment, a process for producing a particulate precipitated aragonite calcium carbonate, and the particulate precipitated aragonite calcium carbonate thus produced, which process comprises reacting an aqueous calcium hydroxide slurry with a gas selected from the group consisting of carbon dioxide and a gas containing it, wherein the parameters of said process, including at least one preselected active agent, mode of operation, operating concentrations of raw materials, operating temperature, operating mixer speed and operating pH, are such that at least one of the following criteria (a), (b) and (c) is satisfied:

(a) the specific gravity of the product after drying for 12 hours at 120° C. is <2.5 g/cm³ and the specific gravity of this dry product after ignition for eight hours at 500° C. is <2.5 9/cm³;

(b) the apparent (loose) bulk density (L.B.D.) of the product after drying for 12 hours at 120° C. is <0.55 g/cm³;

(c) the tapped bulk density (T.B.D.) of the product after drying for 12 hours at 120° C. is <0.70 g/cm³.

Preferably the product satisfies at least one of the following criteria: (a) it has a specific gravity <2.3 g/cm³ after drying at 120° C., and a specific gravity <2.3 g/cm³ after ignition for eight hours at 500° C. of the thus-fried product; (b) it has a L.B.D. <0.50 g/cm³, after drying at 120° C. for twelve hours; (c) it has a T.B.D <0.6 g/cm³, after drying at 120° C. for twelve hours.

More preferably, the product satisfies at least one of the following criteria: (a) it has a specific gravity <2.1 g/cm³ after drying at 120° C., and a specific gravity <2.1 g/cm³ after ignition for eight hours at 500° C. of the thus-fried product; (b) it has a L.B.D. <0.45 g/cm³, after drying at 120° C. for twelve hours; (c) it has a T.B.D. <0.55 g/cm³, after drying at 120° C. for twelve hours.

In a further embodiment of the invention, there is provided a process for producing a particulate precipitated aragonite calcium carbonate, and the particulate precipitated aragonite calcium carbonate thus produced, which process comprises reacting an aqueous calcium hydroxide slurry with a gas selected from the group consisting of carbon dioxide and a gas containing it, wherein the parameters of said process, including at least one preselected active agent, mode of operation, operating concentrations of raw materials, operating temperature, operating mixer speed and operating pH, wherein said at least one active agent is selected from nonanoic acid, decanoic acid, undecanoic acid, dodecanoic acid, tetradecanoic acid, octadecanoicacid, and undecylenic acid, their carboxylate salts, their acid anhydrides, their esters, their acyl halides and their ketenes.

The process of the invention for producing a particulate precipitated aragonite, in accordance with the invention, is preferably further characterized by at least one, and preferably all, of the following features: (a) the active agent comprises at least one member selected from the group consisting of carboxylic acids of formula RCOOH, where the organic group R (which may be e.g. a saturated or unsaturated aliphatic group, such as a hydrocarbon group which may be substituted or unsubstituted) contains 7-20 carbon atoms, and their carboxylate salts, esters, anhydrides, acyl halides, and their ketenes (b) more specifically, the active agent comprises at least one member selected from the group consisting of carboxylic acids of formula CₙH₂ₙ₊₁COOH, where n is 8-17, and their carboxylate salts, esters, anhydrides, acyl halides, and their ketenes; (c) also, the active agent comprises at least one member selected from the group consisting of carboxylic acids of formula CₙH₂ₙ₋₁COOH, where n is 8-17, and their carboxylate salts, esters, anhydrides, acyl halides, and their ketenes; (d) more specifically, the active agent comprises at least one member selected from the group consisting of carboxylic acids of formula CH₃(CH₂)ₙCOOH, where n is 7-16, and their carboxylate salts, esters, anhydrides, acyl halides, and their ketenes of formula CH₃(CH₂)ₙ₋₁C═C═O; (e) the concentration of the active agent is within the range of between 0.2 wt. % and 10 wt. %, calculated as RCOOH and based on the weight of calcium carbonate; (f) the slurry contains calcium hydroxide in a concentration within the range of from 3 to 30 wt. %, more preferably 4 to 20 wt. %; (g) the product is produced at a pH between 8 and 11, preferably between 9 and 10; (h) the process is effected at a temperature in the range between 60° C., desirably between 80° C., and the boiling temperature of the reaction mixture; (i) the process is effected either in a semi-continuous (intermittent) mode of operation, or more preferably in a continuous manner;.(j) the process is effected under high shear mixing e.g. with a mixer comprising a rotor/stator or a rotor only, the mixer peripheral (tip) speed being preferably at least 5 m/sec. In a particular embodiment, this process is effected in a continuous mode of operation under high shear mixing with a mixer comprising a rotor/stator or a rotor only, at a temperature in the range between 90° C. and the boiling temperature of the reaction mixture, the active agent—preferably present in an amount in the range between 0.2% and 10 wt. %, calculated on the weight of calcium carbonate—being selected from the carboxylic acids and their calcium salts, and the slurry contains calcium hydroxide in a concentration within the range of from 5 to 15 wt. %, the active agent being desirably premixed with the calcium hydroxide slurry prior to reaction with carbon dioxide.

The present invention also provides as a novel chemical substance, which is of course obtainable in accordance with the present process, a particulate precipitated aragonite, which has a specific gravity of <2.5 g/cm³ (preferably <2.3 g/cm³, more preferably <2.0 g/cm³, even more preferably <1.5 g/cm³) after drying at 120° C., and a specific gravity <2.5 g/cm³ (preferably <2.3 g/cm³, even more preferably <2.1 g/cm³) after ignition for eight hours at 500° C. In a particular embodiment, the product has a specific gravity of <2.3 g/cm³ after drying at 120° C., and a specific gravity <2.3 g/cm³ after ignition for eight hours at 500° C. and in another particular embodiment, the product has a specific gravity of <2.1 g/cm³ after drying at 120° C., and a specific gravity <2.1 g/cm³ after ignition for eight hours at 500° C.

A typical such product may be further characterized by at least one of the following features: it contains said carboxylic acid calcium salt(s) in an amount between 0.2 and 10 wt. %, calculated as CH₃(CH₂)ₙCOOH and based on the weight of calcium carbonate; it has a specific gravity <2.2 g/cm³, preferably <2.0 g/cm³, more preferably <1.8 g/cm³, and even more preferably <1.5 g/cm³; a product previously dried at 120° C. for 12 hours has a loss on drying at 300° C. for 8 hours of about <10% wt. %, based on the weight of calcium carbonate; a product previously dried at 120° C. for 12 hours has a loss on ignition at 500° C. for 8 hours of about <10% wt. %, based on the weight of calcium carbonate; after drying at 120° C. for 12 hours, and/or drying for 8 hours at 300° C., and/or firing for 8 hours at 500° C., it still has a specific gravity <2.5 g/cm³; after drying at 120° C. for 12 hours, and/or drying for 8 hours at 300° C., and/or firing for 8 hours at 500° C. The product is further characterized by its low bulk density, and in particular an apparent (loose) bulk density below 0.55 (preferably <0.50, more preferably <0.45) g/cm³ and a tapped bulk density below 0.70 (preferably <0.60, more preferably <0.55) g/cm³. In another aspect, the present invention provides a particulate precipitated aragonite which contains at least one calcium salt of carboxylic acids selected from those of the general formula: CₙH_{2n±1}COOH, where n=8-17, in an amount between 0.2 and 10 wt. %, calculated as CₙH_{2n±1}COOH and based on the weight of calcium carbonate, and which has (A) a specific gravity <2.5 g/cm³ after drying for 12 hours at 120° C., and/or (B) a specific gravity <2.5 g/cm³ after ignition for eight hours at 500° C. of the product dried, preferably, in (A).

In still another aspect, the present invention provides a particulate precipitated aragonite which contains at least one calcium salt of carboxylic acids selected from those of the general formula: CH₃(CH2)ₙCOOH, where n=7-16, in an amount between 0.2 and 10 wt. %, calculated as CH₃(CH₂)ₙCOOH and based on the weight of calcium carbonate, and which has (A) a specific gravity <2.5 g/cm³ after drying for 12 hours at 120° C., and/or (B) a specific gravity <2.5 g/cm³ after ignition for eight hours at 500° C. of the product dried, preferably, in (A).

In still another aspect, the present invention provides a particulate precipitated aragonite which contains at least one calcium salt of carboxylic acids selected from nonanoic acid, decanoic acid, undecanoic acid, dodecanoic acid, tetradecanoic acid, octadecanoic acid, and undecylenic acid in an amount between 0.2 and 10 wt. %, calculated as CH₃(CH₂)ₙCOOH or CₙH₂ₙ₋₁COOH, respectively, and based on the weight of calcium carbonate, and which has (A) a specific gravity <2.5 g/cm³ after drying for 12 hours at 120° C., and/or (B) a specific gravity <2.5 g/cm³ after ignition for eight hours at 500° C. of the product dried, preferably, in (A).

The product of the present invention can be used as a builder, an anticaking material, an encapsulant, an adsorbent, a thickening material, a sunscreen, a filler, an extender and particularly as a pigment for the detergent, pharmaceuticals, agrochemicals, plastics, adhesives, printing, coating (paint), paper, rubber, filtration, toiletries and many other industries. Thus, in accordance with further aspects of the present invention, there are provided a coating composition, a paper composition, a plastics composition, a rubber composition, an adsorbent composition, a powder detergent composition, a pharmaceutical composition, an agrochemical composition, a flavor composition, a fragrance composition, a food composition, a feed composition, a conductive composition, and a sunscreen composition, each of which comprises a particulate precipitated aragonite in accordance with the invention. For this purpose, such compositions may comprise, for example, substantially dry particulate precipitated aragonite, or particulate precipitated aragonite in aqueous dispersion.

The PCC of the present invention can be used in most of the (consumer) products that the prior art particulate calcium carbonate is being used (and quite probably in all of them). However, the PCC of the present invention will manifest its advantages and unique properties when these (consumer) products are to be produced and/or be used under conditions that exploit its “porous” nature as an adsorbent for liquids (e. g. in powders or detergent powders, in pharmaceuticals, in agrochemicals and in various household products like food and feed formulations. Also, as an encapsulating agent for flavors and fragrances, pharmaceuticals and agrochemicals), and/or an anticaking agent (e. g. in powders or detergent powders, in pharmaceuticals, agrochemicals, food, and feed formulations), as a “light” component to reduce the bulk density of products (e. g. when it is used as a filler and/or a builder in powders or detergent powders), as a thickening material (e. g. in glues, sealants, adhesives, coatings (paints), and in paper), as filler, as an extender and, particularly, as a pigment (e. g. in sunscreen formulations, plastics, adhesives, printing (inks), coatings (paints), paper (especially formulations for coating paper, and particularly for high gloss paper products), rubber, filtration, and many others).

### BRIEF DESCRIPTION OF THE DRAWINGS

FIG. 1 shows a schematic flow sheet for production of particulate precipitated calcium carbonate according to the prior art.

FIG. 2 shows a schematic flow sheet for production of a particulate precipitated aragonite, in accordance with an embodiment of the present invention.

FIG. 3 shows in schematic vertical section, a reactor/flotation cell for producing a particulate precipitated aragonite, in accordance with an embodiment of the present invention.

FIG. 4 shows a SEM picture of a substantially pure particulate precipitated aragonite, in accordance with an embodiment of the present invention.

FIG. 5 shows an XRD spectrum of a substantially pure particulate precipitated aragonite, in accordance with an embodiment of the present invention.

FIG. 6 shows a SEM picture of, ARP-76, a substantially pure particulate precipitated aragonite, in accordance with an embodiment of the present invention.

FIG. 7 shows an XRD spectrum of, ARP-76, a substantially pure particulate precipitated aragonite, in accordance with an embodiment of the present invention.

FIG. 8 shows a SEM picture of, ARP-70, a mixture of −50% particulate precipitated aragonite and −50% particulate precipitated calcite, in accordance with an embodiment of the present invention.

FIG. 9 shows an XRD spectrum of, ARP-70; a mixture of −50% particulate precipitated aragonite and −50% particulate precipitated calcite, in accordance with an embodiment of the present invention.

### DETAILED DESCRIPTION OF THE INVENTION

In the process of the present invention, a slurry of calcium hydroxide in water and carbon dioxide gas or a carbon dioxide containing gas is reacted together in the presence of the active agent under stringent process conditions, to generate a particulate precipitated aragonite having unique properties.

The product of the present invention is characterized by its low production cost and by its unique physical properties (high whiteness, high effective refractive index, at least one of, and preferably all of, low L.B.D. (<0.55 g/cm³), low T.B.D. (<0.70 g/cm³) and low specific gravity (<2.5 g/cm³)) and by its excellent chemical properties (hydrophobicity and resistance to weak acids), which make it particularly suitable as an adsorbent for liquids, an anticaking material, a thickening material, a builder, a filler, an extender and most of all as a pigment for the printing, coating (paint), paper, rubber, plastics, filtration, adhesives, sealants, pharmaceuticals, agrochemicals, food, feed, detergents and many other industries.

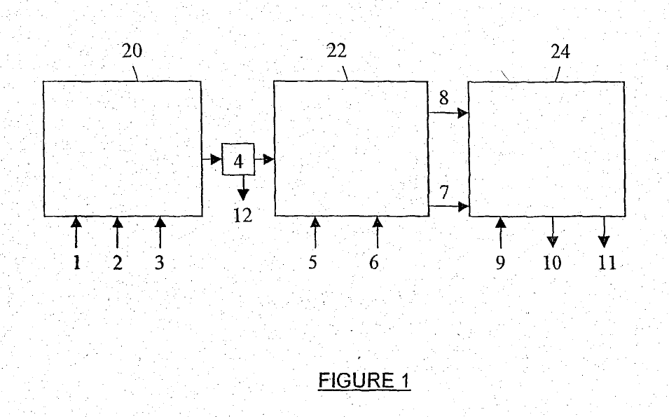

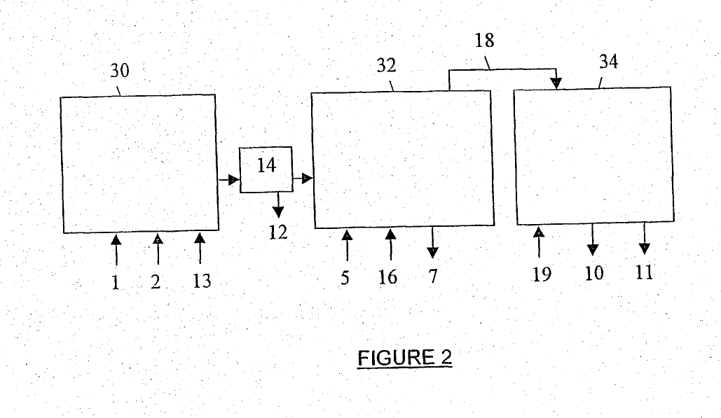

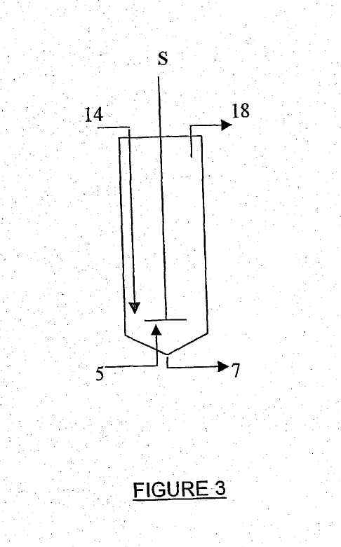

As stated above, FIG. 1 shows a flow sheet for production of particulate precipitated calcium carbonate according to the prior art. By contrast, in order to define the most suitable conditions to operate the carbonation stage of the present invention, a detailed description of parameters for the present process is given below. These also include some details of how to operate the upstream and downstream stages of the carbonation stage, as these may affect the final outcome (c. f. FIGS. 2 and 3).

In FIG. 1, which is a schematic representation of a prior art procedure for making a precipitated calcium carbonate, quicklime (CaO) and water, which react together giving slaked lime, are fed to reactor 20 via respective conduits 1 and 2, and optional additives such as aragonite calcium carbonate particles for seeding, phosphoric acids and salts, aluminum salts, oxides and hydroxide (other than CaO/Ca(OH)2), chelating agents, dispersants, and surface active agents, may also be added at this stage via conduit 3. The initial product “milk of lime” (calcium hydroxide) is fed via filter or hydrocyclone 4 (large solid particles being removed at 12) into carbonator 22, to which there is also fed gaseous carbon dioxide (or a gas containing it) via conduit 5 and the aforementioned optional additives via conduit 6. The reaction product including any contaminants exits carbonator 22 as an underflow via conduit 7 and/or an overflow via conduit 8, to further operations (at site 24) such as dewatering, grinding and coating; for such further operations there may be added optionally via conduit 9, e.g. dispersants, surface active agents, greases, silicon-greases, long-chain carboxylic acids and their salts and esters, organic and inorganic pigments, powder metals, coal, carbon black or activated carbon, and/or dyeing agents. The filtrate and water vapors exit the system via conduit(s) 10, while the final product (which may be wet or dry and optionally post-treated) exits via conduit 11.

In FIG. 2, which is a schematic representation of a procedure for making a particulate precipitated aragonite in accordance with the present invention, quicklime (CaO) and water which react together giving slaked lime are fed to reactor 30 via respective conduits 1 and 2, and the present active agent (and optionally also additives such as phosphoric acids and salts, chelating agents, dispersants, and surface active agents) may be added at this stage via conduit 13. The initial product “milk of lime” (calcium hydroxide) together with active agent if added to 30 (and optional additives) is fed via filter or hydrocyclone 14 (large solid particles being removed at 12) into carbonator 32, to which there is also fed gaseous carbon dioxide (or a gas containing it) via conduit 5 and the active agent (and possibly the aforementioned optional additives) via conduit 16. It will be appreciated that the active agent may be added either to reactor 30 or to carbonator 32, or to both. Contaminants and liquid exit carbonator 32 as an underflow via conduit 7, whereas—owing to the fact that an embodiment of the present process includes simultaneous flotation—the desired product exits as an overflow via conduit 18, to further operations (at site 34) such as dewatering, grinding and coating; for such further operations there may be added optionally via conduit 19, e.g. dispersants, surface active agents, greases, silicon greases, long-chain carboxylic acids and their salts (including if desired those within the definition of the present active agents) and esters, organic and inorganic pigments, powder metals, coal, carbon black or activated carbon, and/or dyeing agents. The filtrate and water vapors exit the system via conduit(s) 10, while the final product (which may be wet or dry and optionally post-treated) exits via conduit 11.

Slaking of Quicklime

Though this operation is well known in the prior art, it is worthwhile to choose a preferred mode of operation, which is best, adapted to the process of the present invention. Thus, fresh slaked lime is preferably prepared in a continuous mode of operation, which enables operation of the downstream carbonation stage using low inventories and exploiting to its maximum the energy that is liberated in the reaction between the water and the CaO, before this precious energy is lost to the surroundings. The present invention desirably makes use of this energy to effect the step of carbonation of the aqueous calcium hydroxide slurry at relatively high temperatures, more preferably without cooling or heating, or in other words, without adding or subtracting energy, and thus utilizing only the energy liberated by the carbonation reaction together with the energy produced by a powerful mixing system. Once again, use of fresh and still warm milk of lime is preferably an important factor in the success of the carbonation stage and this is more preferably effected, as mentioned above, in a continuous mode of operation, the temperature of the slaked lime being preferably maintained at about the temperature of the carbonation stage. However, in the alternative, a batch mode of operation may also be used for process of the present invention or the CaO can be introduced directly into the carbonator, as is demonstrated in the prior art.

Mixing of Quicklime

In some prior art patents it is recommended to use high shear mixers to slake the CaO with water. The process the present invention is quite tolerant to the kind of mixing, as long as the slaking reaction is complete and the maximum energy is liberated. Mixers that comprise rotor/stator mixing systems and mixers that comprise rotors only are suitable.

Purification of Slaked Lime Prior to Carbonation

There are numerous methods of purifying slaked lime before its utilization in the carbonation stage. Filtration by filters to remove large insoluble particles and/or separation of these particles by hydrocyclones are two efficient methods for this purpose. Usually, particles of greater diameter than 40 μm (up to 70 μm) are removed prior to the carbonation stage and the coarse particles can then be discarded or used in the construction industry, for example. The fine slurry is then ready for carbonation in the subsequent downstream stage. Naturally, feeding CaO directly into the carbonator, as mentioned above, does not allow to make use of such purification methods.

Sources of CaCO₃/CaO

Many sources of CaCO₃/CaO are too contaminated to be used to produce, by known methods, a particulate precipitated aragonite for the printing, (inks), coating (paint), paper, rubber, plastics, filtration, adhesives and sealants, pharmaceuticals, household and personal care and other industries, and their main use is, as very inexpensive materials, in the construction industry. On the other hand, the present invention may allow utilizing many of these “impure” CaCO₃/CaO sources and turning them into a particulate precipitated aragonite, of filler, extender and pigment grades. The present invention, as is manifested in the carbonation stage, is superior over any state of the art technology in salvaging CaCO₃ mines and turning them to profitable use, without changing greatly the state of the art methods for preparing the slaked lime.

Use of Additives

The state of the art technology for slaking quicklime includes adding a variety of additives into the milk of lime prior to the carbonation stage. According to the present invention, one of the preferred modes of operation is to add the active agent into the milk of lime prior to the carbonation reaction. Those skilled in the art of producing precipitated calcium carbonate must carefully check that the other additives, if any are present in the milk of lime, do not interfere with the ability of the active agent to enhance formation of the particulate precipitated aragonite and to cause its flotation in the carbonation reactor. For instance, the use of 1 wt. % (based on the calcium carbonate) of phthalic acid or trimelitic acid with about 1 wt. % (based on the calcium carbonate) of one of the most potent active agents of the present invention, n-decanoic acid, cause the formation of mostly the particulate calcite polymorph in the carbonation stage, under the specific conditions that are described in the experimental section, instead of obtaining mostly the aragonite polymorph. In other cases, the additives may cause the formation of mixtures of various concentrations of particulate precipitated calcite and aragonite, instead of quite pure particulate precipitated aragonite calcium carbonate.

The Reaction/Carbonation Stage

This operation is well known in the prior art. However, as this stage is the essence of the present invention, it is worthwhile to choose the mode of operation that suits it best. For example, although the use of aragonite particles for seeding is a recommended procedure in the prior art, it seems at the present time that this practice is unlikely to have any particular utility in the process of the present invention, since use of the active agent enables all desired objectives to be achieved.

As the most important functions of the active agent in the present invention are to catalyze the production of particulate precipitated aragonite, of improved physical and chemical properties and to cause its flotation in the carbonation reactor, all necessary measures should be taken in order to maximize these functions.

The Nature of the Active Agent and its Origin

While the scope of the present invention is not to be regarded as limited by any theory, nevertheless, it may be likely that the calcium salts of the carboxylic acids of the general formula RCOOH (of which more specific chemical structures have been mentioned already in greater details hereinbefore) operate in practice as the functioning active agent in the present process. It should not be ruled out, however, that for example, other derivatives of such acids within the scope of the invention may participate in similar activity.

The above-mentioned calcium salts of the relevant acids may be used as raw materials in the present invention. However, other compounds, which undergo chemical transformations to form the active agent under the process conditions, also serve this purpose as raw materials in the production of the desired particulate precipitated aragonite.

In a particular embodiment of the invention, which will serve here as an example, the active agent is selected from carboxylic acids of the general formula: CH₃(CH₂)ₙCOOH, where n=7-16, and including mixtures thereof. All these acids can be quite easily introduced into any of the production facilities. Pumping of these acids when their temperature is held above their melting points (e.g. >60° C.) seems to be a very useful method to deliver the acids into the suitable production units. Under such conditions, these thermally stable acids are immediately converted into their respective calcium salts when they are mixed with the hot aqueous calcium hydroxide slurry or with the hot carbonation mixture at pH>7. As water is the only by-product of the reaction between the calcium hydroxide and the respective carboxylic acids, the use of these acids, as raw materials in the process of the present invention, seems to have no harmful side effect.

The respective acid anhydrides of the general formula: (CH₃(CH₂)ₙCO)₂O, including mixtures thereof, where n=7-16, are as good a source for the active agent, as the corresponding acids. However, the anhydrides are much less safe to handle and they are much more expensive than the respective acids.

The carboxylate salts of the acids of the general formula: CH₃(CH₂)ₙCOOH, including mixtures thereof, where n 7-16, can serve as raw materials in the process of the present invention, e.g. where the cations are selected from Na⁺, K⁺, NH₄⁺, Li⁺, Mg⁺⁺ and especially Ca⁺⁺, but, generally, the use of these salts does not appear to have any advantage over the free acids. On the contrary, the salts are usually more expensive, they are not as easy to handle on an industrial scale as the respective acids and, except the Ca⁺⁺ salts, all the other salts add cations that, so far as is presently known, are not required in the present process. The Mg⁺⁺ salts present a special case, as they leads to the formation of hydromagnesite and thereby to a dramatic rise of the surface area of the product, to its contamination and to a large increase in the water content in the wet filter cake. Therefore, in the process of the present invention only limited concentrations of this cation are allowed, i.e. <1 wt. %, based on the calcium hydroxide (this limitation is removed if it is desired to exploit the process of the present invention to produce hydromagnesite or mixtures of hydromagnesite and PCC of the present invention. On the contrary, then Mg⁺⁺ can also be introduced as other Mg salts or, preferably, as MgO/Mg(OH)₂).

Esters of the following general formula: CH₃(CH₂)ₙCOOR′, where n 7-16 and R′ is an esterification radical such as alkyl, e.g. CH₃, C₂H₅, C₃H₇, etc., are also suitable candidates for the active agent in the present invention. However, in order for these compounds to generate e.g. the corresponding calcium salts, they have to undergo a basic hydrolysis, which may preferably be done by premixing them in the hot and basic aqueous calcium hydroxide slurry, in which they are hydrolyzed and thus converted to the respective Ca⁺⁺ salts. However, the use of these esters in the process of the present invention appears to be inferior to the use of the respective acids, for reasons, which will be self-evident to the skilled person.

Chemically equivalent to the other preferred active agents specifically mentioned above, are ketenes of the general formula: CH₃(CH₂)ₙ₋₁C═C═O, wherein n=7-16, and including mixtures thereof, behave in a similar manner and entail similar drawbacks as for the acid anhydrides, as mentioned above.

Therefore, the acids of the general formula: CH₃(CH₂)ₙCOOH, wherein n=7-16, including mixtures thereof, are the presently preferred source for the active agent to be used in the process of the present invention. More specifically, decanoic acid (who rein n=8) is presently one of the most potent and preferred acids, as it leads to products of the present invention of which the content of the aragonite isomorph is the highest, under comparable conditions. Lauric acid (wherein n=10), myristic acid ((wherein n=12) or even stearic acid (wherein n=16), relatively abundant and less expensive raw materials, may be preferred in some other cases, in which the maximum content of the aragonite ismorph in the product is not critical or in cases in which controlled concentrations of the calcite isomorph in the product of the present invention may even be desirable.

It seems that the process of the present invention is quite more general than it was thought originally. It was as also found out that undecylenic (or 10-undecenoic) acid (CH₂=CH(CH2)₈COOH) is also a very potent active agent in the process of the present invention and others will, probably, be sorted out in the future, using the conditions of the novel, process of the present invention and the simple and straight-forward methodology of how to determine which compound (carboxylic acid) is an active agent.

The Reactor/Carbonator/Flotation Cell

As already mentioned above, the carbonation stage can be conducted in any well-stirred reactor according to the prior art. However, due to the fact that the active agent is a unique material that can enhance the formation of the particulate precipitated aragonite of the present invention, in the reaction between aqueous calcium hydroxide slurries and carbon dioxide gas or a carbon dioxide containing gas, and also due to the fact that the active agent can cause this product to float, the presently preferred carbonators to be used in the process of the present invention are flotation cells.

These cells may be operated somewhat differently from the regular carbonators and the regular flotation cells, as both functions (carbonation and flotation) take place in the same production unit of the particulate precipitated aragonite, of the present invention. The exact set-up of these flotation cells can vary, as this will depend on, for example, the preferences of the skilled designer, the precise nature of the desired product, the quality of the aqueous calcium hydroxide slurries, etc. For example; a flotation cell like that depicted in FIG. 3, containing stator/rotor or rotor only S, is suitable for carrying out the inventive process, and of which the main features are as follows:

A. The stream of slaked lime (14) is preferably introduced near the inner circumference of the reactor and above the stirring blades.

B. The stream (5) of carbon dioxide gas or carbon dioxide containing gas is preferably introduced through suitable spargers at a point below the stirring blades, but still not too close to the bottom of the cell, to avoid excessive mixing near the outlet stream (7) of the contaminants and liquid.

C. The wet product and the gas are preferably discharged from the top (18) of the cell. The customary skimmer for skimming the product out of the flotation cell, and hydrocyclones for efficient product/gas separation, are not shown in FIG. 3.

Mode of Operation in the Carbonation Step

Continuous reaction/carbonation of the aqueous calcium hydroxide slurry with carbon dioxide gas or a carbon dioxide containing gas is the most suitable mode of operation for the present invention, especially because of the huge potential market for the produced particulate precipitated calcium carbonate, and particularly particulate precipitated aragonite.

Semi-continuous (intermittent) operations may also be used. However, as may be understood from the desirability of operating the process at its utmost efficiency, e.g. as a flotation operation, it is unlikely that an intermittent mode of operation can compete economically with the continuous mode of operation.

A “real” batch mode of operation, in which the milk of lime and the active agent are mixed together and carbon dioxide gas or a carbon dioxide containing gas is introduced to precipitate the desired product until the reaction mixture turns neutral (at about pH −7), appears not to be viable, probably because the active agent is not efficient in catalyzing the formation of desired product, at the high initial pH characteristic of the batch mode of operation in this case, and/or because the active agent is adsorbed onto the surface of the first formed crystals of particulate precipitated calcium carbonate, where it is then “buried” under the subsequent PCC. In such circumstances, the active agent is very quickly depleted from the reaction zone, and the process of the invention, as such, is likely to become inoperable.

Temperature of the Carbonation Step

The prior art teaches producing a particulate precipitated aragonite, at a temperature range between 60° C. and the boiling temperature of the reaction mixture, at ambient pressure, and the present process is preferably conducted similarly, because lower temperatures favor the formation of calcite.

On the other hand, operating the process at a temperature as close as possible. to the boiling point of the reaction mixture is presently particularly preferred, since these conditions give a product of relatively lower water content in the wet filter cake, which is a great advantage in many applications of the product.

While the present process may be operated at higher temperatures and pressures (since the active agent is stable under such conditions) this kind of operation is associated with serious technological problems that may adversely affect the whole economics of the process.

Concentration of Ca(OH)₂ Slurry in the Carbonation Step

The prior art method for producing a particulate precipitated aragonite, may be classified into three principle modes of operation. The first mode is operated at very low concentrations of the calcium hydroxide in water, and in some cases a clear solution of <1 wt. % calcium hydroxide is used. In the second mode, there are used aqueous calcium hydroxide slurries and active agents to induce the formation of the desired particulate precipitated aragonite, albeit, at very low production rates. In the third mode, particulate precipitated aragonite is used for seeding, in order to improve production rates.

The present invention requires relatively high concentrations in the aqueous calcium hydroxide slurries and the production rates are very fast. Actually, at the range of very low concentrations of <2 wt. % (based on the calcium hydroxide) the present process may not “ignite” right away and under these circumstances no desirable “porous” product of the present invention is obtained, but rather, only precipitated calcite calcium carbonate particles, or mixtures of mainly such particles.

The present invention can use quite dense aqueous calcium hydroxide slurries of up to about 30 wt. % calcium hydroxide, but such dense slurries are very viscous and are very difficult to handle. Therefore, the preferred range of concentrations of the aqueous calcium hydroxide slurries, according to the present invention, are in the range between 4% and 20 wt. %, and more preferably between 5% and 15 wt. % calcium hydroxide. In these ranges, the viscosity of the reaction mixture permits smooth operation, while the energy maintained already in the feed of aqueous calcium hydroxide slurry (as discussed above), plus the energy liberated by the carbonation reaction, as well as the energy liberated by the mixing system, are sufficient to maintain the desired reaction temperature without any external heating or cooling.

Concentration of Active Agent in the Carbonation Step

To simplify the calculations of how much active agent is needed in the process and how much of it may be included in the product of the present invention, we prefer to use the weights of the respective acids, since the carboxylate moieties differ from their respective acids by less than 1%. Therefore, in cases that suitable ketenes, esters, carboxylate salts, acid anhydrides and/or acyl halides are being used, the equivalent weight of the respective acid should be calculated, unless otherwise indicated. Moreover, as we are presently aware of differences among the activities of the acids of the general formula e. g. CH₃(CH₂)ₙCOOH, wherein n=7-16, including mixtures thereof, their individual contribution to the total weight of the active agent should be calculated arithmetically, namely by adding the weight of each individual acid, as if these are of the same chemical entity. This concept is important for understanding this invention and particularly the claims, unambiguously. The difference between the molecular weights of the respective acids (−±30%) is not a great problem, because a person skilled in the art will in any event check carefully what is the exact amount of the relevant carboxylic acids that is necessary to operate the process in a manner, which is not sensitive to even larger variations of the concentrations of the active agent, namely, of >±30 wt. %, based on CaCO₃. Moreover, when using decanoic acid as the presently preferred active agent, the present invention will not even be subject to the above-mentioned inaccuracy.

To determine the concentration range of the active agent in the present invention, it is important to be aware of the various functions of this agent in the production process and the effects that it produces in the final product.

The prior art describes many additives that assist in producing particulate precipitated aragonite, but none of these additives is comparable to the present active agent, under the selected process parameters, for the following two major reasons:

1. The active agent leads to a dramatic reduction of the specific gravity of the particulate product and allows use of the flotation method to separate the “light” particulate precipitated aragonite, from the “heavy” contaminants (containing aluminosilicates and heavy metal salts, carbonates and oxides). These “heavy” particles sink down to the bottom of the carbonator/flotation cell and are discharged from the production unit without reaching the downstream filter, and

2. The optical properties of the particulate precipitated product are altered and its effective refractive index is increased dramatically.

Thus, according to one of the preferred modes of operation, the pure product of the present invention, on the flotation embodiment, is being carried to the top of the reactor/carbonator/flotation cell, by the small bubbles that adhere to the tiny precipitated particles, and this relatively pure product is discharged from the top of the carbonator/flotation cell prior to any downstream operation. Thus, in this embodiment, the present process entails an intrinsic, built-in, extra purification operation, prior to the downstream dewatering operation, which is not so common in the prior art.

This unique property of the active agent to cause the flotation of the “light” particulate precipitated calcium carbonate, is also a reason why this embodiment of the present invention is superior over any of the prior art production technologies in exploiting highly contaminated sources of CaCO₃/CaO, which have hitherto been unsuitable as raw materials for production of a particulate precipitated calcium carbonate, and particularly particulate precipitated aragonite, of filler, extender and pigment quality grades. Such sources can now be utilized successfully, using this novel technology of the present invention.

Since the aqueous calcium hydroxide slurry is usually quite contaminated and the impurities are liable to affect performance of the active agent, the threshold (minimum) concentration of the active agent will vary, but is within the competence of a skilled person to determine, under any particular set of circumstances. Moreover, the threshold concentration will also vary with the kind of active carboxylic acids that will be used. In any case, it is desirable to avoid this threshold concentration at the carbonation stage, as this is a point of instability and would involve unnecessary risk to the desired objective. When considering use of a new feedstock of CaCO₃/CaO, laboratory experiments will reveal the minimum concentration of the active agent, which is necessary to start the production of the desirable particulate precipitated calcium carbonate, and particularly particulate precipitated aragonite, without any faults (vis-a-vis the pertinent CaCO₃/CaO feedstock). This value is expected to be in most cases above 0.2 wt. %, preferably within the range 0.4% to 3 wt. %, based on the calcium carbonate.

It is very important to note that this threshold concentration, discussed above, for catalyzing the production of particulate precipitated aragonite, of the present invention (−0.2% wt. %, based on CaCO₃) is substantially above the threshold concentration that is required to cause the flotation of this product in aqueous solutions (−0.02% wt. %, based on CaCO₃) and that by operating in the concentration range merely for a “proper” flotation process, nothing that is disclosed in the present invention really happens. Actually, the optimal physical and chemical properties of the particulate precipitated aragonite calcium carbonate, of the present invention are attained at above 100 fold of this concentration (−2-3 wt. %, based on CaCO₃).

Other factors may indicate use of even higher concentrations of the active agent in the production process of the present invention. For instance, coating the surface of the particulate precipitated aragonite, with a predetermined rather thick layer of the active agent, in situ, in a carbonator/flotation cell, may require quite high concentrations of this material, which may exceed 5%, 10% and even 15 wt. %, based on CaCO₃, in order to produce good surface coated hydrophobic and acid resistant particulate precipitated aragonite (e.g. for master batches). Naturally, at such high active agent concentrations, the cost component of the coating should then be compared to the alternative possibilities of downstream coating, which are also available in the prior art, as well as in the present invention (c.f. FIGS. 1 and 2, respectively). Another serious reason to avoid operating the process at too low concentrations, is the fact that the chemical and physical properties of the product, and especially its optical properties and specific gravity, which are quite interdependent, are dramatically affected by the concentration of the active agent.

In between the upper limit and the threshold limit of the concentration of the active agent in the process of the present invention, the optimum concentration should also be determined by one skilled in this art, either vis-a-vis the quality of the CaCO₃/CaO, or whenever the properties of the product are to be changed. The active agent is not an expensive material, but still it may throw an economical burden on the total cost of the final product due to the fact that even quite pure particulate precipitated aragonite is a relatively inexpensive material.

Intuitively, the concentration of 10 wt. %, based on the calcium carbonate, seems to be an economical upper limit of the active agent, while 0.2 wt. %, wt; based on the CaCO₃, seems to be its threshold (minimum) concentration.

Carbon Dioxide in the Carbonation Step

Use of carbon dioxide gas or a carbon dioxide containing gas is well known in the prior art methods for producing precipitated calcium carbonate particles. The process of the present invention is similar in this respect to the prior art processes that operate with substantially pure carbon dioxide gas as well as with mixtures of carbon dioxide with up to about 92 v% inert gases (e.g. air). At lower concentrations of the carbon dioxide in the feed gas (<8 wt. %), however, the efficiency of the process may be too low, mainly, due to the cooling effect of the excessive gas.

In order to understand how to control the process of the present invention, It is worthwhile to describe the major effects that are observed at the two limits, namely, when using “rich” feed gas of about 100% carbon dioxide on the one hand and using “lean” feed gas of about 8 v% carbon dioxide on the other hand. It was found that “rich” carbon dioxide gas feed leads to a PCC, of the present invention, that gives rise to products of much higher gloss than those that are produced from the PCC, of the present invention, that are produced with a “lean” carbon dioxde feed under similar production conditions. Namely, the gloss of the final (consumer) products can easily be fine-tuned by just choosing the right CO₂/inert gas (air) ratio. This fact may be exploited, especially, in using the product of the present invention in formulations that are intended to be used e. g. in the coating industry, which requires quite often low gloss products and in the paper industry for coating paper and obtaining a desirable product of high gloss.

Another phenomenon that is observed when using “lean” feed gas is that it leads to a PCC, of the present invention, of lower specific gravity and of higher hiding power, compared to a PCC, of the present invention, that is produced with “rich” feed gas under similar conditions. That, in turn, allows to include carboxylic acids within the patent range, which otherwise could not meet the constrains that were set up to determine which carboxylic acid is within the borders of this invention and can be used as an active agent to produce the product of the present invention. For instance, under the conditions of the screening test (Example 1; that is described hereinafter), Lauric acid could not be considered active agents (its product was considered “Calcite” as its crystallographic purity (aragonite/(aragonite+calcite)) was only 20%−25% and its specific gravity (in tall oil; after drying it at 120° C. for twelve hours) was only 2.54 g/cm³; When using a “lean” feed gas of 26% CO₂ (by volume) the specific gravity of the, product decrease dramatically to 1.78 g/cm³. Therefore, based on the too high specific gravity values that were obtained for lauric acid, for palmitic acid and for stearic acid, myristic acid was not considered, at that time, to be a viable candidate to catalyze the process of the present invention and, therefore, due to constraints of time, it was not tested and not included in Table 1. The use of very “lean” gas feed allows to sort out and use much more carboxylic acids (lauric acid, myristic acid and even stearic acid) to serve as the active agents of the process of the present invention, using the simple and straight forward methods that were developed herein

Additives in the Process

The process of the present invention is quite self-sufficient and requires only the active agent in suitable quantities, as discussed above. The active agent can be introduced preferably already premixed with the aqueous calcium hydroxide slurry, or alternatively (or additionally) it can be introduced directly into the carbonator. The active agent can also be used downstream the carbonation stage, but that, naturally, has no effect on the production of the particulate precipitated calcium carbonate, and particularly the particulate precipitated aragonite, in the carbonator.

It appears that the active agent has a surprising affinity to the aragonite, which is unlikely to be adversely affected by the presence of other additives. Consequently, additives like phosphoric acids and water soluble salts thereof, can be used in the present invention to modify the product properties by increasing the aspect ratio of the thus formed acicular crystals; polyacrylates, polyacrylamides and some short-chain carboxylic acids can be used to modify the rheology of the product mixtures and allow operation at higher calcium hydroxide concentrations and, consequently, at higher throughputs; chelating agents can be used to convert heavy metals into water-soluble species and once again lead to super-pure products; metal powders and carbon black may be introduced to obtain electrically conductive powders; soluble aluminum salts may affect the shape of the calcite particles; and magnesium salts or preferably MgO/Mg(OH)₂ may lead to hydromagnesite. The prior art is infested with examples of additives that are used to achieve improved particulate calcium carbonate products. These additives and many others may, potentially, be used in the product (process) of the present invention.

It is nevertheless prudent to check carefully the effect that well known additives of the prior art may have on the action of the active agent, but in most cases the active agent will be the dominant catalyst for the purpose of the present invention and, therefore, such additives can usually be introduced at various stages of the process, as is customary in the prior art (c.f. FIGS. 1 and 2).

The Mixing System

The need for high shear mixing in this process is well known in the relevant art. The mixers may be a rotor/stator type or a rotor only type. Usually, the latter one is used to produce relatively larger product particles, while the rotor/stator type leads to much higher attrition of the acicular crystals. On the other hand, the rotor/stator type may allow a more efficient dispersion of the gas bubbles, thereby improving the quality of the product. The skilled operator will utilize the preferred mixing system for working or enhancing the present process. The type of mixers and the rotor speed should be optimized according to the desired carbonation performance and the desired product characteristics.

The lower limit of the rotor speed (hereinafter—“Tip Speed” or “Peripheral Speed”) is known in the prior art. A requirement of a minimum tip speed of about 5 m/sec., to effect the formation of desired product is not unusual in this art.

The upper limit of the rotor speed is determined by mixer technology, cost of the specific mixer, the nature of the desired product and the energy that is to be used. For instance, the higher the rotor speed, the lower may be the reaction time (in a continuous process, the reaction time is termed HUT (Hold Up Time) and it is calculated as follows: HUT=V (the carbonator volume)/F (the discharge rate of the product mixture out of the carbonator)). This in turn may lead to small particles. A skilled person in this art will know how to optimize the kind of mixers and rotor speeds above the minimal peripheral speed, which is preferably 5 m/sec.

The Reaction Duration in the Reactor/Carbonator/Flotation Cell

As already mentioned above, the carbonation step is preferably conducted in a continuous mode of operation. In such a case, “reaction duration” is hardly relevant, but we can calculate the HUT (Hold Up Time), which lies essentially within the range between 5 minutes and 180 minutes. At below the lower limit of the HUT the yields may be too low and the PSD (Particle Size Distribution) of the product may be too small, while at the upper limit of the HUT the process throughput may be too low, the yields may be excellent and the PSD may be too small, because of excessive attrition of the product in the flotation cell. Once again, the skilled person will be able to determine by experiment, suitable working parameters vis-a-vis the desired product properties and to optimize its quality and cost.

The Specific Gravity and Bulk Density (L.B.D. and/or T.B. D.) of the Particulate Precipitated Calcium Carbonate of the Present Invention

While the present invention is not limited by any theory, it may be that trapped gas (air) in the product could account for the unusual properties observed in the present product. The specific gravity (S.G.) and bulk density (L.B.D. and/or T.B.D.)_of the PCC of the present invention are measured for the following three major reasons:

(a) to distinguish the product of the present invention from the products of the prior art;

(b) to distinguish the process of the present invention from the processes of the prior art; and (c) to control and optimize the process and the product of the present invention.

Specific Gravity (S.G.)

The specific gravity of calcite and of aragonite are well documented in the literature and are always well above 2.5 g/cm³. However, measurement of the S.G. of the present product, as well as the PCC/GCC products of the prior art, which may be coated with hydrophobic coatings (e.g. calcium salts of long-chain carboxylic acids), may lead to erroneous results, if superficially adhering air bubbles are not thoroghly removed.

In order to better differentiate the products of the present invention from those of the prior art, the S.G. of the dry products may be determined in various oils, which simulate the practical environment, in which the PCC/GCC particles are customarily used, at least in certain applications. This determination may be carried out on the dry products as produced, and/or after igniting them at 500° C. for eight hours, e.g. as is described in Example 14 (E) herein. The S.G. values of the dried PPC/GCC particles should reflect their real properties under conditions in which they are to be used in most cases, while the S.G. values determined after calcination should reveal whether the S.G. values of the dried products indicate significant structural differences from prior art products. Merely determining that the S.G. of the dried (but not calcined) products is <2.5 g/cm³ will not necessarily distinguish these products from those of the prior art, whereas the S.G. values determined after calcination are the most decisive and accurate criteria to determine that the relevant product has a specific gravity of <2.5 g/cm³ (preferably <2.3 g/cm³ and more preferably <2.1 g/cm³) and, therefore, that it is indeed the product of the present invention. Similar considerations apply to the determination as to whether the process that produced such a product is a process according to an embodiment of the present invention. The total elimination of the carboxylates from the PCC particles after such a thermal treatment (i. e. <1 ppm; as measured by GC-MS analyses), solves the problem of gas bubbles adhering onto the surface of the measured PCC samples, and thus the specific gravity values for products of the prior art (calcite, as well as, aragonite) are always >2.5 g/cm³ (even >2.65 g/cm³), while the products according to a particular embodiment of the present invention are characterized by their specific gravity values <2.5 g/cm³ (preferably <2.3 g/cm³ and even more preferably <2.1 g/cm³).

As already mentioned, the PCC particles are usually being used in practice without any such a drastic ignition treatment (at 500° C. for 8 hours) and in most cases the PCC particles are even not being dried, but rather dispersed in water, after the dewatering step, using known dispersants to obtain stable dispersions (slurries of >50 wt %). Therefore, the PCC particles of the prior art may be coated with carboxylates, and therefore, they may be surrounded by gas (usually air) bubbles that lead to a seemingly “reduced” specific gravity, of value below 2.5 g/cm³. However, this erroneous situation lasts only until these PCC particles are subjected to high shear forces (e. g. in the processes of making coatings, inks and papers), which causes the separation of these gas bubbles, unless they are “hidden” deep below the surface of the PCC particles, and that is, probably, the basis of the present invention. Therefore, any suggestion that is made herein to measure the specific gravity of the PCC particles, after drying them at 120° C. for 12 hours only, is just to get the notion that indeed the respective product may be of suitable properties and be further ignited at about 500° C. for the time that is necessary to remove all the organic moieties, before further specific gravity tests are conducted. A person skilled in the art may choose other conditions to perform this task, but then he should make sure that the organic compounds are no longer in/onto the tested PCC particles.

Contrary to what was thought before, that the “pores” in the PCC particles of the present invention are closed, we know now that these “pores” are semipermeable (or selectively permeable) to liquids and gases. Any attempt to use the regular gas phase pycnometer measurements to determine the specific gravity of commercial PCC particles, as well as the PCC of the present invention, will lead to values well above 2.5 g/cm³, irrespective of the kind and source of these calcium carbonate products or the kind of treatment that these samples received prior to the specific gravity analyses (c. f. Example 14 (D)). Namely, using such a practice would have resulted in totally overlooking the present invention. However, conducting specific gravity analyses of the PCC particles of the present invention in liquids like water, oleic acid (>97%), cold pressed edible olive oil, refined edible sunflower oil, refined edible corn oil, refined edible soybeans oil, refined canola oil, and tall oil, leads to values <2.5 g/cm³ (preferably <2.3 g/cm³ and more preferably <2.1 g/cm³), as shown e.g. in Example 14 (H). Similar measurements of the specific gravity of commercially available GCC (calcite) and PCC (calcite and aragonite) gave always rise to values that were >2.5 g/cm³ (even >2.6 g/cm³ and even >2.7 g/cm³). When the measurements of the specific gravity were conducted in water, the specific gravity of the products of the present invention were <2.5 g/cm³, but however, when a small amount of sodium dioctylsulfosuccinate (2%) was added to the slurry, the specific gravity of the PCC particles increased quite fast and ended up at values >2.7 g/cm³ (such a phenomenon could not be observed in the case of the prior art GCC or PCC products). This phenomenon of penetration of liquids into the “pores” of the product of the present invention has a lot of benefits, but when this happens on preparing the usual stable slurries of PC (of >50 wt %) by mixing the PCC, water and a suitable dispersants, it results in a very thick, high viscose mass. At the preparation stage, PCC slurries made of a product of the prior art look, superficially, quite similar to those that are made of the product of the present invention, but this superficial appearance may mislead. For instance, measuring the specific gravity (S.G.) of the PCC particles of the prior art will result in values that are >2.5 g/cm³, while the S.G. values of the PCC particles of the present invention will be considerably lower. Moreover, the addition of a wetting agent, like the sodium dioctylsulfosuccinate, to these slurries will reveal a much more dramatic behavior. Namely, such slurries of the PCC particles of the prior art may not be affected much, but the slurries made of the PCC particles of the present invention will turn into a dense and thick high-viscose mass and the S.G. values of the particles therein will increase to >2.7 g/cm³, due to the penetration of the aqueous phase into the PCC particles.

Due to the fact that the “pores” in the products of the present invention are not closed to gases and to some liquids, it is important to avoid the customary gas pycnometer specific gravity (S. G.) measurements when analyzing the product of the present invention, and rather follow the exact instructions of how to do it (c. f. in Example 14 and especially in Example 14 (E)). These measurements reveal best the desired properties of the novel products of the present invention and of the process of the present invention and give a close picture of how these PCC particles are going to improve the final (consumer) products, due to their unique property—“porosity”.

Bulk Density (L.B.D. and/or T.B.D.)

Another observation can be made, based on the experimental data that was collected thus far, that the bulk density (L.B.D. and/or T.B.D.) of the products of the present invention have remarkably lower values (L.B.D. <0.55 g/cm³ and even <0.45 g/cm³ and/or T.B.D. <0.70 g/cm³ and even <0.60 g/cr³), than those of similar products of the prior art (which usually. have L.B.D. >0.6 g/cm³ and T.B.D. >0.8 g/cm³). Therefore, we may also use these alternative criteria, i.e. L.B.D. and/or T.B.D., to indicate whether a product is in the domain of the present invention. An exemplary procedure of how to perform these tests will be detailed in Example 14, parts (F) and (G), respectively.

Generally, particulate PCC products, previously dried at 120° C. for twelve hours, that are of SSA (Specific Surface Area) (BET) ? 15 m²/g will belong to the domain of the present invention, i.e. in the embodiments linked to bulk density and/or S.G. considerations, if they have a L.B.D. of less than 0.55 g/cm³ and/or a T.B.D. of less than 0.70 g/cm³ and otherwise satisfy the definitions recited in the claims. Products of higher SSA will generally not be tested for L.B.D. and/or T.B.D., but rather only by the S.G. test, as instructed e.g. in Example 14 (E).

The present invention will now be described in more detail by way of Examples, which are presented for illustration purposes only and are not be construed restrictively.

Experimental:

Raw Materials:

A. All raw materials were purchased from Aldrich, unless otherwise specified.

B. Ethyl decanoate was prepared by reacting decanoyl chloride with ethanol in the presence of triethylamine at about 50° C. After about 3 hours the product was washed with water to remove water-soluble residues and it was then dried at about 50° C. under a vacuum of about 30 mm/Hg.

C. Sodium decanoate was prepared by thoroughly mixing decanoic acid with 2% aqueous NaOH at about 70° C. until the pH passed 10.

D. Potassium decanoate was prepared by thoroughly mixing decanoic acid with 2% aqueous KOH at about 70° C. until the pH passed 10.

E. CaO(1)—of Arad, Israel.

F. CaO(2)—of Shfeya, Israel.

G. Commercial PCC—Aragonite; of Specialty Minerals Inc. (SMI); Opacarb® A40.

H. CO₂—Cylinders of 100% pure compressed gas of Mifalay Hamzan Ltd., Haifa.

I. Tall Oil (Sylvatal 20S) of Arizona Chemical, USA.

J. Ultrafine stearic acid coated GCC—Omya UFT 95 ex Omya-Pluess-Staufer—Switzerland.

K. A commercial ultrafine stearic acid coated—Ultraflex PCC ex SMI—USA.

L. A commercial ultrafine talc—Ultratalc 609 ex SMI—USA.

M. Isostearic Acid—Emersol 875 ex Henkel—Germany.

N. Anise Alcohol (ex Koffolk—Israel).

O. Hexabromocyclododecane (Syntex HBCD ex Albermarle—USA).

P. NeendX (ex Albermarle—USA).

Q. Diazinon (Diazol ex Makhteshim-Agan—Israel).

R. The Paint Constituents:

Nopco NDW of Henkel

Cellosize QP 15000 (hydroxy ethyl cellulose) of Union Carbide

Disperse One (45% N.V.) of Tambour, Israel

Synperonic NP10 of ICI

TiO₂ (Kronos 2160) of Kronos (However, similar TiO₂ pigments, like Tioxide R-TC90 and Tioxide TR92, of which their D₅₀=220 nm±20 nm may serve equally well)

Synthetic sodium aluminum silicate (p820) of Degussa

Kaolin clay (D₅₀=3.1 micron) of Engelhard

CaCO₃ powder (d₅₀=3.5 microns) of Polychrom, Israel—“Girulite-8”

Talc (D₅₀=12.3 micron) of Lusenac Val Chisone

Copolymer vinyl acetate acrylate emulsion (55% N.V.) of Cerafon, Israel

Butyl diglycol acetate of Union Carbide

Kathon LXE of Rohm & Haas

Ammonia (25%) of Frutarom, Israel

Antioxidant (irganox B225 ex Ciba Specialty Chemicals—Switzerland)

Lubricant (Wax PE 520 ex Hoechst-Celanese—USA)

Polypropylene copolymer (Capilene-TR50 ex Carmel Olefins—Israel).

Instruments and Accessories:

1. pH meter/controller; Jenco; Model 3671; Made in China.

2. pH electrode; Hanna Industries; type HI 1131B (Glass Probe).

3. Thermometer; Jenco Model 3671; Made in China.

4. Peristaltic pump; Watson-Marlow; Model 505 u (variable speed).

5. Agitator; Ika; Model RW-20 (variable speed).

6. Dissolver; Hsiangtal; Model HD-550; Made in Taiwan

7. Ultra-turra® T50; Ika; rotor d=3.8 cm; stator d=4 cm.

8. Disk type rotor of d=12 cm.

9. Disk type rotor of d=8 cm.

10. Saw-blade type rotor of d=9 cm.

11. Saw-blade type rotor of d=4.8 cm.

12. Hydrocyclone 2″; Mozely; P=50 psi; vortex finder=11 mm; spigot=6.4 mm.

13. Vacuum pump; Vacuumbrand GmbH; Model MD 4C.

14. Buchner+filter cloth with 8-10 μm pores.

15. XRD (X-Rays Diffractometer); Siemens D-500 for the crystallographic phases.

16. SEM (Scanning Electron Microscope); Jeol 5400 for the shapes of the particles.

17. Colorimeter; Hunterlab D25-PC2 for whiteness measurements.

18. Colorimeter; ACS instrument (Applied Color Systems).

19. Ultrasonic bath (10 I); Selecta, Spain—“ULTRASONS”.

20. Ultrasonic cleaners (baths) of limited power (<100 Amp.Volt.) e.g. P-08890-01/06 ex Cole Parmer—USA.

21. Analytical Balance; Shekel Ltd., Israel.

22. HPLC Analyzer; Waters HPLC Analyzer (Detector 486+Autosampler 717+Pump 510+millenium Software).

23. HPLC Column; Phenomenex C18(250 mm×4.3 mm; 5 m Particle size).

24. AccPyc 1330 ex Micromeritics—USA.

25. Glossmeter (Minigloss 101 N ex Sheen Instruments—England).

26. Reflectometer (Ref. 310 Sheen-Opac ex Sheen Instruments—England).

27. Twin-screw compounder (UD=24 ex Dr. Collin—Germany).

28. Injection machine (25 t ex Dr. Boy—Germany).

29. Screen-shaker (Rotap Model RX-29-10 ex WS. Tyler Inc.—USA).

30. GC-MS for trace analysis—of HP Model 589015971.

PREPARATION I—Preparation of Aqueous Calcium Hydroxide Slurries:

The aqueous calcium hydroxide slurry was prepared in the laboratory in a batch mode of operation as follows: 40 kg of tap water were introduced into a 50 I. stainless steel 316 reactor that was equipped with a steam heated jacket, a thermometer and with the Hsiangtal Dissolver with a rotor of d=12 cm. The Dissolver was operated at 200 rpm, 4 kg of CaO (Shfeya) were added to the reactor during less than 10 minutes and the slurry was allowed to stir for 10-0 minutes. At that time the temperature rose to above 60° C. and when it reached its maximal temperature at 80-90° C., the mixture was ready for its purification prior to the carbonation stage, as follows:

a. The slurry passed a stainless steel 316 screen to remove particles of d>2 mm, and

b. The filtered slurry passed a hydrocyclone to remove particles of d>50 μm.

Notes:

At this point the warm aqueous calcium hydroxide slurry was ready for its use in the carbonation stage and its temperature was maintained at a preset value by heating the slurry in the above reactor in order to control the temperature in the carbonator.

The potential active agent(s) and any optional additives could be blended into the warm slurry at a preset concentration before the purification steps a. and b. or thereafter.

This batch mode of operation is used only in the laboratory tests. The production plant is intended to be operated under a continuous mode of operation, as is discussed herein.

PREPARATION II—Preparation of Aqueous Calcium Hydroxide Slurries:

PREPARATION I was repeated using CaO of Arad, a substantially purer raw material than that of Shfeya (the respective whitenesses are >95% and −88%).

### EXAMPLE 1

Screening Test for the Potential Active Agents:

Possible active agents were investigated by producing particulate precipitated calcium carbonate according to the following procedure:

2 kg tap water were added to a 3.2 I. stainless steel 316 reactor (of inner diameter d=15 cm and length−18 cm), equipped with a steam heated jacket, a pH electrode, a thermometer and the Hsiangtal Dissolver with a saw-blade rotor of d=4.8 cm (c.f. FIG. 3). The Dissolver was operated at a preset speed and carbon dioxide gas or a carbon dioxide containing gas and the aqueous calcium hydroxide slurry of PREPARATION I, containing already the active agent, were fed simultaneously into the reactor, while maintaining the pH, the temperature and the production rate at preset values. The product was collected at the top of the reactor, and the impurities were discharged from the bottom of the reactor (naturally, the product exited from the bottom of the reactor when the experimental active agent did not lead to a particulate precipitated aragonite and to its flotation).

The first. 10 I. of resulting slurry were discarded. The residual slurry was collected and it was filtered through a filter-cloth on the Buchner using a vacuum pump to dewater the product. The filter cake was dried for 12 hours at 120° C. and the crystallographic morphologies and the shapes of the crystals of the precipitated calcite and/or aragonite calcium carbonate particles were determined using XRD and SEM analyses, respectively. The results are shown in the Table 1, below.

The process set points—continuous mode of operation:

1. Rotor Speed=4000 rpm (Tip Speed—10 m/sec.).

2. pH=9.5.

3. Temperature=85° C.

4. Carbon dioxide flow rate=180 L.P.H. (liters/hour).

5. Aqueous calcium hydroxide slurry (of Shfeya) —1.0% (wt)=6 L.P.H. (to maintain preset pH value).

6. Potential active agent concentration=1 wt. %, based on CaCO₃.

TABLE 1
the results of EXAMPLE 1

| Test | | Number of | Product |
|---|---|---|---|
| # | Active Agent | Carbons | (Isomorph) |
| 1 | Propionic acid | 3 | Calcite |
| 2 | Lactic acid | 3 | Calcite |
| 3 | Pyruvic acid | 3 | Calcite |
| 4 | Acrylic acid | 3 | Calcite |
| 5 | Methoxyacetic acid. | 3 | Calcite |
| 6 | Methacrylic acid. | 4 | Calcite |
| 7 | Butanoic acid | 4 | Calcite |
| 8 | Pentanoic acid | 5 | Calcite |
| 9 | Hexanoic acid | 6 | Calcite |
| 10 | Heptanoic acid | 7 | Calcite |
| 11 | Octanoic acid | 8 | Calcite |
| 12 | Phthalic acid | 8 | Calcite |
| 13 | Terephthalic acid | 8 | Calcite |
| 14 | 2-Ethylhexanoic acid | 8 | Calcite |
| 15 | Nonanoic acid | 9 | Aragonite |
| 16 | Nonanoic acid* | 9 | Aragonite |
| 17 | Azelaic acid | 9 | Calcite |
| 18 | Trimelitic acid | 9 | Calcite |
| 19 | Decanoic acid | 10 | Aragonite |
| 20 | Decanoic acid* | 10 | Aragonite |
| 21 | Sodium decanoate | 10 | Aragonite |
| 22 | Potassium decanoate | 10 | Aragonite |
| 23 | Ethyl decanoate | 12 | Aragonite |
| 24 | Decanoyl chloride | 10 | Aragonite |
| 25 | Decanoic acid anhydride | 20 | Aragonite |
| 26 | Undecanoic acid | 11 | Aragonite |
| 27 | Undecanoic acid* | 11 | Aragonite |
| 28 | 4-Butylbenzoic acid | 11 | Calcite |
| 29 | Dodecanoic acid** | 12 | Calcite |
| 30 | Palmitic acid | 16 | Calcite |
| 31 | Stearic acid | 18 | Calcite |
| 32 | Oleic acid | 18 | Calcite |
| 33 | MgCl₂ | — | Calcite |
| 34 | AlCl₃ | — | Calcite |
| 35 | C₁₂H₂₅C₆H₄SO₃H (LABSA) | 18 | Calcite |
| *Was pumped continuously and directly into the carbonator. | | | |
| **This experiment led to mostly calcite (of a crystallographic purity (aragonite/(aragonite + calcite)) ˜20%-25%) and to a specific gravity (S. G.) = 2.54 g/cm3 (measured according to Example 14A), which is outside the limits of the present invention (S. G. <2.5 g/cm3). However, the use of CO2 containing gas (26% by volume CO2 and 74% by volume Air) and 1.5% dodecanoic acid in an experiment similar to that described in Example 10, led to a product of mostly aragonite | | | |
| #(of a crystallographic purity (aragonite : (aragonite + calcite)) >50%) and to a specific gravity (S. G.) = 1.78 g/cm3 (measured according to Example 14A). | | | |

### EXAMPLE 2

A Screening Test for Interfering Compounds:

EXAMPLE 1 was repeated, except that in all the experiments 1% (wt; based on the calcium carbonate) decanoic acid was premixed in the aqueous calcium hydroxide slurry feed and in each experiment an additional experimental active agent was added to study its effect on the activity of the decanoic acid. The results are shown in Table 2, below.

The process set points—continuous mode of operation:

1. Rotor Speed=4000 rpm (Tip Speed—10 mfsec.)

2. pH=9.5.

3. Temperature=85° C.

4. Carbon dioxide flow rate=180 L.P.H. (liters/hour).

5. Aqueous calcium hydroxide slurry (of Shfeya) −10% (wt)=−6 L.P.H. (to maintain the preset pH value).

6. Active agents concentrations=1 wt. % decanoic acid+1 wt. % potential active agent based on CaCO₃.

TABLE 2
the results of EXAMPLE 2

| Test | | Number of | Product |
|---|---|---|---|
| # | Active Agent | Carbons | (Isomorph) |
| 1 | Propionic acid | 3 | Aragonite |
| 2 | Lactic acid | 3 | Aragonite |
| 3 | Pyruvic acid | 3 | Aragonite |
| 4 | Acrylic acid | 3 | Aragonite |
| 5 | Methoxyacetic acid | 3 | Aragonite |
| 6 | Methacrylic acid | 4 | Aragonite |
| 7 | Butanoic acid | 4 | Aragonite |
| 8 | Pentanoic acid | 5 | Aragonite |
| 9 | Hexanoic acid | 6 | Aragonite |
| 10 | Heptanoic acid | 7 | Aragonite |
| 11 | Octanoic acid | 8 | Aragonite |
| 12 | Phthalic acid | 8 | Calcite |
| 13 | 2-Ethylhexanoic acid | 8 | Aragonite |
| 14 | Nonanoic acid | 9 | Aragonite |
| 15 | Azelaic acid | 9 | Aragonite |
| 16 | Trimelitic acid | 9 | Calcite |
| 17 | Decanoic acid | 10 | Aragonite |
| 18 | Undecanoic acid | 11 | Aragonite |
| 19 | 4-ButylBenzoic acid | 11 | Aragonite |
| 20 | Dodecanoic acid | 12 | Aragonite |
| 21 | Palmitic acid | 16 | Aragonite |
| 22 | Stearic acid | 18 | Aragonite |
| 23 | Oleic acid | 18 | Aragonite |
| 24 | MgCl₂ | — | Aragonite |
| 25 | AlCl₃ | — | Aragonite |
| 26 | C₁₂H₂₅C₆H₄SO₃H (LABSA) | 18 | Aragonite |

### EXAMPLE 3

A Batch Mode of Operation:

A batch mode of operation, of which parameters were as close as possible to those of EXAMPLE 1, was attempted. Only particulate precipitated calcite of rhombohedral shape was obtained. No particulate precipitated aragonite could be obtained when using decanoic acid or any other active agent that was mentioned as being effective in EXAMPLE 1. The experiment was conducted as follows:

The active agents were investigated by producing precipitated calcium carbonate particles according to the following procedure:

2 kg aqueous calcium hydroxide slurry, containing already the respective active agent (c.t. EXAMPLE I) were added to the 3.2 I. stainless steel 316 reactor of EXAMPLE 1. The Dissolver was operated at 4000 rpm, the temperature was maintain at 85° C. and the production rate was determined by controlling the feed rate of the carbon dioxide gas. The carbonation was stopped after about 20-30 minutes, when the pH reached 7. The product mixture was then removed from the reactor through its bottom outlet.

The resulting slurry was filtered through a filter cloth on the Buchner using a vacuum pump to dewater the product. The filter cake was dried for 12 hours at 120° C. and the crystallographic morphologies and the shapes of the crystals of the precipitated calcite particles were determined using XRD and SEM analyses, respectively. As mentioned above, no precipitated aragonite particles were obtained.

The Process Set Points—Batch Mode of Operation:

Rotor Speed=4000 rpm (Tip Speed—10 m/sec.).

2. pH=−14→7.

3. Temperature 85° C.

4. Carbon dioxide flow rate 180 L.P.H. (liters/hour).

5. Aqueous calcium hydroxide slurry (of Shfeya) −10% (wt)=2 kg.

6. Potential active agent concentration 1 wt. %, based on CaCO₃.

### EXAMPLE 4

Parametric Studies—the Effect of the Temperature:

Similar experiments to EXAMPLE 1 were conducted using decanoic acid only.

The results are as follows:

The Process Set Points—Continuous Mode of Operation:

1. Rotor Speed=4800 rpm (Tip Speed—12 m/sec.).

2. pH=9.5.

3. Temperature variable.

4. Carbon dioxide flow rate=180 L.P.H. (liters/hour).

5. Aqueous calcium hydroxide slurry (of Shfeya) −10 wt. %=−6 L.P.H. (to maintain the preset pH value).

6. Active agent concentration=decanoic acid; 0.5 wt. %, based on CaCO₃.

TABLE 3
the results of EXAMPLE 4

| Test | Temperature | Mineralogical Phase |
|---|---|---|
| # | ° C. | XRD |
| 1 | 87 | Aragonite |
| 2 | 80 | Aragonite |
| 3 | 70 | Aragonite |
| 4 | 60 | Aragonite |
| 5 | 50 | Calcite |

### EXAMPLE 5

Parametric Studies—Effect of the pH:

Similar experiments to EXAMPLE 1 were conducted using decanoic acid only.

The results are as follows:

The Process Set Points—Continuous Mode of Operation:

1. Rotor Speed=4800 rpm (Tip Speed—12 m/sec.).

pH=variable.

3. Temperature 87° C.

4. Carbon dioxide flow rate=180 L.P.H. (liters/hour)

5. Aqueous calcium hydroxide slurry (of Shfeya) −10 wt. %=−6 L.P.H. (to maintain the preset pH value).

6. Active agent concentration—decanoic acid; 0.5 wt. % based on CaCO₃.

TABLE 4
the results of EXAMPLE 5

| Test | | Mineralogical Phase |
|---|---|---|
| # | pH | XRD |
| 1 | 10 | Aragonite |
| 2 | 9.5 | Aragonite |
| 3 | 9 | Aragonite |
| 4 | 8.5 | Aragonite |
| 5 | 8.0 | Calcite |
| 6 | 7.0 | Calcite |

### EXAMPLE 6

Parametric Studies—Concentration Effect of the Active Agent

Similar experiments to EXAMPLE 1 Were conducted using decanoic acid only.

The results are as follows:

The Process set Points—Continuous Mode of Operation.

1. Rotor Speed 32 4800 rpm (Tip Speed—12 m/sec).

2. pH=9.5.

3. Temperature=87° C.

4. Carbon dioxide flow rate=180 L.P.H. (liters/hour).

5. Aqueous calcium hydroxide slurry (of Shfeya) −10% (wt)=−6 L.P.H. (to maintain the preset pH value).

6. Active agent concentration=decanoic acid; variable wt. %; based on CaCO₃.

TABLE 5
the results of EXAMPLE 6

| Test | Decanoic acid | Mineralogical Phase |
|---|---|---|
| # | % (wt) | XRD |
| 1 | 1.0 | Aragonite |
| 2 | 0.5 | Aragonite |
| 3 | 0.3 | Aragonite + Calcite* |
| 4 | 0.2 | Aragonite + Calcite* |
| 5 | 0.1 | Calcite |

*A crystallographic purity (aragonite/(aragonite + calcite)) <90%.

Note: Though the present invention is especially aimed at obtaining substantially pure particulate precipitated aragonite calcium carbonate of crystallographic purity (aragonite phase+calcite phase)) ≧90% and even >95%, there are still application that can utilize mixtures of these isomorphs where such crystallographic purity is <90%, and such mixtures are within the scope of the present invention in such cases the boundary conditions of the present invention (c. f. Tests #3 and #4, above) may still be used.

### EXAMPLE 7

Parametric Studies—Concentration Effect of the Ca(OH)₂

Similar experiments to EXAMPLE 1 were conducted using decanoic acid only.

The results are as follows:

The Process Set Points—Continuous Mode of Operation:

1. Rotor Speed=4800 rpm (Tip Speed—12m/sec.).

2. pH=9.5.

3. Temperature=87° C.

4. Carbon dioxide flow rate=180 L.P.H. (liters/hour)

5. Aqueous calcium hydroxide slurry (of Shfeya)—variable wt. %=−variable L.P.H. (to maintain the preset pH value).

6. Active agent concentration=decanoic acid; 0.5 wt. % based on CaCO₃.

TABLE 6
the results of EXAMPLE 7

| | Solids in | |
|---|---|---|
| Test | Slaked Lime | Mineralogical Phase |
| # | % (wt) | XRD |
| 1 | 8 | Aragonite |
| 2 | 4 | Aragonite |
| 3 | 3 | Aragonite + Calcite* |
| 4 | 2 | Aragonite + Calcite* |
| 5 | 1 | Calcite |

*A crystallographic purity (aragonite : (aragonite + calcite)) <90% and c.f. the above note at the end of Example 6.

### EXAMPLE 8

Parametric Studies—Rotor Speed Effect:

Similar experiments to EXAMPLE 1 were conducted using decanoic acid only.

The results are as follows:

The Process Set Points—Continuous Mode of Operation:

1. Rotor Speed=variable rpm (Tip Speed—variable).

2. pH=9.5.

3. Temperature=87° C.

4. Carbon dioxide flow rate=180 L.P.H (liters/hour).

5. Aqueous calcium hydroxide slurry (of Shfeya) −10 wt. %=−6 L.P.H. (to maintain the preset pH value).

6. Active agent concentration=decanoic acid; 0-5 wt. % based on CaCO₃.

TABLE 7
the results of EXAMPLE 8

| Test | Rotor Speed | Tip Speed | Mineralogical Phase |
|---|---|---|---|
| # | rpm | m/sec. | XRD |
| 1 | 1000 | 25 | Aragonite |
| 2 | 4800 | 12 | Aragonite |
| 3 | 2000 | 5 | Aragonite + Calcite* |
| 4 | 1000 | 2.5 | Calcite |

*A crystallographic purity (aragonite : (aragonite + calcite)) <90% and c.f. the above note at the end of Example 6.

### EXAMPLE 9

Parametric Studies—Effect of the CO₂ Flow Rate (F.R.)

Similar experiments to EXAMPLE 1 were conducted using decanoic acid only.

The results are as follows:

The Process Set Points—Continuous Mode of Operation:

1. Rotor Speed=4800 rpm (Tip Speed—12 m/sec.).

2. pH=9.5.

3. Temperature=87° C.

4. Carbon dioxide flow rated=variable L.P.H. (liters/hour)

5. Aqueous calcium hydroxide slurry (of Shfeya)—variable wt. %=−variable L.P.H. (to maintain the preset pH value).

6. Active agent concentration=decanoic acid; 0.5 wt. % based on CaCO₃;

TABLE 8
the results of EXAMPLE 9

| Test | CO₂ Flow Rate | Mineralogical Phase |
|---|---|---|
| # | L.P.H. | XRD |
| 1 | 240 | Aragonite |
| 2 | 180 | Aragonite |
| 3 | 120 | Aragonite |

### EXAMPLE 10

Parametric Studies—Effect of the CO₂/Air Ratio:

Similar experiments to EXAMPLE 1 were conducted using decanoic acid only.

The results as follows:

The Process Set Points—Continuous Mode of Operation:

1. Rotor Speed=4800 rpm (Tip Speed—12 m/sec.).

pH=9.5.

3. Temperature=87° C.

4. Carbon dioxide flow rate=180 L.P.H. (liters/hour).

5. Aqueous calcium hydroxide slurry (of Shfeya) −10% (wt)=−6 L.P.H. (to maintain the preset pH value).

6. Active agent concentration=decanoic acid; 0.5 wt. %; based on CaCO₃.

7. Air variable.

TABLE 9
the results of EXAMPLE 10

| Test | | Mineralogical Phase |
|---|---|---|
| # | Air/CO₂ | XRD |
| 1 | 0 | Aragonite |
| 2 | 0.33 | Aragonite |
| 3 | 0.66 | Aragonite |

### EXAMPLE 11

The Effect of Active Agent on Content of the Wet Filter Cake:

Similar experiments to EXAMPLE 1 were conducted using decanoic acid only The content of CaCO₃ in the wet filter cake was determined after drying 12 hours at 120° C. Relatively pure (aragonite phase/(aragonite phase+calcite phase)) ≧95% and dry precipitated acicular aragonite calcium carbonate particles were obtained. The results are as follows:

The Process Set Points—Continuous Mode of Operation:

1. Rotor Speed=4800 rpm (Tip Speed—12 m/sec.).

2. pH=95.

3. Temperature 90° C.

4. Carbon dioxide flow rate=180 L.P.H. (liters/hour).

5. Aqueous calcium hydroxide slurry (of Shfaya) −10 wt. %=−6 L.P.H. (to maintain the preset pH value).

6. Active agent concentration=decanoic acid; 0.7; 1.0; 2.0 wt. %; based on CaCO₃.

TABLE 10
the results of EXAMPLE 11

| Test | Dosage | Product | CaCO₃ | Crystallographic |
|---|---|---|---|---|
| # | % (wt) | (Isomorph) | % (wt)* | Purity** |
| 1 | 0.7 | Aragonite | >80 | ≧95% |
| 2 | 1.0 | Aragonite | >80 | ≧95% |
| 3 | 2.0 | Aragonite | >80 | ≧95% |

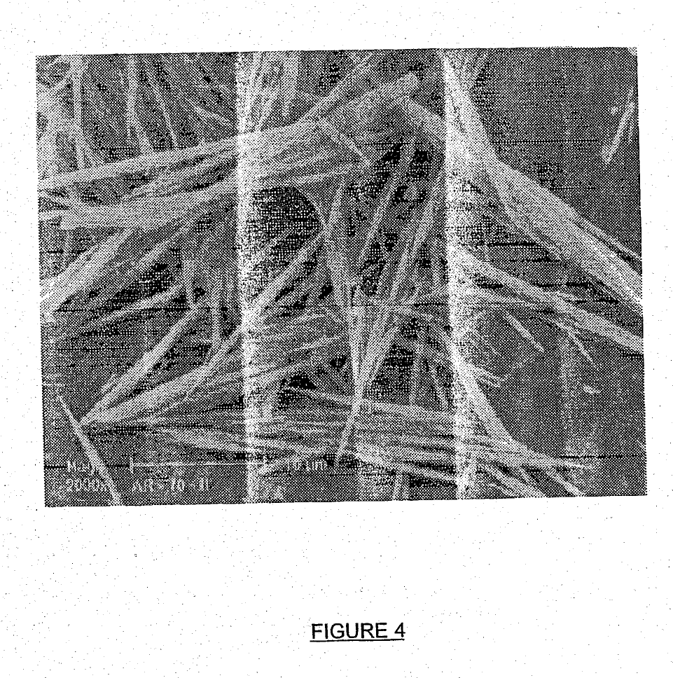

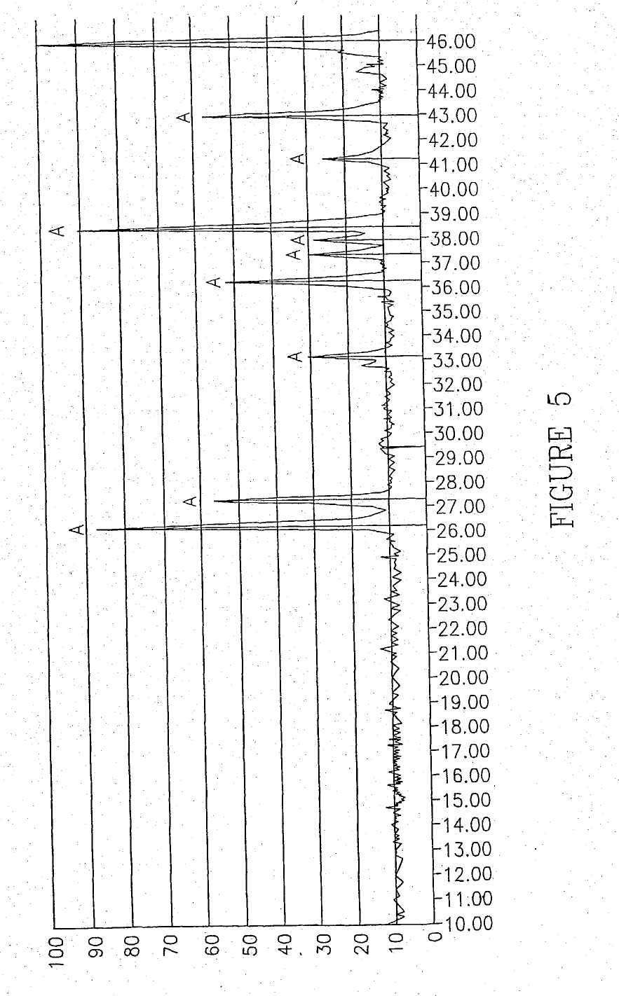

*% (wt) CaCO₃ = 100 × wt. of dry filter cake / wt. of wet filter cake
**As determined by the XRD analyses (for Test #2 - c.f. FIGS. 4 and 5)
Note:
By choosing relatively standard conditions for the present process, it is possible to reduce the water content in the wet filter cake below 20 wt. %.

### EXAMPLE 12

The Effect of the Active Agent on the Resistivity to Acids:

Similar experiments to EXAMPLE 1 were conducted using decanoic acid only, the resistivity of the dry samples to acidic aqueous solutions being determined as follows. A 5 I. solution of HCl in water at pH=3.5 was prepared for all the following experiments, so as to assure equal starting experimental conditions. 100 ml of this HCl solution were poured into a 100 ml graduated cylinder, 5 g of precipitated CaCO₃ particles were added and the pH was measured after 20 minutes. Evolution of CO₂ was observed visually, as was the behavior of the commercial sample #C, the calcite #BM-37, and it was found that the aragonite samples of the present invention (#12-3, #12-4, #12-5) were markedly different. It is worthwhile to note that sample #12-5 produced few bubbles that did not detach from the surface of the precipitated aragonite particles. The results are as follows:

The process Set Points—Continuous Mode of Operation:

1. Rotor Speed=5200 rpm (Tip Speed—13 m/sec.).

2. pH 9.5.

3. Temperature=90° C.

4. Carbon dioxide flow rate=180 L.P.H. (liters/hour).

5. Aqueous calcium hydroxide slurry (of Shfeya) −10 wt. %=−6 L.P.H. (to maintain the preset pH value).

6 Active agent concentration=decanoic acid 0.7%; 1.0%; 2% wt. % based on CaCO₃.

TABLE 11
the results of EXAMPLE 12

| Test | Sample | Active agent | Product | pH after 20 | |
|---|---|---|---|---|---|
| # | # | (wt. %) | (Isomorph) | mins. | Note |
| 1 | C* | Unknown | Aragonite | >6 | Violent |
| | | | | | Evolution of CO₂ |
| 2 | BM-37** | 1.0 | Calcite | >5 | Evolution of CO₂ |
| 3 | 12-3 | 0.7 | Aragonite | <4 | Slight Evolution |
| | | | | | of CO₂ |
| 4 | 12-4 | 1.0 | Aragonite | <4 | Slight Evolution |
| | | | | | of CO₂ |
| 5 | 12-5 | 2.0 | Aragonite | <4 | No Evolution of |
| | | | | | CO₂ |

*Commercial PCC - Aragonite; of Specialty Minerals Inc. (SMI); Opacarb ® A40
**This sample was taken from the batch mode of operation in EXAMPLE 3
Note:
By choosing relatively standard conditions for the present process, it is possible to increase the resistance of the product towards acids by using quite low concentrations of the active agent and obtain excellent product for the paper industry of which processes are acidic and for the coating industry for durable paints for acidic environments.

### EXAMPLE 13

Effect of Raw Material/Process on Whiteness of the Product:

EXAMPLE 1 and EXAMPLE 3 were conducted using: the aqueous calcium hydroxide slurries of PREPARATION I and of PREPARATION II for comparison. The whitenesses of the products are compared.

The results are as follows:

The Process Set Points—Continuous Mode of Operation:

1. Rotor Speed=4000 rpm (Tip Speed—10 m/sec.).

2. pH 9.5.

3. Temperature=85° C.

4. Carbon dioxide flow rate=180 L.P.H. (liters/hour)

5. Aqueous calcium hydroxide slurry (of Arad/Shfeya) −10 wt. %=−6 L.P.H. (to maintain the preset pH value).

6. Active agent concentration=decanoic acid; 1 wt. % based on CACO₃.

The Process Set Points—Batch Mode of Operation:

1. Rotor Speed=4000 rpm (Tip Speed—1msec)

2. pH=14 →7.

3. Temperature=85° C.

4. Carbon dioxide flow rate=180 L.P.H (liters/hour).

5. Aqueous calcium hydroxide slurry (of Arad/Shfeya) −10 wt. %=2 kg.

6. Active agent concentration=decanoic acid 1 wt. % based on CaCO₃.

TABLE 12
the results of EXAMPLE 13

| CaO of Arad (whiteness = >95%) | | CaO of Shfeya (whiteness = ˜88%) | |
|---|---|---|---|
| Continuous | Batch | Continuous | Batch |
| AR-83A | BM37A | AR-83 | BM37 |
| Aragonite CaCO₃ | Calcite CaCO₃ | Aragonite CaCO₃ | Calcite CaCO₃ |
| Whiteness = 98-9% | Whiteness = 97-8% | Whiteness = 97-9% | Whiteness = 92-5% |

Notes:
1. When the raw material (CaO) is relatively pure, the whiteness of the products (AR-83A and BM37A) is not (and should not be) much different. However, when the CaO is relatively impure, the whiteness of the precipitated aragonite particles (AR-83) is dramatically higher than the corresponding calcite (BM37), due to the unique effect of the process of the present invention.
2. The whiteness of the precipitated particulate aragonite obtained according to the present process attains top quality, independently of the calcium hydroxide source.

### EXAMPLE 14

Effect of the Active Agent/Process on the Specific Gravity (S.G.) of Precipitated Particulate Calcium Carbonate.

EXAMPLE 1 was repeated musing the, aqueous calcium hydroxide slurry of PREPARATION I, except that the concentration of decanoic acid was gradually increased.

(A) Determination of the Specific Gravity (S.G.) in Tall Oil of a Product Dried at 120° C.

1. The wet filter cake of the CaCO₃ sample was dried for 12 hours at 120° C. to remove all free water.

2. A weighed quantity of the dry CaCO₃ sample (Wc)+ a weighed quantity of tall oil (Wo) (Density of 0.93 g/cm³) were introduced into a 1 I. glass beaker.

3. The mixture was stirred with the Hasiangtal HD-550 Dissolver for 10 minutes, at 4000 rpm (using a saw-blade rotor of d=4.8 cm).,

4. The slurry was poured into a 250 ml graduated glass settling column and was sonicated gently in an ultrasound bath for 20 minutes, until all the visible trapped bubbles were released from the surface of the PCC particles. In order not to destroy the structure of the “porous” product of the present invention while sonicating it, thereby leading to higher S.G. values, the use of ultrasonic cleaners (baths) of limited power (<100 Amp.Volt.) e.g. P-08890-01/06 ex.Cole Parmer—USA, is recommended.

5. The settling column was then evaluated at 20-22° C. for:

(a) the volume of the slurry—V

(b) the total net weight of the slurry—W

Based on the above measurements, the following was calculated:

(1) from the equation: D=W/V g/cm³, the density of the slurry;

(2) from the equation

1/D=[Wc(Wo+Wc)]/S.G.+[Wo(Wo+Wc)]/0.93,

the S.G. of the CaCO₃ sample was calculated.

6. The loose bulk density (L.B.D.) of the dry powder was measured using a balance and a graduated cylinder (c. f. the exact procedure in EXAMPLE 14 (F)).

The Process Set Points—Continuous Mode of Operation:

1. Rotor Speed=4000 rpm (Tip Speed—10 m/sec.)

2. pH=9.5.

3. Temperature=85° C.

4. Carbon dioxide flow rate=180 L.P.H. (liters/hour).

5. Aqueous calcium hydroxide slurry (of Shfeya) −10 wt. %=−6 L.P.H. (to maintain the preset pH value).

6. Active agent concentration=decanoic acid; 0.5; 1; 2; 5; 2; 1 wt. % based on CaCO₃.

The results are as follows:

TABLE 13
the results of EXAMPLE 14 (A)

| | | | | Mineralogical | | Loose |
|---|---|---|---|---|---|---|
| Test | Sample | | Dosage | Phase | S.G.† | B.D.† |
| # | Code | Active agent | (wt. %) | XRD | g/cm³ | g/cm³ |
| 1 | Natural | — | — | Calcite | 2.63 | 0.65 |
| | CaCO₃ | | | | | |
| 2 | BM-37* | decanoic acid | 1 | Calcite | 2.54 | 0.37^{BM} |
| 3 | C** | N.A. | N.A. | Aragonite | 2.56 | 0.54 |
| 4 | AR-81 | decanoic acid | 0.5 | Aragonite | 2.02 | 0.31 |
| 5 | AR-83 | decanoic acid | 1 | Aragonite | 1.90 | 0.30 |
| 6 | AR-118 | decanoic acid | 2 | Aragonite | 1.75 | 0.25 |
| 7 | AR-119 | decanoic acid | 5*** | Aragonite | 1.67 | 0.29 |
| 8 | AR-135 | nonanoic acid | 1 | Aragonite | 1.88 | 0.31 |
| 9 | AR-120 | decanoic acid | 2\hat{ } | Aragonite | 1.72 | 0.23 |
| *The sample was taken from the batch mode of operation in - EXAMPLE 3. | | | | | | |
| **Commercial PCC - Aragonite; of Specialty Minerals Inc. (SMI); Opacarb ® A40. | | | | | | |
| ***5 g of AR-119 were dissolved in a 10% HCl solution. The decanoic acid was extracted with 1,2-dichloroethane. HPLC analysis using a C18 column revealed 4.93% (wt; based on the calcium carbonate) of this acid in the sample. | | | | | | |
| \hat{ }50 ppm of phosphoric acid were used in addition to the decanoic acid to increase the aspect ratio of the acicular aragonite. | | | | | | |
| †A dry powder after drying for 12 hours at 120° C. | | | | | | |
| BM - The relatively low L.B.D. of this product should not be compared to the other L.B.D. of Tests = 3-9, as BM-37 is a calcite form, while the others are acicular aragonite form. | | | | | | |
| N.A. - Not available. | | | | | | |
| Notes: | | | | | | |
| 1. The determination of a specific gravity (S.G.) of particulate precipitated aragonite calcium carbonate of the present invention, in a range below 2.5 g/cm³ (after drying at 120° C. for twelve hours as described above, as well as after ignition of the dried material at 500° C. for eight hours) is actually an important and decisive test to consider if the technology that was used is under the domain of the present invention. | | | | | | |
| 2. Only the inclusion of gas (probably, as tiny bubbles or “blisters”) in closed pores can account for the dramatic reduction of the S.G. of particulate precipitated aragonite calcium carbonate of the present invention. The L.O.D. and the L.O.I. in the latter tests (c. f. (B) and (C), respectively) do not leave many logical choices to account for this phenomenon. Also, this is in accordance with the facts i. that the product of the present invention is obtained under | | | | | | |
| #flotation conditions, and ii. that the high hiding power of the paints, in which the particulate precipitated aragonite calcium carbonate of the present invention was used, are probably due to the high effective refractive index of this product of the present invention, which is much higher than that expected of similar products that are produced according to the prior art (c. f. data collected in EXAMPLE 15 and the comparison made to paint formulations that were based on | | | | | | |
| #raw materials of the prior art). | | | | | | |

3. The idea of using porous particles, to increase their effective refractive index in coatings, is not new. For instance, Rohm & Haas produces a series of such products, e. g. Ropaque ® OP96 and Ropaque ® OP3000. However, these particles are of an organic polymeric nature of which cost and adaptation to the environment is not to be compared with precipitated calcium carbonate particles.

(B) Determination of the Specific Gravity (S.G.) in Tall Oil of a Product Calcined at 300° C.

1. The wet filter cake of the CaCO₃ sample was dried for 12 hours at 120° C. to remove all the free water.

2. The weighed dry sample was heated for 8 hours at 300° C. The loss on drying (L.O.D.) was then determined.

3. The S.G. of the heated powder was measured as above (c. f. (A)).

4. The loose bulk density (L.B.D.) of the dry powder was measured using a balance and a graduated cylinder (c. f. the exact procedure in EXAMPLE 14 (F)).

The results are as follows:

TABLE 14
the results of EXAMPLE 14 (B)

| | | | | L.O.D. wt. | | Loose |
|---|---|---|---|---|---|---|
| Test | Sample | | Dosage | % | S.G.† | B.D.† |
| # | Code | Active agent | (wt. %) | 300° C. | g/cm³ | g/cm³ |
| 10 | Natural | — | — | 0.10 | 2.63 | 0.651 |
| | CaCO₃ | | | | | |
| 11 | BM-37* | decanoic acid | 1 | 2.21 | 2.64 | 0.372 |
| 12 | C** | N.A. | N.A. | 1.3 | 2.63 | 0.540 |
| 13 | AR-81 | decanoic acid | 0.5 | 0.83 | 2.19 | 0.255 |
| 14 | AR-83 | decanoic acid | 1 | 0.89 | 2.11 | 0.265 |
| 15 | AR-118 | decanoic acid | 2 | 2.32 | 2.03 | 0.200 |
| 16 | AR-119 | decanoic acid | 5 | 5.73 | 2.01 | 0.200 |
| 17 | AR-135 | nonanoic acid | 1 | 0.95 | 2.12 | 0.238 |
| 18 | AR-120 | decanoic acid | 2\hat{ } | 2.27 | 2.02 | 0.235 |

*The sample was taken from the batch mode of operation in-EXAMPLE 3.
**Commercial PCC - Aragonite; of Specialty Minerals Inc. (SMI); Opacarb ® A40.
\hat{ }50 ppm of phosphoric acid were used in addition to the decanoic acid.
†A dry powder after heating for 8 hours at 300° C.
N.A. - Not available.

(C) Determination of the Specific Gravity (S.G.) in Tall Oil of a Product Calcined at 500° C.

1. The wet filter cake of the CaCO₃ sample,was dried for 12 hours at 120° C. to remove free water.

2. The dry sample was calcined for 8 hours at 500° C. The loss on ignition (L.O.I.) was then determined.

3. The S.D. of the calcined powder was measured as above.

4. The loose bulk bulk density (L.B.D.) of the dry powder was measured using a balance and graduated cylinder (c. f the exact procedure in EXAMPLE 14 (F)).

The results are as follows:

TABLE 15
the results of EXAMPLE 14 (C)

| | | | L.O.I. | | Loose |
|---|---|---|---|---|---|
| Test | Sample | Dosage | % (wt) | S.G.† | B.D.† |
| # | Code | % (wt) | 500° C.\hat{ } | g/cm³ | g/cm³ |
| 19 | Natural | — | 0.18 | 2.70 | 0.75 |
| | CaCO₃ | | | | |
| 20 | BM-37 | 1* | 2.58 | 2.60 | 0.38 |
| 21 | C** | N.A. | 2.02 | 2.71 | 0.55 |
| 22 | AR-81 | 0.5 | 1.32 | 2.13 | 023 |
| 23 | AR-83 | 1 | 1.44 | 2.03 | 022 |
| 24 | AR-118 | 2 | 2.07 | 2.01 | 0.18 |
| 25 | AR-119 | 5*** | 5.25 | 1.93 | 0.19 |
| 26 | AR-135 | 1 | 1.44 | 2.01 | 0.24 |
| 27 | AR-120 | 2\hat{ } | 2.37 | 1.91 | 0.18 |

*The sample was taken from the batch mode of operation in -EXAMPLE 3.
**Commercial PCC - Aragonite; of Specialty Minerals Inc. (SMI); Opacarb ® A40.
*** 5 g of AR-119 were dissolved in a 10% HCl solution. No decanoic acid could be extracted or detected, as is expected of such molecules when they are subjected to heating for 8 hours at 500° C.
\hat{ }50 ppm of phosphoric acid were used in addition to the decanoic acid.
\hat{ }Aragonite is converted into calcite at T > 400° C.
†Table 13 - the results of EXAMPLE 14 (A)hours at 500° C.
N.A. - Not available.

(D) Determination of the Specific Gravity (S.G.) —by a Gas Pycnometer CaCO₃ power (d₅₀=3.5 microns) of Polychrom, Israel—“Girulite-8” and AR-118, a product of the present invention, were tested in a AccPyc 1330 ex Micromeritics —U.S.A. The results are given in Table 15a, as follows:

TABLE 15a
the results of EXAMPLE 14 (D):

| Sample | | S. G. | Average S. G. |
|---|---|---|---|
| Code | Test # | (g/cm³) | (g/cm³) |
| G-8 | 1 | 2.7544 | 2.7538 |
| | 2 | 2.7549 | |
| | 3 | 2.7547 | |
| | 4 | 2.7529 | |
| | 5 | 2.7523 | |
| AR-118 | 1 | 2.9070 | 2.8903* |
| | 2 | 2.8918 | |
| | 3 | 2.8932 | |
| | 4 | 2.8846 | |
| | 5 | 2.8750 | |

*This experiment demonstrates that: (i) the product of the present invention is permeable to air (especially under vacuum and pressure) and (ii) the product of the present invention would not have been discovered had this routine technique used to determine the S. G. of the products of the present invention and even those skilled in the art could overlook the whole phenomenon of “porous” PCC, which is the basis of this invention.

(E) Final Determination of the Specific Gravity (S.G.) of a Product Calcined at 500° C.

In most practical instances the use of EXAMPLE 14 (A) and EXAMPLE 14 (C) to determine the specific gravity of the PCC products, may not cause any dispute, and a person of the art can observe quite easily that a product of the present invention is quite different from a prior art product, merely by observing the considerable differences between the apparent (loose) bulk density (L.B.D.) of the aragonite particles of the present invention, compared with those of prior art aragonite particles (Tables 13, 14 and 15). However, when the specific gravity (S. G.) of the PCC particles is quite close to 2.5 g/cm³, the accuracy of the analytical method may be of prime importance.

In such cases especially, determination of the S.G. values should be conducted as follows:

(a) The S.G. should be determined according to (i) EXAMPLE 14 (A) and EXAMPLE 14 (C), and (ii) EXAMPLE 14 (C) only (i.e. the dewatered sample of the product may be ignited at 500C without drying it first, or under the conditions customarily practiced in the prior art). These tests should be conducted three times and the determined average value will represent the final result in each case, (i) and (ii).

(b) The lowest of the S.G. results obtained for a particular product in (a) according to both (i) and (ii), independently, will determine whether the product (and the process) falls within the scope of the present invention (according to the embodiment where the S.G. is determinate).

(F) Determination of the Loose Bulk Density (L.B.D.) of a Product Dried at 120° C.

A sample, dried at 120° C. for twelve hours, was de-agglomerated gently using a mortar/pestle and sieved through a 0.6 mm screen. The L.B.D. of the fine powder that passed the screen was determined, separately and independently of the S.G analyses (c. f. EXAMPLE 14 (E)) and the T.B.D. analyses (c. f. EXAMPLE 14 (G)), according to the ASTM D1895. The average results, of three repetitions of the test, are reported already in Table 13 (above) and now in Table 15b as follows:

TABLE 15b
the results of EXAMPLE 14 (F)

| | | | | | L.B.D. | L.B.D.⁸ |
|---|---|---|---|---|---|---|
| Test | Sample | Active | CO₂ | Dosage | 120° C. | 500° C. |
| # | Code | agent | (%) | (wt %) | (g/cm³) | (g/cm³) |
| 28 | Natural | — | — | — | 0.65 | 0.75 |
| | CaCO₃ | | | | | |
| 29 | GCC-8¹ | — | — | — | 0.65 | 0.56 |
| 30 | GCC-8² | Decanoic A. | N.A. | 2.0 | 0.64 | 0.56 |
| 31 | PCC³ | N.A. | N.A. | N.A. | 0.71 | 0.55 |
| 32 | PCC⁴ | Decanoic A. | N.A. | 2.0 | 0.70 | 0.53 |
| 33 | OM-95^{A} | — | — | — | 0.66 | 0.49 |
| 34 | UPCC^{B} | N.A. | N.A. | N.A. | 0.50 | 0.37 |
| 35 | AR-81 | Decanoic A. | 100.0 | 0.5 | 0.31 | 0.23 |
| 36 | AR-83 | Decanoic A. | 100.0 | 1 | 0.30 | 0.22 |
| 37 | AR-118 | Decanoic A. | 100.0 | 2 | 0.25 | 0.18 |
| 38 | AR-119 | Decanoic A. | 100.0 | 5** | 0.29 | 0.19 |
| 39 | AR-135 | Decanoic A. | 100.0 | 1 | 0.31 | 0.24 |
| 40 | AR-120 | Decanoic A. | 100.0 | 2*** | 0.23 | 0.18 |
| 41 | ARP-35 | Decanoic A. | 26.0 | 1.5 | 0.33 | 0.18 |
| 42 | ARP-36 | Decanoic A. | 26.0 | 2.0 | 0.33 | 0.20 |
| 43 | ARP-61 | Decanoic A. | 100.0 | 2.0 | 0.38 | 0.25 |
| 44 | ARP-62-1 | Decanoic A. | 100.0 | 3.0 | 0.31 | 0.28 |
| 45 | ARP-51 | Lauric A. | 26.0 | 1.5 | 0.31 | 0.17 |
| 46 | ARP-65 | Lauric A. | 50.0 | 1.5 | 0.38 | 0.21 |
| 47 | ARP-76⁶ | Undecylenic | 50.0 | 1.5 | 0.38 | 0.18 |
| | | A. | | | | |
| 48 | ARP-77 | Myristic A. | 50.0 | 1.5 | 0.37 | 0.18 |
| 49 | ARP-70⁷ | Stearic A. | 50.0 | 1.5 | 0.37 | 0.19 |
| 50 | ARP-71 | Isostearic A. | 50.0 | 1.5 | 0.69 | 0.53 |
| 51 | ARP-72 | Oleic A. | 50.0 | 1.5 | 0.92 | 0.53 |
| 52 | ARP-83 | Palmitic A. | 50.0 | 1.5 | 0.86 | 0.54 |

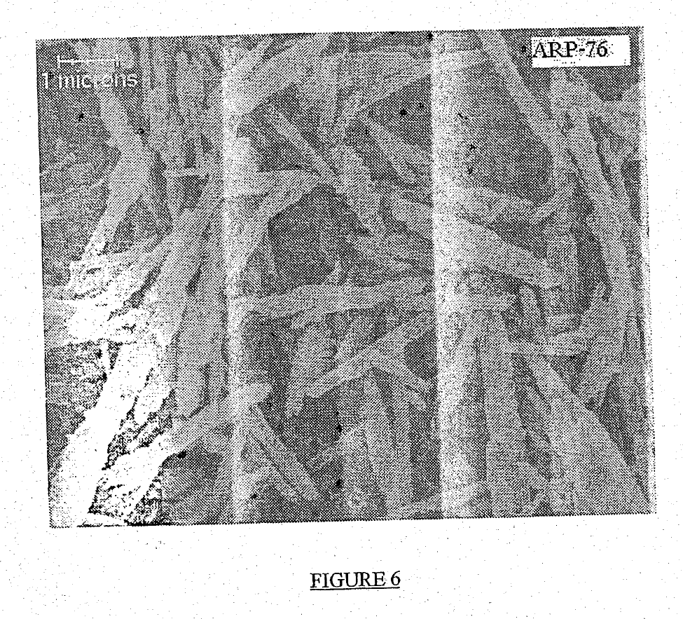

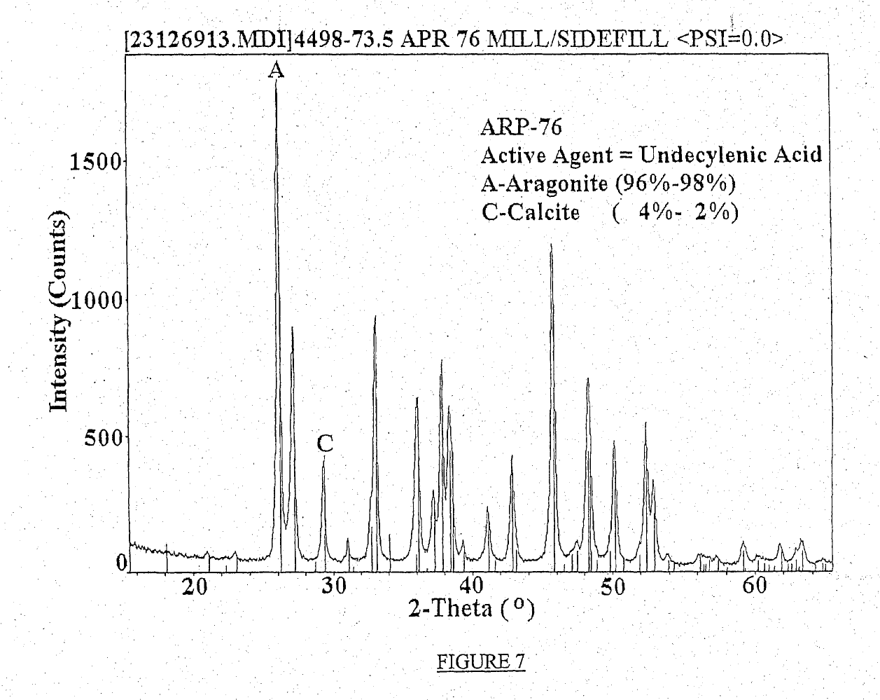

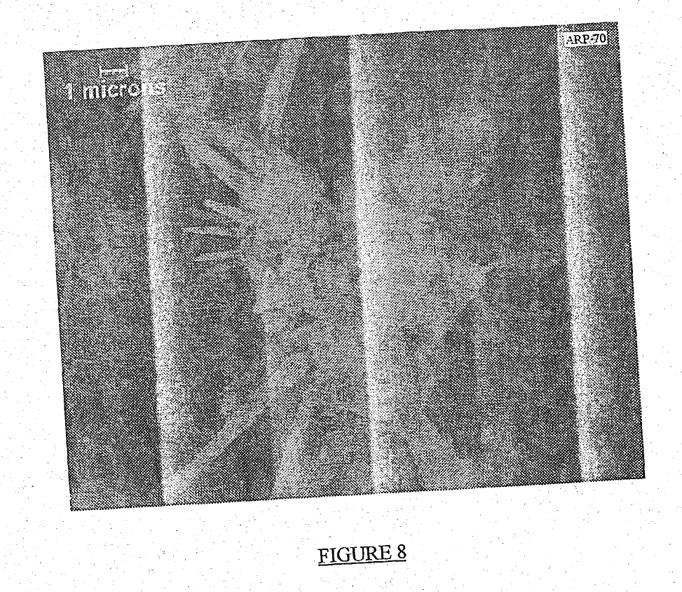

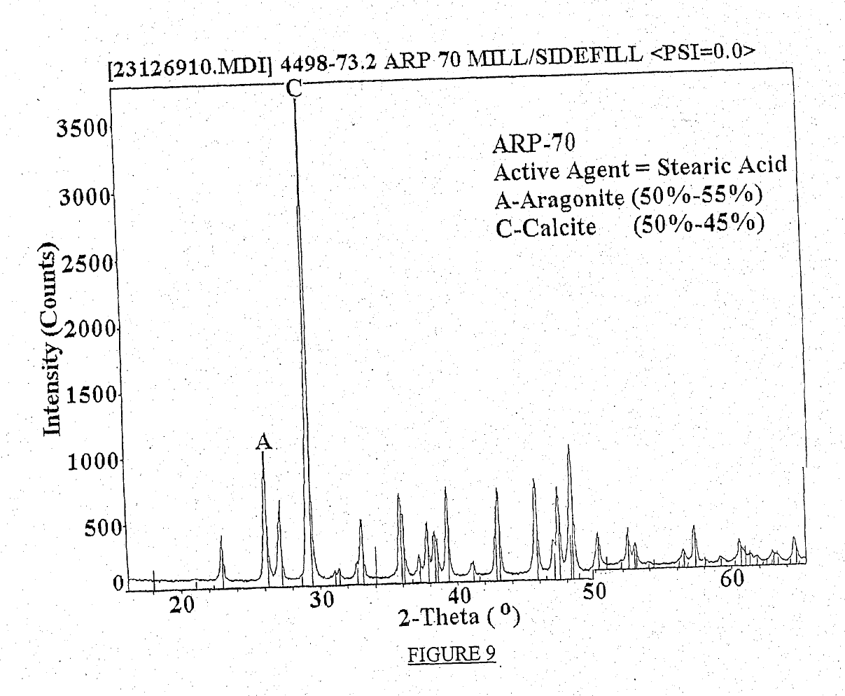

**5 g of AR-119 were dissolved in a 10% HCl solution. No decanoic acid could be extracted or detected, as is expected of such molecules when they are subjected to heating for 8 hours at 500° C.
***50 ppm of phosphoric acid were used in addition to the decanoic acid.
¹“Girulite-8” CaCO3 powder (d50 = 3.5 microns) ex Polychrom - Israel.
²“Girulite-8” CaCO3 powder (d50 = 3.5 microns) ex Polychrom - Israel, which was coated using 2 wt % n-decanoic acid.
³Commercial PCC - Aragonite (SSA = 12 m²/g); of Specialty Minerals Inc. (SMI); Opacarb ® A40.
⁴Commercial PCC - Aragonite; of Specialty Minerals Inc. (SMI); Opacarb ® A40, which was coated using 2 wt % n-decanoic acid.
⁵50 ppm of phosphoric acid were used in addition to the decanoic acid.
⁶The XRD spectrum and SEM of ARP-76 are presented in FIG. 6 and FIG. 7, respectively.
⁷The XRD spectrum and SEM of ARP-70 are presented in FIG. 8 and FIG. 9, respectively.
⁸The L.B.D. of the calcined powder was determined in a similar manner.
^{A}Commercial ultrafine stearic acid coated - UFT 95 GCC natural calcite (95 wt % pass 2μ size) ex Omya-Pluess-Staufer - Switzerland.
^{B}Commercial ultrafine (SSA = 19 m²/g) stearic acid coated - Ultraflex PCC calcite ex SMI - USA.
N.A. - Not Available.

The results in Tables 13 and in Table 15b represent the products of the present invention if they have a L.B.D. <0.55 g/cm³. However, those results count, if the SSA (BET) of the specific samples in test are <15 m²/g and they are coated by the respective active agents that were used (in order to minimize the variations of surface interactions). Those samples that do not meet this requirement, can only be tested according to EXAMPLE 14 (E).

Conclusion: the product (and process) in question will belong to the present invention, if, it passes either this test (i.e. L.B.D. <0.55 g/cm³) or the T.B.D. test (i.e. T.B.D. <0.70 g/cc³). Should the product in question fail to pass both (T.B.D. & L.B.D.) tests, its S.G. values (according to EXAMPLE 14 (E)) will determine if it is the product (the process) according to an embodiment of the present invention.

It may be noted that dramatic L.B.D., changes occur when the products of the present invention are subjected to high temperature treatment at 300° C. (c. f. Table 14) and especially at 500° C. (c. f. Table 15), which are probably due to the thermal collapse of the “porous” structure of these particles.

(G) Determination of the Tapped Bulk Density (T.B.D.) of a Product Dried at 120° C.

A dry sample (at 120° C. for twelve hours) was de-agglomerated gently using a mortar/pestle and sieved through a 0.6 mm screen. The T.B.D. of the fine powder that passed the screen was determined, separately and independently of the S.G. analyses (c. f. EXAMPLE 14 (E)) and the L.B.D. analyses (c. f EXAMPLE 14 (F)) analyses. The fine powder is introduced into a 250 ml calibrated plastic graduate cylinder, which is then mounted on a screen-shaker (e. g. Rotap Model RX-29-10 ex W.S. Tyler Inc. —USA). The apparatus is then operated and the volume of the powder is inspected intermittently (e. g. after 5, 10, 20, 30 and 40 minutes) until no change is observed. The highest T.B.D. value is the final result of the test. This test is repeated three times for each sample and the reported T.B.D. being the average of these three tests. The results are as follows:

TABLE 15c
the results of EXAMPLE 14 (G)

| | | | T.B.D. | T.B.D. | T.B.D. | T.B.D. |
|---|---|---|---|---|---|---|
| | | L.B.D. | 120° C. | 120° C. | 120° C. | 120° C. |
| Test | Sample | 120° C. | (g/cm³) | (g/cm³) | (g/cm³) | (g/cm³) |
| # | Code* | (g/cm³) | 5 mins. | 10 mins. | 20 mins. | 30 mins. |
| 53 | GCC-8¹ | 0.65 | 0.94 | 0.93 | 0.99 | 0.99 |
| 54 | GCC-8² | 0.64 | 1.09 | 1.17 | 1.27 | 1.27 |
| 55 | PCC³ | 0.71 | 0.76 | 0.78 | 0.82 | 0.82 |
| 56 | PCC⁴ | 0.70 | 0.86 | 0.86 | 0.97 | 0.97 |
| 57 | OM-95⁵ | 0.66 | 0.88 | 0.92 | 0.92 | 0.92 |
| 58 | UPCC⁶ | 0.50 | 0.64 | 0.65 | 0.66 | 0.66 |
| 59 | ARP-33 | 0.34 | 0.53 | 0.56 | 0.62 | 0.62 |
| 60 | ARP-35 | 0.33 | 0.49 | 0.57 | 0.63 | 0.63 |
| 61 | ARP-36 | 0.33 | 0.49 | 0.57 | 0.61 | 0.61 |
| 62 | ARP-51 | 0.31 | 0.42 | 0.44 | 0.45 | 0.45 |
| 63 | ARP-65 | 0.38 | 0.53 | 0.59 | 0.62 | 0.62 |
| 64 | ARP-70⁷ | 0.37 | 0.53 | 0.58 | 0.60 | 0.60 |
| 65 | ARP-76⁸ | 0.38 | 0.54 | 0.61 | 0.69 | 0.69 |
| 66 | ARP-77 | 0.37 | 0.45 | 0.52 | 0.59 | 0.59 |
| 67 | ARP-71 | 0.69 | 0.90 | 1.10 | 1.11 | 1.11⁹ |
| 68 | ARP-72 | 0.70 | 0.87 | 1.10 | 1.12 | 1.12⁹ |
| 69 | ARP-83 | 0.86 | 1.05 | 1.16 | 1.22 | 1.22⁹ |
| ¹“Girulite-8” CaCO3 powder (d50 = 3.5 microns) ex Polychrom - Israel. | | | | | | |
| ²¢Girulite-8∞ CaCO3 powder (d50 = 3.5 microns) ex Polychrom - Israel, which was coated using 2 wt % n-decanoic acid. “Girulite-8” CaCO₃ powder (d50 = 3.5 microns) ex Polychrom - Israel, which was coated using 2 wt % n-decanoic acid (the coating is conducted by adding slowly the carboxylic acid (e.g.decanic acid) into a well stirred aqueous slurry of the GCC at 90° C. The product is then dewatered and dried at 120° C. | | | | | | |
| #for twelve hours). It is worthwhile noting that the final T.B.D. value of this coated product is now 1.27 g/cm³ (>0.99 g/cm³ before coating¹). | | | | | | |
| ³Commercial PCC - Aragonite (SSA 12 m²/g); of Specialty Minerals Inc. (SMI); Opacarb ® A40. | | | | | | |
| ⁴Commercial PCC - Aragonite; of Specialty Minerals Inc. (SMI), Opacarb ® A40, which was coated using 2 wt % n-decanoic acid (the coating is conducted by adding slowly the carboxylic acid (e.g.decanic acid) into a well stirred aqueous slurry of the PCC at 90° C. The product is then dewatered and dried at 120° C. for twelve hours). It is worthwhile noting that the final T.B.D. value of this coated product is now 0.97 g/cm³ (0.82 g/cm³ before | | | | | | |
| #coating³). | | | | | | |

⁵A commercial ultrafine stearic acid coated - UFT 95 GCC natural calcite (95 wt % pass 2μ size) ex Omya-Pluess-Staufer - Switzerland.
⁶A commercial ultrafine (SSA = 19 m²/g) stearic acid coated - Ultraflex PCC calcite ex SMI - USA.
⁷The XRD spectrum and SEM of ARP-70 are presented in FIG. 8 and FIG. 9, respectively.
⁸The XRD spectrum and SEM of ARP-76 are presented in FIG. 6 and FIG. 7, respectively.
⁹It is worthwhile noting that the T.B.D. values of products that were produced according to all the parameters of the process of the present invention, except the active agents that were changed, are quite similar to those of the products of the prior art, and especially to coated calcite GCC².

The results in Table 15c represent the products of an embodiment of the present invention if they have a T.B.D. <0.70 g/cm³. However, those results count, if the SSA (BET) of the specific samples in test are <15 m²/g and they are coated by the respective active agents that were used (in order to minimize the variations of surface interactions). Those samples that do not meet this requirement, can only be tested according to EXAMPLE 14 (E).

Conclusion: the product (and process) in question will belong to the present invention, if it passes either this test (i.e. T.B.D. <0.70 g/cm³) or the L.B.D. test (i. e. L.B.D. <0.55 g/cc³). Should the product in question fail to pass both (T.B.D. & L.B.D.) tests its S.G. values (according to EXAMPLE 14 (E)) will determine if it is the product (the process) of an embodiment of the present invention.

(H) Determination of the Specific Gravity (S.G.) in Oils of Products Dried at 120° C.

The specific gravity of various calcium carbonate particles was measured in various oils, as described in Example 14 (A). The results indicate that the low S.G. values are not due to the tall oil that was used, but it is rather common to many similar liquids. In cases at which the S.G. values are close to 2.5 g/cm³, the well-defined oleic acid (of purity >97%) can be used to resolve any dispute, and in any case, the instructions in EXAMPLE 14 (A) and EXAMPLE 14 (E), still prevail.

The Process Set Points—Continuous Mode of Operation:

1. Rotor Speed=2500 rpm (Rotor Diameter=8.5 cm)

2. pH=9.5±0.2

3. Temperature=85° C.±3

4. Carbon dioxide flow rate=2 m³/hr.

5. Aqueous calcium hydroxide slurry (of Shfeya) −10 wt. %=−50-70 L.P.H. (to maintain the preset pH value).

6. Active agent concentration=decanoic acid; 0-2 wt. % based on CaCO₃.

7. Reactor Volume=30 I. (Diameter=8.7 cm).

The results are as follows:

TABLE 15d
the results of EXAMPLE 14 (H);

| | | | | | | S.G.⁷ |
|---|---|---|---|---|---|---|
| Test | Sample | Active | Dosage | CO2 | | g/cm³ |
| # | Code | Agent | (wt %) | (%) | Liquid^{6,7} | 120° C. |
| 70 | GCC-8¹ | — | — | — | Sylvatal 20S | 2.63 |
| 71 | PCC³ | — | — | N.A. | Sylvatal 20S | 2.56 |
| 72 | GCC-8² | Decanoic A. | 2.0 | — | Sylvatal 20S | 2.23 |
| 73 | PCC⁴ | Decanoic A. | 2.0 | N.A. | Sylvatal 20S | 2.31 |
| 74 | AR-118⁵ | Decanoic A. | 2.0 | 100.0 | Sylvatal 20S | 1.77 |
| 75 | AR-118⁵ | Decanoic A. | 2.0 | 100.0 | Sylvatal 20S | 1.75 |
| 76 | AR-118⁵ | Decanoic A. | 2.0 | 100.0 | Oleic (>97%) | 1.79 |
| 77 | ARP-29 | Decanoic A. | 0.7 | 26.0 | Sylvatal 20S | 1.98 |
| 78 | ARP-31 | Decanoic A. | 1.0 | 26.0 | Sylvatal 20S | 1.65 |
| 79 | ARP-35 | Decanoic A. | 1.5 | 26.0 | Sylvatal 20S | 1.57 |
| 80 | ARP-35 | Decanoic A. | 1.5 | 26.0 | Oleic (>97%) | 1.64 |
| 81 | ARP-35 | Decanoic A. | 1.5 | 26.0 | Oleic (>97%) | 1.62 |
| 82 | ARP-35 | Decanoic A. | 1.5 | 26.0 | Canola Oil | 1.66 |
| 83 | ARP-35 | Decanoic A. | 1.5 | 26.0 | Soybean Oil | 1.60 |
| 84 | ARP-35 | Decanoic A. | 1.5 | 26.0 | Sunflower Oil | 1.58 |
| 85 | ARP-35 | Decanoic A. | 1.5 | 26.0 | Corn Oil | 1.61 |
| 86 | ARP-35 | Decanoic A. | 1.5 | 26.0 | Mazola Oil | 1.59 |
| 87 | ARP-35 | Decanoic A. | 1.5 | 26.0 | Olive Oil | 1.63 |
| 88 | ARP-36 | Decanoic A. | 2.0 | 26.0 | Sylvatal 20S | 1.34 |
| 89 | ARP-36 | Decanoic A. | 2.0 | 26.0 | Sylvatal 20S | 1.35 |
| 90 | ARP-36 | Decanoic A. | 2.0 | 26.0 | Oleic (>97%) | 1.36 |
| 91 | ARP-37 | Decanoic A. | 2.0 | 15.0 | Sylvatal 20S | 1.28 |
| 92 | ARP-51 | Lauric A. | 1.5 | 26.0 | Sylvatal 20S | 1.78 |
| 93 | ARP-61 | Decanoic A. | 2.0 | 100.0 | — | — |
| 94 | ARP-62-1 | Decanoic A. | 3.0 | 100.0 | — | — |
| 95 | ARP-65 | Lauric A. | 1.5 | 50. | Sylvatal 20S | 2.04 |
| 96 | ARP-70 | Stearic A. | 1.5 | 50 | Sylvatal 20S | 2.36 |
| 97 | ARP-76 | Undecylenic | 1.5 | 50 | Sylvatal 20S | 2.02 |
| | | A. | | | | |
| 98 | ARP-77 | Myristic A. | 1.5 | 50 | Sylvatal 20S | 2.15 |
| 99 | ARP-71 | Isostearic A. | 1.5 | 50 | Sylvatal 20S | 2.71 |
| 100 | ARP-72 | Oleic A. | 1.5 | 50 | Sylvatal 20S | 2.58 |
| 101 | ARP-78 | Linoleic A. | 1.5 | 50 | Sylvatal 20S | 2.59 |
| 102 | ARP-83 | Palmitic A. | 1.5 | 50 | Sylvatal 20S | 2.61 |
| ¹“Girulite-8” CaCO3 powder (d50 = 3.5 microns) ex Polychrom - Israel. | | | | | | |
| ²“Girulite-8” CaCO3 powder (d50 = 3.5 microns) ex Polychrom - Israel, which was coated using 2 wt % n-decanoic acid (the coating is conducted by adding slowly the carboxylic acid (e.g.decanic acid) into a well stirred aqueous slurry of the GCC at 90° C. The product is then dewatered and dried at 120° C. for twelve hours). It is worthwhile noting that the S.G. value of this coated product is now <2.5 g/cm³ (>2.5 g/cm³ before | | | | | | |
| #coating¹). | | | | | | |
| ³Commercial PCC - Aragonite; of Specialty Minerals Inc. (SMI); Opacarb ® A40. | | | | | | |
| ⁴Commercial PCC - Aragonite; of Specialty Minerals Inc. (SMI); Opacarb ® A40, which was coated using 2 wt % n-decanoic acid (the coating is conducted by adding slowly the carboxylic acid (e.g.decanic acid) into a well stirred aqueous slurry of the PCC at 90° C. The product is then dewatered and dried at 120° C. for twelve hours). It is worthwhile noting that the S.G. value of this coated product is now <2.5 g/cm³ (>2.5 g/cm³ before | | | | | | |
| #coating³). | | | | | | |
| ⁵AR-118, a product of the present invention, mentioned already in EXAMPLE 14 (A), above. | | | | | | |
| ⁶The specific gravity of the liquids were as follows; Oleic A. 0.887 g/cm³; Tall Oil (Sylvatal 20S ex Arizona Chemical - USA) = 0.930 g/cm³; Refined Canola Oil (ex Milumor - Israel) = 0.910 g/cm³; Refined Corn Oil (ex Milumor - Israel) = 0.910 g/cm³; Refined Corn Oil (Mazola ex Bestfoods - USA) = 0.915 g/cm³; Refined Soybean Oil (ex Milumor - Israel) = 0.920 g/cm³; Refined Sunflower Oil (ex Milumor - Israel) | | | | | | |
| #= 0.918 g/cm³; Cold Pressed olive Oil (ex Shemen Industries - Israel) = 0.893 g/cm³; | | | | | | |

⁷The S.G. analyses were conducted at 21° C. ± 1° C.
N.A. - Not available

### EXAMPLE 15

Preparation of Exterior White Paint—Hercules Inc.

The procedure for the preparation of this paint was obtained from Hercules Inc.; Cellulose & Protein Products D.; Wilmington, Del. 19899 (USA). The procedure followed quite closely the Celanese Resins Formulation No. EP48-222 for the production of this Exterior White Paint (Vinyl Acetate & Acrylate).

(A) The ingredients used for the 52% PVC Paint and their function are as follows:

1. Tap water.

2. Nopco NDW defoamer.

3. Cellosize QP 15000 thickener (hydroxy ethyl cellulose).

4. Disperse One (45% N.V.) (dispersant).

5. Synperonic NP10 surfact; wetting agent.

6. Kronos 2160 TiO₂pigment.

7. Synthetic sodium aluminum silicate (p820) (spacer).

8. Kaolin clay (D₅₀=3.1 micron)(spacer).

9. CaCO₃ (spacer)—A GCC product of Polichrom Ltd., Israel.

10. Talc (D₅₀=112.3 micron)(spacer).

11. PCC—Aragonite of the present invention (samples used contained >80% CaCO₃ in the wet cake products before their drying; no diminution operation took place prior to this use. Namely, the PCC—Aragonite used is not necessarily yet optimized for its purpose).

12. Copolymer vinyl acetate acrylate (55% N.V.) (emulsion).

13. Butyl diglycol acetate solvent (coalescent agent).

14. Kathon LXE preservative.

15. 25% Ammonia (base).

16. Tap water.

Tap water (1), defoamer (2) and thickener (3) were added to a plastic container (d=20 cm; h=30 cm) equipped with a disk (d=8 cm) attached to a Dissolver (Homo Disperse Model HD-550 (0.75 HP) of Hsiangtal Machinery Industry Co. Ltd.; Taiwan). The mixture was stirred at 500 rpm for 5 minutes, after which the dispersant (4) and the wetting agent (5) were added, and stirring was continued at 500 rpm for additional 5 minutes. At this point the stirring speed was increased to 1500 rpm and the respective ingredients for the respective formulations 1-10 were added consecutively, each ingredient over a 5 minute period, according to the order in the above list of reagents (6-16).

The physical properties of the above paints were measured, including the most important property—the hiding power (%) of 90 μm layers of paint were determined with an ACS instrument (Applied Color Systems) and the results are given in the following Tables 19 and 20:

TABLE 19
the results of EXAMPLE 15
Exterior White Paint - Hercules Inc.
Evaluation of the 52% PVC Paints Based on the Precipitated Aragonite
Calcium Carbonate Particles of the Present Invention (PCC - Aragonite)

| Raw Material | 1 | 2 | 3 | 4 | 5 | 6 |
|---|---|---|---|---|---|---|
| | % (wt) | | | | | |
| Tap Water | 25.0 | 25.0 | 25.0 | 25.0 | 25.0 | 25.0 |
| Defoamer | 0.1 | 0.1 | 0.1 | 0.1 | 01 | 0.1 |
| Thickener(15K) | 0.3 | 0.3 | 0.3 | 0.3 | 0.3 | 0.3 |
| Dispersant (45%) | 0.9 | 0.9 | 0.9 | 0.9 | 0.9 | 0.9 |
| Wetting Agent | 0.35 | 0.35 | 0.35 | 0.35 | 0.35 | 0.35 |
| TiO₂; Kronos | 14.0 | 9.0 | 9.0 | 9.0 | 9.0 | 8.4 |
| Silicate | 3.7 | 3.7 | 3.7 | 3.7 | 4.0 | 3.9 |
| CaCO₃ - GCC | 7.0 | — | — | — | — | — |
| Kaolin Clay | 6.5 | 6.5 | 6.5 | 6.5 | 10.7 | 6.8 |
| Talc | 6.3 | — | — | — | — | — |
| PCC-Aragonite* | — | 17.75 | 17.75 | 17.75 | 13.00 | 17.75 |
| Copolymer (55%) | 24.5 | 25.5 | 25.5 | 25.5 | 25.4 | 25.4 |
| Coalescent Agent | 0.1 | 0.1 | 0.1 | 0.1 | 0.1 | 0.1 |
| Preservative | 0.5 | 0.5 | 0.5 | 0.5 | 0.5 | 0.5 |
| Ammonia | 0.3 | 0.3 | 0.3 | 0.3 | 0.3 | 0.3 |
| Tap Water | 10.45 | 10.0 | 10.0 | 10.0 | 10.35 | 10.2 |
| Total | 100. | 100. | 100. | 100. | 100. | 100. |

The Characteristics of the Paint

| | | | | | | |
|---|---|---|---|---|---|---|
| Solids (%) | 50.98 | 50.98 | 50.98 | 50.98 | 50.67 | 50.82 |
| P.V.C.(%) | 51.77 | 51.32 | 51.32 | 51.32 | 51.51 | 51.55 |
| Hiding Power (%) | 94.0 | 94.4 | 94.9 | 95.5 | 95.1 | 94.9 |
| Viscosity (K.U.) | 92.0 | 92.0 | 93.2 | 98.0 | 100.0 | 98.0 |
| Hegman | 4.5 | 5.5 | 5.5 | 5.0 | 4.0 | 4.5 |
| Bulk Density | 1.317 | 1.259 | 1.257 | 1.248 | 1.226 | 1.221 |
| Saving of TiO₂ (%) | — | 35.7 | 35.7 | 35.7 | 35.7 | 40.0 |
| Weight Saving (%) | — | 4.4 | 4.6 | 5.2 | 6.9 | 7.3 |

| Formulation | | Sample | | Active Agent |
|---|---|---|---|---|
| No. | Pigment* | Code | Active Agent | % (wt) |
| 1 | Reference Paint | — | — | — |
| 2 | PCC - Aragonite | AR-81 | Decanoic acid | 0.5 |
| 3 | PCC - Aragonite | AR-83 | Decanoic acid | 1.0 |
| 4 | PCC - Aragonite | AR-118 | Decanoic acid | 2.0 |
| 5 | PCC - Aragonite | AR-119 | Decanoic acid | 5.0 |
| 6 | PCC - Aragonite | AR-118 | Decanoic acid | 2.0 |

TABLE 20
the results of EXAMPLE 15
Exterior White Paint - Hercules Inc.
Evaluation of the 52% PVC Paints Based on the Precipitated Aragonite
Calcium Carbonate Particles of the Present Invention
(PCC - Aragonite)

| Raw Material | 1 | 7 | 8 | 9 | 10 |
|---|---|---|---|---|---|
| | % (wt) | | | | |
| Tap Water | 25.0 | 25.0 | 25.0 | 25.0 | 25.0 |
| Defoamer | 0.1 | 0.1 | 0.1 | 0.1 | 0.1 |
| Thickener(15K) | 0.3 | 0.3 | 0.3 | 0.3 | 0.3 |
| Dispersant (45%) | 0.9 | 0.9 | 0.9 | 0.9 | 0.9 |
| Wetting Agent | 0.35 | 0.35 | 0.35 | 0.35 | 0.35 |
| TiO₂; Kronos | 14.0 | 7.0 | 7.0 | 6.3 | 12.0 |
| Silicate | 3.7 | 4.8 | 4.2 | 4.2 | 3.7 |
| CaCO₃ - GCC | 7.0 | — | — | — | — |
| Kaolin Clay | 6.5 | 7.1 | 12.5 | 13.1 | 6.5 |
| Talc | 6.3 | — | — | — | — |
| PCC-Aragonite* | — | 17.75 | 13.0 | 13.0 | 15.3* |
| Copolymer (55%) | 24.5 | 25.5 | 26.0 | 26.0 | 24.5 |
| Coalescent | 0.1 | 0.1 | 0.1 | 0.1 | 0.1 |
| Preservative | 0.5 | 0.5 | 0.5 | 0.5 | 0.5 |
| Ammonia | 0.3 | 0.3 | 0.3 | 0.3 | 0.3 |
| Tap Water | 10.45 | 10.3 | 9.75 | 9.85 | 10.45 |
| Total | 100. | 100. | 100. | 100. | 100. |

The Characteristics of the Paint

| | | | | | |
|---|---|---|---|---|---|
| Solids (%) | 50.98 | 50.98 | 50.98 | 50.98 | 50.98 |
| P.V.C. (%) | 51.77 | 51.32 | 51.32 | 51.32 | 51.91 |
| Hiding Power (%) | 94.0 | 94.2 | 94.3 | 94.0 | 92.7 |
| Viscosity (K.U.) | 92.0 | 96.8 | 98.8 | 98.0 | 90.2 |
| Hegman | 4.5 | 4.5 | 4.5 | 4.5 | 4.5 |
| Bulk Density | 1.317 | 1.179 | 1.159 | 1.224 | 1.300 |
| Saving of TiO₂ | — | 50.0 | 50.0 | 55.0 | 14.3 |
| Weight Saving | — | 10.5 | 12.0 | 7.0 | 1.3 |

| Formulation | | Sample | | Active Agent |
|---|---|---|---|---|
| No. | Pigment* | Code | Active Agent | % (wt) |
| 1 | Reference Paint | — | — | — |
| 7 | PCC - Aragonite | AR-118 | Decanoic acid | 2.0 |
| 8 | PCC - Aragonite | AR-119 | Decanoic acid | 5.0 |
| 9 | PCC - Aragonite | AR-119 | Decanoic acid | 5.0 |
| 10 | PCC - Aragonite | C** | N.A. | N.A. |

**Commercial PCC - Aragonite; of Specialty Minerals Inc. (SMI); Opacarb ® A40.

(B) The ingredients of the 32% PVC Paint and their function are as follows:

1. Tap water.

2. Nopco NDW defoamer.

3; Cellosize QP 15000 thickener (hydroxy ethyl cellulose).

4. Disperse One (45% N.V.) (dispersant).

5. Synperonic NP10 surfactant; wetting agent.

6. Kronos 2160 TiO₂ pigment. 7.

7. Synthetic Na-Al silicate (p820) (spacer).

8. Kaolin clay (D₅₀3.1 micron)(spacer)

9. CaCO₃ (spacer)—a GCC product of Polichrom Ltd., Israel

10. Talc (D₅₀=1 2.3 micron)(spacer)

11. PCC—aragonite of the present invention (samples used contained >80% CaCO₃ in the wet cake products before their drying; no diminution operation took place prior to this use. However, the PCC—aragonite used is not necessarily yet optimized for its purpose).

12. Propylene glycol (solvent).

13. Copolymer vinyl acetate acrylate (55% N.V.) (emulsion).

14. Butyl diglycol acetate solvent (coalescent agent).

15. Kathon LXE preservative.

16. 25% Ammonia (base).

17. Tap water.

Tap water (1), defoamer (2) and thickener (3) were added to a plastic container (d=20 cm; h=30 cm) equipped with a disk (d=8 cm) attached to a Dissolver (Homo Dispers Model HD-550 (0.75 HP) of Hsiangtai Machinery Industry Co. Ltd.; Taiwan). The mixture was stirred at 500 rpm for 5 minutes, after which the dispersant (4) and the wetting agent (5) were added, and stirring was continued at 500 rpm for additional 5 minutes. At this point the stirring speed was increased to 1500 rpm and the respective ingredients for the respective formulations 1-10 were added consecutively, each ingredient over a 5. minute period, according to the order in the above list of reagents (6-15).

The physical properties of the above paints were measured, including the most important property—the hiding power (%) of 90 pm layers of paint were determined with an ACS instrument (Applied Color Systems) and the results are given in the following

TABLE 21
the results of EXAMPLE 15
Exterior White Paint - Hercules Inc.
Evaluation of the 32% PVC Paints Based on the Precipitated Aragonite
Calcium Carbonate Particles of the Present Invention (PCC - Aragonite)

| Raw Material | 11 | 12 | 13 | 14 | 15 | 16 |
|---|---|---|---|---|---|---|
| | % (wt) | | | | | |
| Tap Water | 17.8 | 17.8 | 17.8 | 17.8 | 17.8 | 17.8 |
| Defoamer | 0.15 | 0.15 | 0.15 | 0.15 | 0.15 | 0.15 |
| Thickener(15K) | 0.22 | 0.22 | 0.22 | 0.22 | 0.22 | 0.22 |
| Dispersant (45%) | 0.60 | 0.60 | 0.60 | 0.60 | 0.60 | 0.60 |
| Welling Agent | 0.34 | 0.34 | 0.34 | 0.34 | 0.34 | 0.34 |
| TiO₂; Kronos | 22.5 | 20.0 | 20.0 | 19.0 | 18.0 | 19.0 |
| Silicate | 2.25 | 2.25 | 2.25 | 2.25 | 2.25 | — |
| CaCO3 - GCC | 5.0 | — | — | — | — | — |
| PCC-Aragonite* | — | 7.5 | 7.5 | 8.5 | 9.25 | 13.0 |
| Propylene Glycol | 2.70 | 2.70 | 2.70 | 2.70 | 2.70 | 2.70 |
| Copolymer (55%) | 37.45 | 37.45 | 37.45 | 37.45 | 38.0 | 33.4 |
| Coalescent Agent | 0.18 | 0.18 | 0.18 | 0.18 | 0.18 | 0.18 |
| Preservative | 0.45 | 0.45 | 0.45 | 0.45 | 0.45 | 0.45 |
| Ammonia | 0.30 | 0.30 | 0.30 | 0.30 | 0.30 | 0.30 |
| Tap Water | 10.06 | 10.06 | 10.06 | 10.06 | 9.76 | 11.86 |
| Total | 100. | 100. | 100. | 100. | 100. | 100. |

The Characteristics of the Paint

| | | | | | | |
|---|---|---|---|---|---|---|
| Solids (%) | 50.35 | 50.35 | 50.35 | 50.35 | 50.35 | 50.37 |
| P.V.C. (%) | 32.59 | 32.64 | 32.64 | 32.93 | 32.64 | 36.73 |
| Hiding Power (%) | 91.0 | 91.4 | 91.4 | 91.0 | 90.8 | 91.0 |
| Viscosity (K.U.) | 87.2 | 98.0 | 97.4 | 96.2 | 87.8 | 90.2 |
| Hegman | 5.5 | 5.5 | 5.5 | 5.5 | 5.0 | 5.5 |
| Bulk Density | 1.18 | 1.128 | 1.127 | 1.109 | 1.005 | 1.073 |
| Saving of TiO₂ | - | 11.1 | 11.1 | 15.5 | 20.0 | 15.5 |
| Weight Saving | - | 4.4 | 4.5 | 6.0 | 14.8 | 6.8 |

| Formulation | | Sample | | Active Agent |
|---|---|---|---|---|
| No. | Pigment* | Code | Active Agent | % (wt) |
| 11 | Reference Paint | — | — | — |
| 12 | PCC - Aragonite | AR-118 | Decanoic acid | 2.0 |
| 13 | PCC - Aragonite | AR-119 | Decanoic acid | 5.0 |
| 14 | PCC - Aragonite | AR-119 | Decanoic acid | 5.0 |
| 15 | PCC - Aragonite | AR-119 | Decanoic acid | 5.0 |
| 16 | PCC - Aragonite | AR-118 | Decanoic acid | 2.0 |

Notes:
1. The particulate precipitated aragonite calcium carbonate of the present invention (PCC-Aragonite) can be used to produce paints without a substantial prior size reduction, except that effected by the mixing system of the production of the paint, which is anyway being used in this art to thoroughly disperse the pigments in the various formulations.
2. Though the particulate precipitated aragonite calcium carbonate of the present invention (PCC-Aragonite) is not yet optimized for its use in the production of paints and though the formulations used are by no means optimized, still this product is able to substitute over 50% of the expensive titanium oxide pigment without any deterioration of the resulting paint, as it manifested by the hiding power measured.
3. As the coatings (paints) are being sold and used by volume, and not by weight, the additional saving resulting from using the particulate precipitated aragonite calcium carbonate of the present invention (PCC-Aragonite) can surpass 10% on all the constituents of the coating, including the titanium oxide.
4. For simplicity in formulating the above mentioned paints, dry samples of The particulate precipitated aragonite calcium carbonate of the present invention (PCC-Aragonite), were used. However, wet filter cakes that contain even more water than 20% wt. %, based on wet CaCO₃ cake, can be used, provided that this water is being taken in account. However, on an industrial scale, dry PCC-Aragonite will be rarely used, due to the economy of using the wet product.

(C) A Comparison of Modified Paint Formulations Containing Various GCC/PCC

The experimental of EXAMPLE 15 (A) was repeated, except that the paint compositions contained only one selected PCC/GCC pigment (>50 wt %) at a time and the minimum required ingredients that were necessary to prepare these basic modified paint formulations. A standard (STD) interior paint formulation was used as a general reference.

The paint compositions are as follows:

TABLE 22
STD vs. Modified paint formulation of EXAMPLE 15 (C)

| Raw Material | S T D | Modified |
|---|---|---|
| Water | 28.25 | 28.87 |
| Defoamer | 0.30 | 0.38 |
| Thickener | 0.20 | 0.09 |
| Dispersant | 0.40 | 0.00 |
| Wetting Agent | 0.30 | 0.00 |
| TiO₂ | 7.5 | 0.00 |
| Silicate | 3.5 | 0.00 |
| Talc | 13.0 | 0.00 |
| G.C.C. | 34.0 | 0.00 |
| AR-pigment | 0.00 | 57.28 |
| Propylene glycol | 1.00 | 0.56 |
| Copolymer - 50% solids | 11.40 | 12.72 |
| Biocide | 0.15 | 0.10 |
| Total | 100.0 | 100.0 |
| % Solids in paint | 63.7 | 64.3 |

The physical and optical properties of the pigments used and the paint obtained are follows:

TABLE 23
the pigments properties in EXAMPLE 15 (C)

| | | | | | S.S.A. | PSD⁴ | |
|---|---|---|---|---|---|---|---|
| | Pigment | Active | Dosage | CO₂ | (BET) | μ | |
| Paint | Code | Agent | (wt %)³ | (v%) | (m²/g) | D₉₀ | D₅₀ |
| STD | — | — | — | — | — | — | — |
| 1 | PCC¹ | — | — | — | 12.0 | 2.0 | 0.8 |
| 2 | GCC² | — | — | — | 4.0 | 5.0 | 2.1 |
| 3 | ARP-29 | Decanoic A. | 0.7 | 26.0 | 5.7 | 4.49 | 1.98 |
| 4 | ARP-31 | Decanoic A. | 1.0 | 26.0 | 6.2 | 3.54 | 1.68 |
| 5 | ARP-34 | Decanoic A. | 1.5 | 100 | 11.1 | 2.68 | 1.27 |
| 6 | ARP-35 | Decanoic A. | 1.5 | 26.0 | 11.5 | 3.0 | 1.65 |
| 7 | ARP-36 | Decanoic A. | 2.0 | 26.0 | 15.4 | 2.51 | 0.73 |
| 8 | ARP-37 | Decanoic A. | 2.0 | 15.0 | 10.9 | 2.20 | 0.93 |
| 9 | ARP-51 | Lauric A. | 1.5 | 26.0 | | 4.14 | 2.39 |
| 10 | ARP-61 | Decanoic A. | 2.0 | 100 | 15.5 | 1.8 | 0.68 |
| 11 | APR-65 | Lauric A. | 1.5 | 50.0 | 8.2 | 5.4 | 3.1 |
| 12 | ARP-70 | Stearic A. | 1.5 | 50.0 | 4.3 | 5.3 | 1.6 |
| 13 | ARP-71 | Isostearic | 1.5 | 50.0 | 1.9 | 9.3 | 5.9 |
| 14 | ARP-72 | Oleic A. | 1.5 | 50.0 | 3.7 | 10.9 | 6.5 |
| 15 | ARP-76 | Undecylenic | 1.5 | 50.0 | 13.1 | 2.7 | 1.5 |
| | | A. | | | | | |
| 16 | ARP-77 | Myristic A. | 1.5 | 50.0 | 5.2 | 3.8 | 2.3 |
| 17 | ARP-83 | Palmitic A. | 1.5 | 50.0 | | | |

¹Commercial stable PCC Slurry of Aragonite (Opacarb ® A40 ex SMI - USA). Calculation of the S.G. of the aragonite particles in a 69.6% commercial slurry resulted in 2.83 g/cm³. Naturally, this slurry was used to produce the paint above.
²CaCO3 (spacer) - a GCC (Calcite ex Polichrom Ltd. - Israel).
³Calculated as the acid form, based on the CaCO3.
⁴The PCC of the present invention has not undergone any size reduction prior to its use, except the size reduction that may happen, during regular operations.

TABLE 24
the paint properties in EXAMPLE 15 (C)

| | | | | | S.G.⁴ | Paint | |
|---|---|---|---|---|---|---|---|
| Paint | Pigment | Active | Dosage | CO₂ | 120° C. | | Hiding⁶ |
| Code | Code | Agent | (wt %)³ | (v%) | (g/m³) | Gloss⁵ | Power |
| STD | — | — | — | — | — | 2.1 | 83.7 |
| 1 | PCC¹ | — | — | — | 2.56 | 31.9 | 88.0 |
| 2 | GCC² | — | — | — | 2.63 | 2.2 | 80.9 |
| 3 | ARP-29 | Decanoic A. | 0.7 | 26.0 | 1.98 | 3.0 | 92.6 |
| 4 | ARP-31 | Decanoic A. | 1.0 | 26.0 | 1.65 | 3.6 | 96.5 |
| 5 | ARP-34 | Decanoic A. | 1.5 | 100 | — | 7.5 | 96.3 |
| 6 | ARP-35 | Decanoic A. | 1.5 | 26.0 | 1.57 | 4.0 | 99.6 |
| 7 | ARP-36 | Decanoic A. | 2.0 | 26.0 | 1.34 | 5.5 | 98.1 |
| 8 | ARP-37 | Decanoic A. | 2.0 | 15.0 | 1.28 | 5.2 | 99.5 |
| 9 | ARP-51 | Lauric A. | 1.5 | 26.0 | 1.78 | 4.3 | 94.8 |
| 10 | ARP-61 | Decanoic A. | 2.0 | 100 | — | 11.5 | 98.3 |
| 11 | APR-65 | Lauric A. | 1.5 | 50.0 | 2.04 | 4.0 | 93.7 |
| 12 | ARP-70 | Stearic A. | 1.5 | 50.0 | 2.36 | 2.6 | 94.1 |
| 13 | ARP-71 | Isostearic | 1.5 | 50.0 | 2.71 | 1.8 | 70.0 |
| 14 | ARP-72 | Oleic A. | 1.5 | 50.0 | 2.58 | 1.9 | 74.9 |
| 15 | ARP-76 | Undecylenic | 1.5 | 50.0 | 2.02 | 4.7 | 96.8 |
| | | A.⁷ | | | | | |
| 16 | ARP-77 | Myristic A. | 1.5 | 50.0 | 2.15 | 3.5 | 95A |
| 17 | ARP-83 | Palmitic A. | 1.5 | 50.0 | 2.61 | 2.0 | 79.3 |

¹Commercial PCC a stable slurry of Aragonite (Opacarb ® A40 ex SMI - USA).
²CaCO3 (spacer) - a GCC (Calcite ex Polichrom Ltd. - Israel).
³Calculated as the acid form, based on the CaCO3.
⁴Measured according to Example 14(A), after drying at 120° C. for twelve hours (c. f. Tables 13 and 15d).
⁵Measured at 60⁰ with a Glossmeter (Minigloss 101N ex Sheen Instruments - England).
⁶The hiding power of a 90μ layer was measured with a reflectometer (Ref. 310 Sheen-Opac ex Sheen Instruments - England).
⁷This compound, for example, can be brominated and thus serves also as a flame retardant.
Notes:
1. The gloss increases as the v% of the CO₂ in the feed gas increases. The gloss increases as the wt % of the active agent increases. The gloss increases as the specific gravity (S.G.) of the PCC decreases. These facts are particularly important in controlling the PCC of the present invention, and more specifically, in formulating high-gloss paper coatings on the one hand and it is particularly important in formulating low-gloss paints on the other hand.
2. The opacity increases as the wt % of the active agent increases. The opacity increases as the V% of the air in the feed gas increases. The opacity increases as the specific gravity (S.G.) of the PCC decreases. n-Decanoic acid seems to exhibit, thus far, the best performance, however, the optimal w% seems to be in the range between 1.5 wt % to 3 wt % for this purpose of forming products of high hiding power.

### EXAMPLE 16

The preparation of the Plastic (Polypropylene Copolymer—PP) Formulations

The composition of the various formulations was as follows: 40% Filler, 0.3% antioxidant (irganox B225 ex Ciba Specialty Chemicals—Switzerland), 0.5% lubricant (Wax PE. 520 ex Hoechst-Celanese—USA) and 59.2% polypropylene copolymer (Capilene-TR50 ex Carmel Olefins—Israel).

(A) Preparation of the Particulate Precipitated Aragonite

Three samples of particulate precipitated aragonite of the present invention were used and three of the top quality commercial samples were used for comparison. The preparation parameters of the aragonite samples and their properties are given in Table 25, as follows:

The Process Set Points—Continuous Mode of Operation:

1. Rotor Speed=4000 rpm (Tip Speed—10 m/sec.)

2. pH 9.5.

3. Temperature=90° C.

4. Carbon dioxide flow rate=180 L.P.H. (liters/hour).

5. Aqueous calcium hydroxide slurry (of Shfeya) −10 wt. %=−6 L.P.H. (to maintain the preset pH value).

6. Active agent concentration=decanoic acid; 0.5; 1; 2 wt. % based on CaCO₃.

TABLE 25
the results of EXAMPLE 16(A)

| | | | | Aragonite | | | SSA |
|---|---|---|---|---|---|---|---|
| | Sample | | | Aragonite + Calcite | D₉₀¹ | B** | (BET) |
| # | Code | Active agent | (wt. %) | XRD | μ | (%) | m²/g |
| 1 | AR-213 | Decanoic Acid | 0.5* | 93-96% | 5.92 | 95.8 | 3.6 |
| 2 | AR-214 | Decanoic Acid | 1.0* | 93-96% | 4.38 | 98.3 | 6.4 |
| 3 | AR-215 | Decanoic Acid | 2.0* | 96-98% | 1.56 | 98.2 | 12.8 |

*50 ppm of phosphoric acid were used in addition to the decanoic acid to increase the aspect ratio of the acicular aragonite.
**Brightness.
¹The PCC of the present invention has not undergone any size reduction prior to its use, except the size reduction that may happen during regular operations.

Compounding of the Plastic (Polypropylene Copolymer) Formulations

The formulations were processed in a co-rotating twin-screw compounder (L/D=24 ex Dr. Collin—Germany). The compounding conditions are given in Table 26, as follows:

TABLE 26
the compounding conditions of EXAMPLE 16(B)

| | | Melt | Screws | | |
|---|---|---|---|---|---|
| | | Temp. | Speed | Pressure | Torque |
| # | Filler | (° C.) | (rpm) | (bar) | (N.m) |
| 1 | AR-215 | 203 | 200 | 16 ± 5 | 45 ± 5 |
| 2 | AR-214 | 203 | 200 | 15 ± 5 | 40 ± 2 |
| 3 | AR-213 | 202 | 200 | 18 ± 5 | 43 ± 2 |
| 4 | OM-95^{A} | 201 | 175 | 30 ± 5 | 63 ± 2 |
| 5 | UPCC^{B} | 203 | 174 | 30 ± 5 | 60 ± 3 |
| 6 | UTALC^{C} | 202 | 195 | 17 ± 2 | 49 ± 2 |

^{A}Commercial ultrafine stearic acid coated - UFT 95 GCC natural calcite (95 wt % pass 2μ size) ex Omya-Pluess-Staufer - Switzerland.
^{B}Commercial ultrafine stearic acid coated - Ultraflex PCC calcite ex SMI - USA.
^{C}Commercial ultrafine talc - Ultratalc 609 ex SMI - USA.
Note:
The results of the compounding step, in Table 16b, indicate that the PCC of the present invention is superior over the commercial products of the top qualities and top prices in the market.

(C) Injection of the Plastic (Polypropylene Copolymer) Formulations

The resulting granules were fed to an injection machine (25 t ex Dr. Boy—Germany). Specimens of 127×12.7×3.2 mm we produced. The injection conditions are given in Table 27 as follows:

TABLE 27
the compounding conditions of EXAMPLE 16c

| | | | Injection | Injection | Injection |
|---|---|---|---|---|---|
| | | Temp. | Speed | Pressure | Pressure |
| # | Filler | (° C.) | (cm³/sec) | (bar) | (bar) |
| 1 | AR-215 | 170-180 | 66 | 250 | 250 |
| 2 | AR-214 | 170-180 | 66 | 250 | 250 |
| 3 | AR-213 | 170-180 | 66 | 250 | 300 |
| 4 | OM-95^{A} | 170-180 | 66 | 250 | 300 |
| 5 | UPCC^{B} | 170-180 | 66 | 400 | 400 |
| 6 | UTALC^{C} | 170-180 | 66 | 400 | 400 |

^{A}a commercial ultrafine stearic acid coated GCC ex Omya-Pluess-Staufer - Switzerland.
^{B}a commercial ultrafine stearic acid coated - Ultraflex PCC ex SMI - USA.
^{C}a commercial ultrafine talc - Ultratalc 609 ex SMI - USA.
Note:
Only OM-95 behaves quite close to the PCC of the present invention (AP-213, Ar-214 and AR-215) in the injection compartment. The relatively (very) expensive talc is unable to compete with AR-213, Ar-214 and AR-215.

(D) The Mechanical Tests he resulting specimens were conditioned at 25° C. under 50% RH for at least 72 hrs. before testing them. Two test were performed as follows: Flexure testing (3 point) was conducted according to ASTM D-790. Impact testing—Izod notched was conducted according to ASTM D-256.

The results are given in table 28, as follows:

TABLE 28
the results of the mechanical tests of EXAMPLE 16d

| | | Flex. | |
|---|---|---|---|
| | | Modulus | Impact |
| # | Filler | (Mpa) | (J/m) |
| 0 | —* | 793 | 538 |
| 1 | AR-215 | 1603 ± 60 | 225 ± 21.7 |
| 2 | AR-214 | 1872 ± 90 | 281 ± 18.7 |
| 3 | AR-213 | 1735 ± 31 | 397 ± 14.5 |
| 4 | OM-95^{A} | 1107 ± 20 | 192 ± 20.4 |
| 5 | UPCC^{B} | 1006 ± 13 | 5.1 ± 6.4 |
| 6 | UTALC^{C} | 1749 ± 54 | 151 ± 5.3 |
| *Capilene - TR50 as reported by its producer. | | | |
| ^{A}a commercial ultrafine stearic acid coated GCC ex Omya-Pluess-Staufer - Switzerland. | | | |
| ^{B}a commercial ultrafine stearic acid coated - Ultraflex PCC ex SMI - USA. | | | |
| ^{C}a commercial ultrafine talc - Ultratalc 609 ex SMI - USA. | | | |
| Notes: | | | |
| 1. Fillers are usually added to the polypropylene (PP) formulations to increase their flexural modulus. In the proper loading range, the higher the concentration of the filler, the higher is the flexural modulus. However, as the concentration of the filler increases, the Izod impact characteristics are decreased dramatically. Namely, the final loading of the filler in the polymer is the result of optimizing both characteristics of the final (consumer) products. Under the same | | | |
| #experimental conditions, the particulate precipitated calcium carbonate of the present invention (AR-213, Ar-214 and AR-215) are by far superior over commercial products of the highest quality in the market. | | | |

2. The overall properties of the PCC of the present invention are superior over the commercial products of top qualities in the market, as it may leads to faster operations and to better (consumer) products.

### EXAMPLE 17

Adsorption Experiments Using the PCC of the Present Invention

The PCC/GCC particles of the prior art can adsorb limited quantities of liquids and in all cases that will take place quite fast onto their surface.

The PCC of the present invention exhibits a varied behavior, depending on the environment at which these particles are located.

(A) The PCC Particles of the Present Invention in the Gas Phase

The results that were obtained by using the gas pycnometer to determine the specific gravity (S. G.) of the product of the present invention (c. f. EXAMPLE 14 (D)) do not indicate at all that these particles contain some kind of “pores” or “bubbles” or “blisters” to any extend. However, the following results will demonstrate that this view is entirely wrong.

(B) The PCC Particles of the Present Invention in Stable Aqueous Dispersions

The Process Set Points—Continuous Mode of Operation:

1. Rotor Speed=1200 rpm (Rotor Diameter=10 cm)

2. pH=9.5±0.2

3. Temperature=85° C.±2

4. Carbon dioxide flow rate=2.5 m³/hr.

5. Aqueous calcium hydroxide slurry (of Shfeya) −10 wt. %=−80-100 L.P.H. (to maintain the preset pH value).

6. CO₂ (v%) in the feed gas=30%

7. Active agent concentration=decanoic acid; 1.5 wt. % based on CaCO₃.

8. Reactor Volume=50 I. (Diameter=30 cm).

9. The product (of the present invention)—ARP-73

Preparation of Stable Slurries (60-70 wt %) in Water:

The wet cake of ARP-73, which was obtained after dewatering of the product, was mixed with about 2 wt % dispersant (resulting in calculated −1:1 dry weight ratio; Dispex N40 (−45 wt % solids) ex Allied Colloids—GB) and water) in a 10 1. (d=30 cm) tank that was equipped with, laboratory dissolver (DVH-020-18/6; 2.5 HP ex a Dantco Inc.—USA; rotor diameter=10 cm) for 60 mins. at 1200 rpm. The resulting slurries exhibit the following characteristics:

TABLE 29
the results of EXAMPLE 17 (B)

| | | S.G. of Slurry | | |
|---|---|---|---|---|
| | Solids | (g/cm³)⁴ | | S.G. of Solids |
| Sample | In Slurry | After | After | ARP-73 |
| Code | (wt %)¹ | Preparation¹ | 7 Days² | (g/cm³)¹ |
| ARP-73-1 | 60.2 | 1.47 | 1.47 | 2.13 |
| ARP-73-2 | 69.3 | 1.61 | 1.61 | 2.20 |
| ARP-73-3 | 63.0 | 1.55 | 1.55 | 2.30 |
| | | | 1.68³ | >2.79³ |
| ¹Was measured and/or immediately after the preparation of the slurry, but no efforts were made to minimize the S.G. values of the PCC. | | | | |
| ²Was measured and calculated, but no efforts were made to minimize the S.G. values of the PCC. | | | | |
| ³The addition of 2 wt % sodium dioctylsulfosuccinate (75% in ethanol; ex Cytec - USA) - a potent wetting agent - to the water at the end of the preparation stage (+ a short stirring thereafter), led to the formation of a very dense and viscose mass after 7 days (most of the water have been absorbed by the PCC of the present invention!), which could not be stirred. This mass was disintegrated by adding more of the wetting agent and stirring the mass. The S.G. of the slurry | | | | |
| #was then measured³ (1.68 g/cm³) and the calculated³ S.G. of the PCC was >2.79 g/cm³. Such behavior is unprecedented in the prior art of PCC/GCC products. | | | | |

⁴The low S.G. values are also observed in e.g. the paint compositions containing the products of the present invention, which gives rise to an additional advantage, as was explained already in EXAMPLE 15.

(C) Dispersions of the PCC Particles of the Present Invention in Organic Solvents

Attempts to obtain stable slurries of the PCC of the present invention in organic solvents such as alcohols (e.g. methanol, ethanol, isopropanol), ketones (e.g. acetone, methyl ethyl ketone), esters (e.g. methyl acetate, ethyl acetate), aromatic solvents (e.g. toluene, xylene, chlorobenzene, o-dichlorobenzene), and many others, result in the formation of mixtures in which the specific gravity (S.G.) of the PCC particles is >2.5 g/cm³ (usually, water and oils (e.g. those that are mentioned as liquids in Examples 14 (A) and 14 (H)), permeate very slowly during very long periods and in some cases it is impractical to measure their permeation rates). More polar solvents such as ethylene glycol penetrate more slowly into the PCC of the present invention, and eventually the S.G. values reach the ultimate value that characterizes calcite, and especially aragonite, calcium carbonate (namely, −2.7-2.9 g/cm³, depending on the specific crystallographic purity of the tested products). Naturally, the increase of the S.G. is dependent on many factors such as pressure, temperature, viscosity, surface tension, purity, and naturally the quality of the PCC product of the present invention.

It is worthwhile noting that the unique properties of the original PCC particles of the present invention are fully restored once the organic solvent is evaporated to dryness, and this product can be used in the same application or another one as the original sample. More specifically, after the removal of e.g. acetone, toluene, or ethyl acetate, all the properties of a used sample e. g. of AR-120, matched the original sample.

The phenomenon described in this EXAMPLE 17 leads to the conclusion that the PCC of the present invention can readily be used as an adsorbent for liquids (solvent), as a carrier (encapsulant) for liquids and solids (by dissolving them in a suitable solvent; allowing the solution to penetrate into the “pores” of the PCC; and removing the solvent by e.g. evaporation or dissolution of the solvent in another solvent that reduces the solubility of the substrate. The PCC of the present invention can encapsulate many compounds, including e.g. pharmaceuticals (medicines), agrochemicals, flavors, fragrances and sunscreen agents (this PCC itself is particularly, suitable for protecting the human skin, once its particles are fine-tuned for that purpose. Due to the trapped gas (air) in the PCC of the present invention, this task of fine-tuning the PSD to meet the requirements to protect from incoming light at 300-400 mμ, is expected to be much less expensive than of e. g. the TiO₂, which is used for this purpose quite often). Therefore, the PCC of the present invention offers two functions in one material, namely, encapsulation and efficient light dispersion). Moreover, the “porous” nature of this PCC makes it a preferable candidate to serve as a filler, a builder and/or an anticaking agent in e. g. powder detergents, etc.

To summarize, the PCC of the present invention can serve in any capacity that calcium carbonate particles of the prior art serve, and additionally it possesses many advantages due to its “porous” nature.

The results of mixing experiments at which a solvent only or a solution is used to form a thick and dense viscose mass are reported as follows:

TABLE 30
the results of EXAMPLE 17 (C)

| | PCC/GCC¹ | Liquid | Substrate- | Ratio | Residual |
|---|---|---|---|---|---|
| # | Product | (Solvent) | (wt %) | wt/wt² | Liquid² |
| 1 | ARP-73 | Water | DOSSNa -2 | 1.0 | − |
| 2 | “Girulite-8” | Methanol | — | 1.2 | + |
| 3 | Opacarb ® A40 | Methanol | — | 1.2 | + |
| 4 | ARP-35 | Methanol | — | 1.2 | − |
| 5 | ARP-37 | Methanol | — | 1.2 | − |
| 6 | ARP-76 | Methanol | — | 1.2 | − |
| 7 | “Girulite-8” | Methanol³ | p-Anisaldehyde-5 | 1.2 | + |
| 8 | Opacarb ® A40 | Methanol³ | p-Anisaldehyde-5 | 1.2 | + |
| 9 | ARP-35 | Methanol^{3,4} | p-Anisaldehyde-5 | 1.2 | − |
| 10 | ARP-37 | Methanol^{3,4} | p-Anisaldehyde-5 | 1.2 | − |
| 11 | ARP-76 | Methanol^{3,4} | p-Anisaldehyde-5 | 1.2 | − |
| 12 | “Girulite-8” | Acetone³ | HBCD-5 | 1.2 | + |
| 13 | Opacarb ® A40 | Acetone³ | HBCD-5 | 1.2 | + |
| 14 | ARP-35 | Acetone^{3,5} | HBCD-5 | 1.2 | − |
| 15 | ARP-37 | Acetone^{3,5} | HBCD-5 | 1.2 | − |
| 16 | ARP-76 | Acetone^{3,5} | HBCD-5 | 1.2 | − |
| 17 | “Girulite-8” | Ethyl Acetate³ | Caffeine-0.5 | 1.2 | + |
| 18 | Opacarb ® A40 | Ethyl Acetate³ | Caffeine-0.5 | 1.2 | + |
| 19 | ARP-35 | Ethyl Acetate^{3,6} | Caffeine-0.5 | 1.2 | − |
| 20 | ARP-37 | Ethyl Acetate^{3,6} | Caffeine-0.5 | 1.2 | − |
| 21 | ARP-76 | Ethyl Acetate^{3,6} | Caffeine-0.5 | 1.2 | − |
| 17 | “Girulite-8” | Acetonitrile³ | Pd (II) Diacetate-2 | 1.2 | + |
| 18 | Opacarb ® A40 | Acetonitrile³ | Pd (II) Diacetate-2 | 1.2 | + |
| 19 | ARP-35 | Acetonitrile^{3,7} | Pd (II) Diacetate-2 | 1.2 | − |
| 20 | ARP-37 | Acetonitrile^{3,7} | Pd (II) Diacetate-2 | 1.2 | − |
| 21 | ARP-76 | Acetonitrile^{3,7} | Pd (II) Diacetate-2 | 1.2 | − |
| ¹The respective powder was mixed thoroughly with the liquid (solvent; solution) in a tightly closed 100 cm³ erlenmeyer and allowed to stand for one hour at 21° C. ± 1° C. Test #1 lasted longer, as water permeates much slower - described in EXAMPLE 17 (B). | | | | | |
| ²The weight ratio of liquid/powder (which was de-agglomerated and sieves through a 0.6 mm screen. The fines that passed the screen were used). | | | | | |
| ³At the end of each test, the presence of a liquid layer on top of the slurry and its flowability was marked by a plus sign, while the absence of such a layer and the formation of a thick viscose mass was marked by a minus sign. | | | | | |
| ⁴The products of the present invention were then dried, de-agglomerated and sieved through a 0.6 mm screen. The fines that passed the screen were stored for stability tests. This experiment was repeated using the following substrates: p-Anisaldehyde (a flavor & fragrance); 2-Ethylhexyl trans-Cinnamate (a sunscreen agent); (−) Menthon (a pharmaceutical & fragrance); Menthol (a flavor & fragrance); Anise Alcohol | | | | | |
| #(ex Koffolk - Israel) (a flavor & fragrance); Methyl Raspberry Ketone (a flavor & fragrance); and Lilial (a fragrance). | | | | | |

⁵The products of the present invention were then dried, de-agglomerated and sieved through a 0.6 mm screen. The fines that passed the screen were stored for stability tests. This experiment was repeated using the following substrates: Hexabromocyclododecane (Syntex HBCD ™ ex Albemarle - USA) (a flame retardant for plastics); and NeendX ™ ex Albemarle - USA (a non-halogen flame retardant for elastics); Diazinon (Diazol ex Makhteshim-Agan - Israel) (an insecticide).
⁶The products of the present invention were then dried, de-agglomerated and sieved through a 0.6 mm screen. The fines that passed the screen were stored for stability tests. This experiment was repeated using the following substrates; Caffeine (a pharmaceutical); and (−) Menthon (a pharmaceutical and fragrance).
⁷The products of the present invention were then dried, de-agglomerated and sieved through a 0.6 mm screen. The fines that passed the screen were stored for for further calcination and hydrogenation (other precious metals could be used in a similar manner).
Notes:
1. The “porous’ product of the present invention may absorb considerable quantities of solvents (>50% of its weight).
2. The existence of “pores” in the PCC of the present invention has been established by indirect evidence. However, it is not of much consequence if we are still not too accurate in depicting the exact properties that are responsible for the effects that were encountered.

### EXAMPLE 18

Preparation of Ultra-Lightweight Coated (ULWC) Papers

(A) The Pigments

Using methods that are known to the paper industry, a series of PCC pigments of the present invention (AR), with variations in particle size and distribution, was compared to commercial pigments that are customarily being used in the prior art. The AR products were used, as obtained in their production process, for comparison with Opacarb A40 (a commercial product ex SMI—USA). Characterization data is as follows:

TABLE 31
characterization of the pigments of EXAMPLE 18:

| Pigment | AR-110B | AR-F1 | AR-245-S | A40 |
|---|---|---|---|---|
| Identification | 4449-90.3 | 4449-90.4 | 3911-17 | 4327-48 |
| pH | — | 7.7 | 9.6 | 10.3 |
| % solids | 72.7 | 71.8 | 72.9 | 70.8 |
| Brook. 20 | 15150 | 10400 | 8040 | 220 |
| Visc. 50 | 6800 | 4480 | 3832 | 111 |
| 100 | 3700 | 3480 | 2204 | 110 |
| Hercules | 290 | ND | 441 | 1440 |
| PSD¹ @90 | 2.25 | 1.83 | 2.52 | 1.76 |
| 50 | 0.81 | 0.69 | 1.69 | 0.43 |
| 20 | 0.41 | 0.35 | 1.40 | 0.27 |
| 10 | 0.29 | 0.24 | 1.32 | 0.21 |
| SSA¹ | 7.5 | 6.8 | 6.8 | 12.2 |
| SD(90/20)² | 2.34 | 2.29 | 1.34 | 2.55 |
| Dry Rd | 95.0 | 94.3 | 95.3 | 95.9 |
| a | −0.6 | −0.5 | −0.6 | −0.1 |
| b | 0.3 | 0.8 | 1.0 | 0.8 |

¹It is worthwhile noting that the particles of the AR series are much larger than those of A40, which is also being reflected in the SSA values, respectively.
²SD (90/20) is used instead of GSD (84/16) to reflect the particle size distribution because d84 and d16 values were not available for the experimental pigments.

The clay control formulation developed with CPI consisted of 85 parts Kaowhite delaminated clay, 5 parts Ansilex 93 calcined clay and 10 parts TiO₂. Carbonates were used at 33 parts replacing an equal amount of delaminated clay. Binders and additives included Styronal 4606 SX latex and PG290 starch at 9 parts each and 0.7 parts Nopcote C-104 calcium stearate; Solids were adjusted to 60%. All formulations were coated at 2500 fpm on CPI groundwood stock (28#) to bracket the target of 3.5#/R. Coated sheets were calendered to achieve a gloss of 40 for the lowest weight clay control sample. Conditions were 2 nips at 600 pli and 150° F.

(B) Pigment and Coating Color

The paste-like consistency of the AR-F1 sample made determination of Hercules rheology of this pigment impossible. The high Brookfield viscosities of the AR series is most likely due to their unique and unusual thickening ability. A check of adequate dispersants and dispersant levels on these pigments is not presented herein, because of the proprietary nature of the dispersant package. The results are as follows:

TABLE 32
coating color results of EXAMPLE 18:

| | 4576-10-1 | 4576-10-2 | 4576-10-8 | 4576-10-9 | 4576-10-10 |
|---|---|---|---|---|---|
| Formulation | Clay | Opacarb | 4449-90.3 | 4449-90.4 | 3911-17 |
| Pigment | Control | A40 | AR-110B | AR-F1 | AR-245S |
| pH | 8.5 | 8.5 | 8.5 | 8.5 | 8.5 |
| % solids | 60.8 | 60.6 | 60.4 | 60.4 | 60.7 |
| Brook. 10 | 5680 | 5100 | 5100 | 5220 | 4800 |
| Visc. 20 | 3600 | 3100 | 3000 | 3150 | 2860 |
| 50 | 1940 | 1700 | 1528 | 1680 | 1484 |
| 100 | 1320 | 1000 | 950 | 1050 | 882 |
| Hercules | 50.0 | 50.7 | 36.1 | 40.3 | 50.0 |
| Rd | 81.6 | 83.6 | 83.6 | 83.5 | 84 |
| L | 90.4 | 91.4 | 91.4 | 91.4 | 91.7 |
| a | −1.7 | −1.8 | −1.7 | −1.7 | −1.7 |
| b | 4.7 | 3.9 | 3.8 | 3.9 | 3.6 |

Note:
Although AR-F1 displayed very high pigment Brookfield viscosity, no problems were observed when it was formulated into a coating. Additionally, improvements in Hercules viscosity were observed with this pigment as well as with AR-110B after make down. Hercules viscosity of AF-245S was equivalent to that of the control formulation.

(C) Coated Sheet Results

All data are interpolated to a value of 3.5 #/R using linear regression of properties as a function of pigment coating weight. The results are as follows:

TABLE 33
coated sheet results interpolated to 3.5 #/R of EXAMPLE 18:

| | 4576-10-1 | 4576-10-2 | 4576-10-8 | 4576-10-9 | 4576-10-10 |
|---|---|---|---|---|---|
| Formulation | Clay | Opacarb | 4449-90.3 | 4449-90.4 | 3911-17 |
| Pigment | Control | A40 | AR-110B | AR-F1 | AR-245S |
| Brightness | 70.9 | 72.7 | 72.9 | 73.1 | 73.2 |
| Hunter L | 87.9 | 88.5 | 88.6 | 88.8 | 88.6 |
| a | −0.22 | −0.26 | −0.19 | −0.19 | −0.25 |
| b | 6.56 | 6.20 | 6.12 | 5.92 | 6.03 |

Notes:
1. Base on the results obtained and considering the facts: i. that the AR-products have been used as obtained in their production process, ii. that their particles were consideably larger (and their SSA values were considerably smaller) than the control samples, and iii. that the AR products and processes are not yet optimized for the purpose of making paper formulations, the AR products offer excellent pigments for the paper industry.

2. The brightness of the AR-coated papers is at least as good as that of the OPACARB A40 PCC sample, but is definitely better than other controls.

While the invention has been described with respect to a limited number of embodiments, it will be appreciated that many variations, modifications and other plications of the invention may be made.

1. A process for producing a particulate precipitated aragonite calcium carbonate, which comprises reacting an aqueous calcium hydroxide slurry with a gas selected from the group consisting of carbon dioxide and a gas containing it, wherein the parameters of said process, including at least one preselected active agent, mode of operation, operating concentrations of raw materials, operating temperature, operating mixer speed and operating pH, are such that at least one of the following criteria (a), (b) and (c) is satisfied:
(a) the, specific gravity of the product after drying for 12 hours at 120° C. is <2.5 g/cm³ and the specific gravity of this dry product after ignition for eight hours at 500° C. is <2.5 g/cm³;
(b) the apparent (loose) bulk density (L.B.D.) of the product after drying for 12 hours at 120° C. is <0.55 g/cm³;
(c) the tapped bulk density (T.B.D.) of the product after drying for 12 hours at 120° C. is <0.70 g/cm³.

2. A process according to claim 1, in which said at least one active agent is selected from the group consisting of carboxylic acids of formula RCOOH, where R is an organic group containing 7-20 carbon atoms, their carboxylate salts, their acid anhydrides, their esters, their acyl halides and their ketenes.

3. A process according to claim 2, in which said at least one active agent is selected from the group consisting of carboxylic acids of formula CₙH₂ₙ₊₁COOH, where n is 8-17, their carboxylate salts, their acid anhydrides, their esters, their acyl halides and their ketenes of the formula CₙH₂ₙ₊₁C═C═O, where n is 7-16.

4. A process according to claim 2, which is further characterized by the following features:
(a) said at least one active agent is selected from the group consisting of carboxylic acids of formula CH₃(CH₂)ₙCOOH, where n is 7-16, their carboxylate salts, their acid anhydrides, their esters, their acyl halides and their ketenes of the formula CH₃(CH₂)ₙC═C═O, where n is 6-15;
(b) said concentration of the at least one active agent is within the range between 0.2 wt. % and 10 wt. %, calculated as carboxylic acid(s) and based on the weight of calcium carbonate;
(c) said slurry contains calcium hydroxide in a concentration within the range of from 3 to 30 wt. %; 1(d) said pH is within the range of from 8 to 11;
(e) said temperature is in the range between 60° C. and the boiling temperature of the reaction mixture;
(f) said mode of operation is selected from a continuous and a semi-continuous (intermittent) mode of operation;
(g) said mixer peripheral speed (tip-speed) is above 5 m/sec.;
(h) said at least one active agent is added in a manner selected from introduction into the carbonation reactor and premixing with said calcium hydroxide slurry prior to reaction with said gas.

5. A process according to claim 4, which is further characterized by at least one of the following features:
(a) said at least one active agent is selected from the group consisting of carboxylic acids of formula CH₃(CH₂)ₙCOOH, where n is 7-12, and the calcium salts thereof;
(b) said concentration of the at least one active agent is within the range between 0.3 wt. % and 5 wt. %, calculated as carboxylic acid(s) and based on the weight of calcium carbonate;
(c) said slurry contains calcium hydroxide in a concentration within the range of from 4 to 20 wt. %;
(d) said pH is within the range of from 9 to 10;
(e) said temperature is in the range between 80° C. and the boiling temperature of the reaction mixture;
(f) said mode of operation is a continuous mode of operation.

6. A process according to claim 5, which is further characterized by at least one of the following features, namely:
(a) said active agent is selected from the group consisting of nonanoic acid, decanoic acid, undecanoic acid and the calcium salts thereof,
(b) said concentration of said at least one active agent is within the range between 0.4 wt. % and 3 wt. %, calculated as carboxylic acid and based on the weight of calcium carbonate,
(c) said temperature is in the range between 90° C. and the boiling temperature of the reaction mixture, and
(d) said slurry contains calcium hydroxide in a concentration within the range of from 5 to 15 wt. %.

7. A process according to claim 6, which is further. characterized by at least one of the following features, namely:
(a) said active agent is selected from the group consisting of decanoic acid and the calcium salts thereof,
(b) said concentration of said at least one active agent is within the range between 0.4 wt. % and 3 wt. %, calculated as carboxylic acid and based on the weight of calcium carbonate,
(c) said temperature is in the range between 90° C. and the boiling temperature of the reaction mixture, and
(d) said slurry contains calcium hydroxide in a concentration within the range of from 5 to 15 wt. %.

8. A process according to claim 2, which is further characterized by the following features:
(a) said at least one active agent is selected from the group consisting of carboxylic acids of formula CₙH₂ₙ₋₁COOH, where n is 8-17, their carboxylate salts, their acid anhydrides, their esters, their acyl halides and their ketenes of the formula CₙH₂ₙ₋C═C═O, where n is 7-16;
(b) said concentration of the at least one active agent is within the range between 0.2 wt. % and 10 wt. %, calculated as carboxylic acid(s) and based on the weight of calcium carbonate;
(c) said slurry contains calcium hydroxide in a concentration within the range of from 3 to 30 wt. %;
(d) said pH is within the range of from 8 to 11;
(e) said temperature is in the range between 60° C. and the boiling temperature of the reaction mixture;
(f) said mode of operation is selected from a continuous and a semi-continuous (intermittent) mode of operation;
(g) said mixer peripheral speed (tip-speed) is above 5 m/sec.;
(h) said at least one active agent is added in a manner selected from introduction into the carbonation reactor and premixing with said calcium hydroxide slurry prior to reaction with said gas.

9. A process according to claim 8, which is further characterized by at least one of the following features, namely:
(a) said active agent is selected from the group consisting of undecylenic acid and the calcium salts thereof,
(b) said concentration of said at least one active agent is within the range between 0.4 wt. % and 3 wt. %, calculated as carboxylic acid and based on the weight of calcium carbonate,
(c) said temperature is in the range between 80° C. and the boiling temperature of the reaction mixture,
(d) said pH is within the range of from 9 to 10, and
(e) said slurry contains calcium hydroxide in a concentration within the range of from 5 to 15 wt. %.

10. A process according to claim 1, which is conducted as a flotation process in a flotation cell.

11. A process according to claim 10, and substantially as hereinbefore described with reference to FIG. 3 of the attached drawings.

12. A particulate precipitated aragonite produced by the process of claim 1.

13. A particulate precipitated aragonite according to claim 12, which contains at least one calcium salt of carboxylic acids selected from those of the general formulae CₙH₂ₙ₊₁COOH and CₙH₂ₙ₋₁COOH, where n is, 8-17, in an amount between 0.2 and 10 wt. %, calculated as carboxylic acid(s) and based on the weight of calcium carbonate.

14. A particulate precipitated aragonite according to claim 12, which contains at least one calcium salt of carboxylic acids selected from those of the general formula: CH₃(CH₂)ₙCOOH, where n 7-16, in an amount between 0.2 and 10 wt. %, calculated as carboxylic acid(s) and based on the weight of calcium carbonate.

15. A particulate precipitated aragonite, which satisfies at least one of the following criteria (a), (b) and (c):
(a) it has a specific gravity <2.5 g/cm³ after drying at 120° C., and a specific gravity <2.5 g/cm³ after ignition for eight hours at 500° C. of the thus-dried product;
(c) it has a T.B.D. <0.70 g/cm³, after drying at 120° C. for twelve hours.

16. A particulate precipitated aragonite according to claim 15, which satisfies at least one of the following criteria (a), (b), and (c):
(a) it has a specific gravity <2.3 g/cm³ after drying at 120° C., and a specific gravity, <2.3 g/cm³ after ignition for eight hours at 500° C. of the thus-dried product;
(b) it has a L.B.D. <0.50 g/cm³, after drying at 120° C. for twelve hours;
(c) it has a T.B.D. <0.60 g/cm³, after drying at 120° C. for twelve hours.

17. A particulate precipitated aragonite according to claim 15, which satisfies at f (east one of the following criteria (a), (b), and (c):
(a) it has a specific gravity <2.1 g/cm³ after drying at 120° C., and a specific gravity <2.1 g/cm³ after ignition for eight hours at 500° C. of the thus-dried product;
(b) it has a L.B.D. <0.45 g/cm³, after drying at 120° C. for twelve hours;
(c) it has a T.B.D. <0.55 g/cm³, after drying at 120° C. for twelve hours.

18. A particulate precipitated aragonite, which has a specific gravity <1.8 g/cm after drying at 120° C., and a specific gravity <2.3 g/cm³ after ignition for eight hours at 500° C. of the thus-dried product.

19. A particulate precipitated aragonite, which has a specific gravity <1.5 g/cm³ after drying at 120° C., and a specific gravity <2.3 g/cm³ after ignition for eight hours at 500° C. of the thus-dried product.

20. A particulate precipitated aragonite, which has a specific gravity <1.5 g/cm³ after drying at 120° C., and a specific gravity <2.1 g/cm³ after ignition for eight hours at 500° C. of the thus-dried product.

21. A particulate precipitated aragonite according to claim 15, which contains at least one calcium salt of carboxylic acids selected from those of the general formulae CₙH₂ₙ₊₁COOH and CₙH₂ₙ₋₁COOH, where n is 8-17, in an amount between 0.2 and 10 wt. %, calculated as carboxylic acid(s) and based on the weight of calcium carbonate.

22. A particulate precipitated aragonite according to claim 15, which contains at least one calcium salt of carboxylic acids selected from those of the general formula: CH₃(CH₂)ₙCOOH, where n 7-16, in an amount between 0.2 and 10 wt. %, calculated as carboxylic acid(s) and based on the weight of calcium carbonate.

23. A particulate precipitated aragonite according to claim 15, which contains at least one calcium salt of carboxylic acids selected from nonanoic acid, decanoic acid, undecanoic acid, dodecanoic acid, tetradecanoic acid, octadecanoic acid and undecylenic acid, in an amount between 0.2 and 10 wt. %, calculated as carboxylic acid(s) and based on the weight of calcium carbonate

24. A process according to claim 1, wherein said specific gravity after drying is <2.3 g/cm³, said specific gravity after ignition is <2.3 g/cm³, said L.B.D. is <0.50 g/cm³. and said T.B.D. is <0.60 g/cm³.

25. A process according to claim 1, wherein said specific gravity after drying is <2.1 g/cm³, said specific gravity after ignition is <2.1 g/cm³, said L.B.D. is <0.45 g/cm³. and said T.B.D. is <0.55 g/cm³.

26. A process according to claim 1, wherein each said specific gravity is determined substantially as described in Example 14 (E), said L.B.D. is determined substantially as described in Example 14 (F), and said T.B.D. is determined substantially as described in Example 14 (G).

27. A particulate precipitated aragonite according claim 15, wherein each said specific gravity is determined substantially as described in Example 14 (E), said L.B.D. is determined substantially as described in Example 14 (F), and said T.B.D. is determined substantially as described in Example 14 (G).

28. A substantially pure particulate precipitated aragonite according to claim 12, of crystallographic purity (aragonite/(aragonite+calcite)) at least 95%.

29. A particulate precipitated aragonite according to claim 12, of crystallographic purity (aragonite(aragonite+calcite)) at least 90%.

30. A particulate precipitated aragonite according to claim 12, of crystallographic purity (aragonite/(aragonite+calcite)) <90%.

31. A particulate precipitated aragonite according to claim 12, of cytallographic purity (aragonite/(aragonite+calcite)) >75%.

32. A particulate precipitated aragonite according to claim 12, of crystallographic purity (aragonite/(aragonite+calcite)) >50%.

33. A substantially pure particulate precipitated aragonite according to claim 15, of crystallographic purity (aragonite/(aragonite+calcite)) at least 95%.

34. A particulate precipitated aragonite according to claim 15, of crystallographic purity (aragonite(aragonite+calcite)) at least 90%.

35. A particulate precipitated aragonite according to claim 15, of crystallographic purity (aragonite/(aragonite+calcite)) <90%.

36. A particulate precipitated aragonite according to claim 15, of crystallographic purity (aragonite/(aragonite+calcite)) >75%.

37. A particulate precipitated aragonite according to claim 15, of crystallographic purity (aragonite/(aragonite+calcite)) >50%.

38. A process for producing a particulate precipitated aragonite calcium carbonate, which comprises reacting an aqueous calcium hydroxide slurry with a gas selected from the group consisting of carbon dioxide and a gas containing it, wherein the parameters of said process, including at least one preselected active agent, mode of operation, operating concentrations of raw materials, operating temperature, operating mixer speed and operating pH, wherein said at least one active agent is selected from the group consisting of nonanoic acid, decanoic acid, undecanoic acid, dodecanoic acid, tetradecanoic acid, octadecanoic acid, and undecylenic acid, their carboxylate salts, their acid anhydrides, their esters, their acyl halides and their ketenes.

39. A process according to claim 38, which is further characterized by the following features:
said concentration of the at least one active agent is within the range between 0.2 wt. % and 10 wt. %, calculated as carboxylic acid(s) and based on the weight of calcium carbonate;
said slurry contains calcium hydroxide in a concentration within the range of from 3 to 30 wt. %;
said pH is within the range of from 8 to 11;
said temperature is in the range between 60° C. and the boiling temperature of the reaction mixture;
said mode of operation is selected from a continuous and a semi-continuous (intermittent) mode of operation;
said mixer peripheral speed (tip-speed) is above 5 m/sec;
said at least one active agent is added in a manner selected from introduction into the carbonation reactor and premixing with said calcium hydroxide slurry prior to reaction with said gas.

40. A process according to claim 39, which is further characterized by at least one of the following features:
(a) said at least one active agent is selected from the group consisting of nonanoic acid, decanoic acid, undecanoic acid, dodecanoic acid, tetradecanoic acid, octadecanoicacid, and undecylenic acid, and the calcium salts thereof,
(b) said concentration of the at least one active agent is within the range between 0.3 wt. % and 5 wt. %, calculated as carboxylic acid(s) and based on the weight of calcium carbonate;
(c) said slurry contains calcium hydroxide in a concentration within the range of from 4 to 20 wt. %,
(d) said pH is within the range of from 9 to 10;
(e) said temperature is in the range between 80° C. and the boiling temperature of the reaction mixture;
(f) said mode of operation is a continuous mode of operation.

41. A process according to claim 39, which is further characterized by at least one of the following features, namely:
(a) said active agent is selected from the group consisting of nonanoic acid, decanoic acid, undecanoic acid, undecylenic acid and the calcium salts thereof,
(b) said concentration of said at least one active agent is within the range between 0.4 wt. % and 3 wt. %, calculated as carboxylic acid and based on the weight of calcium carbonate,
(c) said temperature is in the range between 90° C. and the boiling temperature of the reaction mixture, and
(d) said slurry contains calcium hydroxide in a concentration within the range of from 5 to 15 wt. %.

42. A process according to claim 41, which is further characterized by at least one of the following features, namely:
(a) said active agent is selected from the group consisting of decanoic acid, undecylenic acid, and the calcium salts thereof,
(b) said concentration of said at least one active agent is within the range between 0.4 wt. % and 3 wt. %, calculated as carboxylic acid and based on the weight of calcium carbonate,
(c) said temperature is in the range between 90° C. and the boiling temperature of the reaction mixture, and
(d) said slurry contains calcium hydroxide in a concentration within the range of from 5 to 15wt. %.

43. A process according to claim 38, which is conducted as a flotation process in a flotation cell.

44. A process according to claim 43, and substantially as hereinbefore described with reference to FIG. 3 of the attached drawings.

45. A particulate precipitated aragonite produced by the process of claim 38.

46. A substantially, pure particulate precipitated aragonite according to claim 45, of crystallographic purity (aragonite/(aragonite+calcite)) at least 95%.

47. A particulate precipitated aragonite according to claim 45, of crystallographic purity (aragonite(aragonite+calcite)) at least 90%.

48. A particulate precipitated aragonite according to claim 45, of crystallographic: purity (aragonite/(aragonite+calcite)) >75%.

49. A particulate precipitated aragonite according to claim 45, of crystallographic purity (aragonite/(aragonite+calcite)) >50%.

50. A particulate precipitated aragonite according to claim 45, of crystallographic purity (aragonite/(aragonite+calcite)) >40%.

51. A coating composition which comprises a particulate precipitated aragonite as defined in any one of claims 12 to 23, 27 to 37 and 45 to 50.

52. A coating composition according to claim 51, which comprises substantially dry particulate precipitated aragonite.

53. A coating composition according to claim 51, which comprises particulate precipitated aragonite in aqueous dispersion.

54. A paper composition which comprises a particulate precipitated aragonite as defined in any one of claims 12 to 23, 27 to 37 and 45 to 50.

55. A paper composition according to claim 54; which comprises substantially dry particulate-precipitated aragonite.

56. A paper composition according to claim 54, which comprises particulate precipitated aragonite in aqueous dispersion.

57. A plastics composition which comprises a particulate precipitated aragonite as defined in any one of claims 12 to 23, 27 to 37 and 45 to 50.

58. A plastics composition according to claim 57, which comprises substantially dry particulate precipitated aragonite.

59. A rubber composition which comprises a particulate precipitated aragonite as defined in any one of claims 12 to 23, 27 to 37 and 45 to 50.

60. A rubber composition according to claim 59, which comprises substantially dry particulate precipitated aragonite.

61. An adsorbent composition which comprises a particulate precipitated aragonite as defined in any one of claims 12 to 23, 27 to 37 and 45 to 50.

62. An adsorbent composition according to claim 61, which comprises substantially dry particulate precipitated aragonite.

63. A powder detergent composition which comprises a particulate precipitated aragonite as defined in any one of claims 12 to 23, 27 to 37 and 45 to 50.

64. A powder detergent composition according to claim 63, which comprises substantially dry particulate precipitated aragonite.

65. A pharmaceutical composition which comprises a particulate precipitated aragonite as defined in any one of claims 12 to 23, 27 to 37 and 45 to 50.

66. A pharmaceutical composition according to claim 65, which comprises substantially dry particulate precipitated aragonite.

67. A pharmaceutical composition according to claim 65, which comprises particulate precipitated aragonite in aqueous dispersion.

68. An agrochemical composition which comprises a particulate precipitated aragonite as defined in any one of claims 12 to 23, 27 to 37 and 45 to 50.

69. An agrochemical composition according to claim 68, which comprises substantially dry-particulate precipitated aragonite.

70. An agrochemical composition according to claim 68, which comprises particulate precipitated aragonite in aqueous dispersion.

71. A flavor composition which comprises a particulate precipitated aragonite as defined in any one of claims 12 to 23, 27 to 37 and 45 to 50.

72. A flavor composition according to claim 71, which comprises substantially dry particulate precipitated aragonite.

73. A flavor composition according to claim 71, which comprises particulate precipitated aragonite in aqueous dispersion.

74. A fragrance composition which comprises a particulate precipitated aragonite as defined in any one of claims 12 to 23, 27 to 37 and 45 to 50.

75. A fragrance composition according to claim 74, which comprises substantially dry particulate precipitated aragonite.

76. A fragrance composition according to claim 74, which comprises particulate precipitated aragonite in aqueous dispersion.

77. A food composition which comprises a particulate precipitated aragonite as defined in any one of claims 12 to 23, 27 to 37 and 45 to 50.

78. A food composition according to claim 77, which comprises substantially dry particulate precipitated aragonite.

79. A food composition according to claim 77, which comprises particulate precipitated aragonite in aqueous dispersion.

80. A feed composition which comprises a particulate precipitated aragonite as defined in any one of claims 12 to 23, 27 to 37 and 45 to 50.

81. A feed composition according to claim 80, which comprises substantially dry particulate precipitated aragonite.

82. A feed composition according to claim 80, which comprises particulate precipitated aragonite in aqueous dispersion.

83. A sunscreen composition which comprises a particulate precipitated aragonite as defined in any one of claims 12 to 23, 27 to 37 and 45 to 50.

84. A sunscreen composition according to claim 83, which comprises substantially dry particulate precipitated aragonite.

85. A sunscreen composition according to claim 83, which comprises particulate precipitated aragonite in aqueous dispersion.

86. A conductive powder composition which comprises a particulate precipitated aragonite as defined in any one of claims 12 to 23, 27 to 37 and 45 to 50.

87. A conductive powder composition according to claim 86, which comprises substantially dry particulate precipitated aragonite.
